(19) United States
(12) Patent Application Publication
(10) Pub. No.: US 2026/0359641 A1
(43) Pub. Date: Nov. 12, 2026

(54) TRIANGULAR UPDATE NEURAL NETWORK

(71) Applicant: NVIDIA Corporation, Santa Clara, CA (US)

(72) Inventors: Harisankar Sadasivan, Issaquah, WA (US); Maximilian Stadler, Munich (DE); Patrick Tobias Haft, Munich (DE); Tejas Yogesh Shah, Santa Clara, CA (US); Dejun Lin, Lynnwood, WA (US); Emine Kucukbenli, Cambridge, MA (US)

(21) Appl. No.: 19/672,609

(22) Filed: May 9, 2026

Related U.S. Application Data
(60) Provisional application No. 63/803,143, filed on May 9, 2025.

(51) Int. Cl. G06N 3/084; G06N 3/048

(52) U.S. Cl. CPC G06N 3/084; G06N 3/048

(57) ABSTRACT

Apparatuses, systems, and techniques are to perform a triangular multiplicative update using one or more processors that execute fused accelerator kernels. An input tensor representing pairwise features is received in a first ordered memory layout that includes a first pair-index axis, a second pair-index axis, and a feature-channel axis. A fused accelerator kernel computes a first tensor and a second tensor from the input tensor and stores the first tensor and the second tensor in a second ordered memory layout in which the feature-channel axis precedes the first pair-index axis and the second pair-index axis. The storing performs a transpose by writing tensor values directly to memory addresses corresponding to the second ordered memory layout. A tensor contraction then computes a triangular multiplicative update tensor by summing over an intermediate index while preserving the feature-channel axis. In some embodiments, an output fused layer-normalization-and-transpose kernel restores a pair-feature layout after the tensor contraction.

### CLAIM OF PRIORITY

This application claims the benefit of U.S. Provisional Application No. 63/803,143 (Attorney Docket No. 25-SE-0637) filed May 9, 2025, the entire contents of which is incorporated herein by reference.

### TECHNICAL FIELD

At least one embodiment pertains to neural-network computation. For example, at least one embodiment pertains to processing resources configured to compute a triangular multiplicative update using tensors stored in a reordered memory layout such that a tensor contraction preserves a feature-channel axis while summing over an intermediate index.

### BACKGROUND

Protein structure prediction can be computationally challenging because the number of possible interactions among residues increases rapidly with sequence length. For a protein having many residues, a prediction system may evaluate large numbers of residue-residue relationships, including pairwise proximity, distance, orientation, or other features associated with possible interactions among residues.

### BRIEF DESCRIPTION OF DRAWINGS

FIG. 1 illustrates a neural network structure configured to perform a triangular multiplicative update using input normalization, input projection and gating, operand generation, triangular contraction, output normalization, and output gating, according to at least one embodiment;

FIG. 2 illustrates an example of a process to perform a triangular multiplicative update, according to at least one embodiment;

FIG. 3 illustrates an example of a process to generate intermediate tensors, contraction operands, and output tensors for a triangular multiplicative update, according to at least one embodiment;

FIG. 4 illustrates example GPU kernels usable in a triangular multiplicative update neural-network block, according to at least one embodiment;

FIG. 5 illustrates a compiler-scheduled triangular multiplicative update pipeline for a language processing unit, according to at least one embodiment;

FIG. 6 illustrates an example of output-side processing for a triangular multiplicative update, according to at least one embodiment;

FIG. 7 illustrates triangular contraction and output-side layout handling in a compiler-scheduled embodiment using reordered operands, according to at least one embodiment;

FIG. 8 illustrates an example data center system, in accordance with at least one embodiment;

FIG. 9 illustrates a system-on-a-chip (SOC), in accordance with at least one embodiment;

FIG. 10 illustrates a parallel processor, in accordance with at least one embodiment;

FIG. 11 illustrates a core of central processing unit, in accordance with at least one embodiment;

FIGS. 12A and 12B illustrate a language processing unit, in accordance with at least one embodiment;

FIG. 13 illustrates a software stack of a programming platform, in accordance with at least one embodiment;

FIG. 14 illustrates compiling code to execute on programming platforms of FIG. 13, in accordance with at least one embodiment;

FIG. 15A illustrates inference and/or training logic, in accordance with at least one embodiment;

FIG. 15B illustrates inference and/or training logic, in accordance with at least one embodiment; and

FIG. 15C illustrates training and deployment of a neural network, in accordance with at least one embodiment.

### DETAILED DESCRIPTION

In the following description, numerous specific details are set forth to provide a more thorough understanding of at least one embodiment. However, it will be apparent to one skilled in the art that the inventive concepts may be practiced without one or more of these specific details.

A triangular multiplicative update operation refines representations in an input tensor so that the input tensor encodes relationships between pairs of data items with greater accuracy and consistency. The operation is performed on an input tensor that has at least three axes: a first index axis whose index values identify respective data items in a first position of a pair, a second index axis whose index values identify respective data items in a second position of a pair, and a feature-channel axis indexing components of a feature vector associated with pairs of data items identified by the first index axis and the second index axis. In a protein application, the first index axis and the second index axis identify respective residues of a protein, and the feature vector encodes learned information related to a 3D relationship between the residues, such as distance-related or proximity-related information.

For each pair (i,j) identified by values of the first index axis and the second index axis, the operation updates the feature vector associated with the pair, where a feature-channel axis indexes components of the feature vector, by computing, for each intermediate index k, a contribution from feature vectors associated with two index pairs that share the intermediate index k, and summing the contributions over k to obtain an updated feature vector for {i,j). Each contribution includes a product of corresponding feature-channel values of the feature vectors associated with the two index pairs. The sum of products over the intermediate index k is computed using a tensor contraction operation that multiplies corresponding feature-channel values of the feature vectors and accumulates the resulting products over k. In one directional embodiment, the two index pairs are (i,k) and (j,k). In another directional embodiment, the two index pairs are (k,i) and (k,j).

As used herein, the feature-channel axis refers to a tensor axis that indexes components of a feature representation. As used herein, pair-index axes refer to tensor axes whose index values identify respective data items of a pair for which the feature representation is stored. As used herein, a batch axis refers to a tensor axis that indexes different input examples processed together during execution of a neural-network operation. As used herein, a feature-leading layout refers to an ordered memory layout in which the feature-channel axis precedes one or more pair-index axes in an ordering of tensor axes. When a batch axis is present, the batch axis and the feature-channel axis may precede the pair-index axes in the feature-leading layout. As used herein, a batched matrix multiplication refers to a matrix multiplication operation that computes multiple matrix multiplications across one or more batching axes while preserving the one or more batching axes during the matrix multiplication. As used herein, a batching axis refers to an axis that indexes different matrix instances of the batched matrix multiplication and is preserved rather than reduced during the matrix multiplication. As used herein, a triangular multiplicative update neural-network block may be implemented as a neural-network layer, sublayer, module, stage, or block. Accordingly, references herein to a triangular multiplicative update neural-network block also encompass a triangular multiplicative update neural-network layer, and references to a triangular multiplicative update neural-network layer also encompass a triangular multiplicative update neural-network block. In some embodiments, the triangular multiplicative update is implemented as a single layer of a neural network. In some embodiments, the triangular multiplicative update is implemented as a portion of a larger layer stack or as a block including multiple stages, such as normalization, projection, gating, contraction, and output-side processing.

In some implementations of triangular multiplicative update operations, tensor operands may be stored in layouts in which a feature-channel axis trails pair-index axes. Executing a tensor contraction on tensors stored in such layouts may involve additional layout-conversion operations, including transpose or permutation operations, which may increase memory traffic, increase kernel-launch overhead, and reduce effective utilization of parallel processors. In the embodiments described herein, intermediate tensors may be stored in a feature-leading layout before execution of the tensor contraction. Accordingly, when tensors are stored with the batch axis and the feature-channel axis preceding the pair-index axes, the batch axis and the feature-channel axis may serve as batching axes for matrix multiplications performed over the intermediate index k. With intermediate tensors arranged in that manner, the tensor contraction is executable in a batched matrix-multiplication form over the intermediate index k using instructions of a parallel processor, which may reduce or avoid separate layout-conversion operations, reduce memory traffic, reduce kernel-launch overhead, and improve execution efficiency on parallel processing hardware.

A neural network configured to perform the triangular multiplicative update operation includes an input layer-normalization stage, an input projection-and-gating stage, an operand-generation stage, a tensor-contraction stage, an output layer-normalization-and-transpose stage, and an output projection-and-gating stage. The input projection-and-gating stage computes a projected tensor from the input tensor and stores the projected tensor in a reordered layout for use by the tensor-contraction stage. The operand-generation stage generates contraction operands from the projected tensor. In some embodiments, a fused accelerator kernel generates a projected tensor or feature-expanded tensor from which the contraction operands are generated and stores the projected tensor or feature-expanded tensor in the reordered layout, and, in some embodiments, the fused accelerator kernel directly generates tensor values of the contraction operands and stores the tensor values in the reordered layout. As used herein, a projected tensor refers to a tensor generated from an input tensor by projection processing for downstream use. In one example, the projected tensor is generated by input projection, gating, mask, and transpose stage 106 and is stored according to a reordered layout for use in generating contraction operands. As used herein, a feature-expanded tensor refers to a tensor that has more feature channels than a tensor from which the feature-expanded tensor is generated. In one example, an input pair tensor has feature-channel extent D, and a projected tensor generated from the input pair tensor has feature-channel extent 2D before being partitioned into two tensors each having feature-channel extent D. The projected tensor is therefore a feature-expanded tensor. In at least one embodiment, the fused accelerator kernel need not first materialize a single feature-expanded tensor that is later separated by a distinct runtime operation. For example, the fused accelerator kernel may directly generate tensor values of the first tensor and tensor values of the second tensor and may store the first tensor and the second tensor in respective memory regions according to the reordered layout used by the tensor-contraction stage. Accordingly, references herein to generating a projected tensor or a feature-expanded tensor from which the first tensor and the second tensor are generated also encompass embodiments in which the fused accelerator kernel directly generates and stores the first tensor and the second tensor for downstream triangular contraction.

The tensor-contraction stage performs the sum of products over the intermediate index k to produce a contraction output tensor. The output layer-normalization-and-transpose stage normalizes the contraction output tensor and stores a post-contraction tensor in a layout in which the feature-channel axis trails the index axes. The output projection-and-gating stage receives the post-contraction tensor at a value branch and may receive a bypass tensor derived from the input tensor at a gating branch, performs an output linear projection and a gating operation, applies a sigmoid activation to the gating branch, and combines projected values and gating values by elementwise multiplication to generate an output tensor. In that arrangement, the gating operation generates control values that modulate corresponding projected values so that the output tensor reflects a selected contribution of the post-contraction tensor according to information derived from the input tensor.

In at least one embodiment, processors execute instructions that load tensor elements from memory, perform matrix multiplication and elementwise operations on the tensor elements, accumulate results across the intermediate index, and store resulting tensor values to memory locations corresponding to selected layouts. For example, processors may load tensor values for normalization, projection, gating, masking, contraction, or output-side processing, and may write resulting values directly to addresses corresponding to a contraction-ready layout or to a restored pair-feature layout, such that separate layout-conversion operations are reduced or avoided.

In one example, the output projection-and-gating stage receives the post-contraction tensor at a value branch and receives a bypass tensor derived from the input tensor at a gating branch. The bypass tensor and the post-contraction tensor are combined by a fused kernel that performs output gating and output projection. In that arrangement, the gating operation may generate gating values from the bypass tensor, apply a sigmoid activation to the gating values, and combine the gating values with projected values derived from the post-contraction tensor by elementwise multiplication. The gating values therefore control how strongly corresponding projected values contribute to the output tensor.

In a GPU embodiment, the neural network includes fused kernels that perform multiple stages efficiently and write intermediate tensors directly in layouts used by downstream stages. For example, the fused kernels include a fused layer-normalization-and-transpose kernel and a fused projection-and-gating kernel. The fused layer-normalization-and-transpose kernel normalizes tensor values and stores the normalized tensor values directly in memory locations corresponding to a selected layout of axes, so that layer normalization and layout conversion can be performed within the same kernel. Because layer normalization and layout conversion each primarily involve reading and writing tensor elements, performing both operations within the same kernel may reduce repeated memory accesses and may avoid allocating an intermediate tensor between normalization and storage in the selected layout. The fused projection-and-gating kernel performs linear projection, gating, sigmoid activation, multiplication, optional mask application, and output storage for the tensor contraction. In some embodiments, a layout conversion associated with the tensor contraction is propagated to an earlier stage of a triangular multiplicative update graph so that a transpose associated with preparation of a contraction operand is implemented during normalization or projection-and-gating, and a downstream stage consumes a tensor already stored in the selected layout. In some embodiments, one or more fused accelerator kernels of the triangular multiplicative update neural-network block support selectable numeric precision modes. In one example, a fused accelerator kernel is executable in a default precision mode, a reduced-precision matrix-multiplication mode, or an IEEE floating-point mode. In some embodiments, different precision modes are selected for different data types, hardware capabilities, or execution contexts. In some embodiments, the fused accelerator kernels are compatible with autocast or mixed-precision execution in which one or more input tensors or weight tensors are represented in a reduced-precision format while one or more accumulations are performed in higher precision. In some embodiments, one or more fused accelerator kernels of the triangular multiplicative update neural-network block are associated with multiple execution configurations, and a configuration is selected according to one or more characteristics of a workload. In one example, the selected configuration depends on one or more of tensor shape, tile size, data type, selected precision mode, or whether a fused kernel uses one input tensor or two input tensors. In some embodiments, one or more such configurations are determined by autotuning, including autotuning performed in advance for anticipated workloads, so that execution of the fused accelerator kernel uses a configuration selected for a target processor architecture. In some embodiments, a fused sigmoid-gated dual matrix multiplication kernel is associated with a plurality of tunable parameters including one or more of tile dimensions, stage count, or warp count, and an execution configuration is selected from among the plurality of tunable parameters based on workload characteristics. In some embodiments, the execution configuration is selected using autotuning performed ahead of runtime execution.

In a compiler-scheduled embodiment, a compiler schedules producer operations of a triangular multiplicative update graph so that intermediate tensors are written directly in a layout used by a downstream tensor-contraction stage. In one example, the compiler assigns output buffers for normalization, projection, gating, masking, or elementwise-combination stages so that tensor elements are stored with the feature-channel axis preceding the index axes, and, when a batch axis is present, with the batch axis and the feature-channel axis preceding the index axes. In one example, the compiler assigns output buffers that store a first tensor and a second tensor used by the downstream tensor-contraction stage according to the selected layout, such that the first tensor and the second tensor are produced directly in the selected layout for downstream consumption by the tensor-contraction stage. The compiler may assign the output buffers to the layout expected by the downstream tensor-contraction stage and may generate store addresses during execution of a producer operation so that the producer operation writes tensor elements directly to memory locations corresponding to the selected layout. In the compiler-scheduled embodiment, a transpose is implemented by writing tensor elements according to a layout mapping corresponding to the selected layout, rather than by executing a separate transpose stage after the intermediate tensor has been produced, or by generating a separate intermediate tensor in the selected layout. The tensor-contraction stage then consumes operands already stored in the selected layout, so that the triangular multiplicative update operation is executed with reduced layout-conversion overhead and in a matrix-multiplication form over an intermediate index, with the batch axis and the feature-channel axis acting as batching axes when those axes are leading axes of the selected layout. In some examples, the compiler further schedules one or more downstream stages to consume a contraction output tensor in the selected layout or to restore a pair-feature layout only when needed by a downstream stage such that the selected layout is propagated across multiple stages of the triangular multiplicative update graph. As used herein, a layout mapping refers to a correspondence that maps tensor elements from positions associated with a source ordered layout to positions associated with a target ordered layout. In one example, the layout mapping defines how coordinates of a tensor element in a source layout are translated into memory addresses or index positions in a reordered layout so that the tensor element is written directly to a location corresponding to the target ordered layout used by a downstream stage.

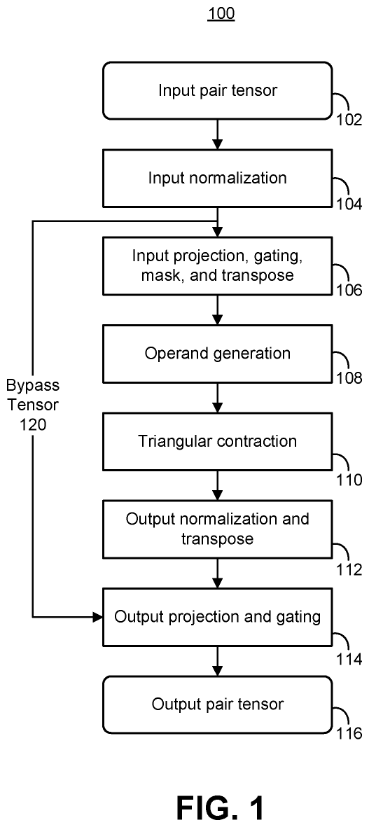

FIG. 1 illustrates an example of a triangular multiplicative update neural-network block 100, according to at least one embodiment. Triangular multiplicative update neural-network block 100 receives an input pair tensor 102 and generates an output pair tensor 116. Triangular multiplicative update neural-network block 100 includes an input normalization stage 104, an input projection, gating, mask, and transpose stage 106, an operand generation stage 108, a triangular contraction stage 110, an output normalization and transpose stage 112, and an output projection and gating stage 114. FIG. 1 further shows a bypass tensor 120 extending from input normalization stage 104 to output projection and gating stage 114.

The triangular multiplicative update neural-network block 100 can be used in protein-folding applications, for example. Protein folding involves determining the three-dimensional (3D) structure of a protein from a one-dimensional (1D) amino acid sequence. The input 1D sequence is a sequence of residues, in which each residue corresponds to an amino acid. The output 3D structure indicates the positions of the residues in the 3D structure of the protein. A protein's 3D structure is influenced by interactions among residues in the sequence. Residues that are distant from one another in the 1D sequence may nevertheless be close to one another in 3D space. Accordingly, predicting protein structure generally involves identifying relationships among many residue pairs and determining how those relationships can be made mutually consistent in a 3D arrangement.

An input pair tensor 102 stores features associated with pairs of data items. In one example, input pair tensor 102 may be represented as a tensor having shape (B,I,J,D) (e.g., a 4-dimensional tensor) stored in memory according to a pair-feature layout having shape (B,I,J,D), where B denotes a batch axis, I denotes a first pair-index axis, J denotes a second pair-index axis, and D denotes a feature-channel axis. In that arrangement, the first pair-index axis and the second pair-index axis identify a pair of data items, and the feature-channel axis indexes components of a feature vector associated with the identified pair of data items. As used herein, a batch axis refers to a tensor dimension that indexes different input examples processed together during execution of a neural-network operation. For example, in a tensor having shape (B,I,J,D), the batch axis has extent B and distinguishes pairwise feature data associated with one input example from pairwise feature data associated with another input example, while common computations are performed across the indexed input examples. In some operations, the batch axis may serve as a batching axis of a batched matrix multiplication. As used herein, an i axis and a j axis refer to tensor axes that identify a pair of data items for which a pairwise representation is stored or processed. For example, in a tensor having shape (B,I,J,D), the i axis indexes a first data item of a pair and the j axis indexes a second data item of the pair, such that each coordinate (i,j) identifies a pairwise relationship associated with those two data items. As used herein, a d axis refers to a tensor axis that indexes feature channels of a pairwise representation. For example, in a tensor having shape (B,I,J,D), the d axis has extent D and identifies components of a feature vector associated with a pair of data items indexed by the i axis and the j axis, such that different values along the d axis correspond to different learned feature values for the same pair location. In one example, in a protein application, the first pair-index axis and the second pair-index axis identify respective residues, and the feature vector encodes learned information related to a three-dimensional relationship between the residues.

An input normalization stage 104 generates a normalized tensor from input pair tensor 102 for downstream processing. In one example, input normalization stage 104 performs layer normalization across the feature-channel axis and stores normalized tensor values according to a layout selected for downstream processing. For example, input normalization stage 104 may receive input pair tensor 102 in a pair-feature layout having shape (B,I,J,D) and may generate a normalized tensor in the pair-feature layout or another layout selected for a downstream stage. Input normalization stage 104 also provides bypass tensor 120 for use by output projection and gating stage 114.

A bypass tensor 120 provides input-side feature information to output projection and gating stage 114. In one example, bypass tensor 120 corresponds to a normalized tensor generated by input normalization stage 104 and retained for downstream gating. Bypass tensor 120 bypasses input projection, gating, mask, and transpose stage 106, operand generation stage 108, triangular contraction stage 110, and output normalization and transpose stage 112 so that output projection and gating stage 114 receives both a post-contraction tensor and bypass tensor 120.

An input projection, gating, mask, and transpose stage 106 generates a projected tensor arranged for operand generation stage 108. In one example, input projection, gating, mask, and transpose stage 106 may perform operations such as one or more linear projections, gating, sigmoid activation, elementwise multiplication (e.g., Hadamard product), optional mask application, and layout conversion. In that arrangement, the gating operation may generate control values from an input-side tensor and use the control values to modulate projected values before formation of contraction operands. In one example, input projection, gating, mask, and transpose stage 106 applies a sigmoid activation to a gating branch and combines resulting gating values with projected values by elementwise multiplication so that selected projected feature values are attenuated or passed through before downstream triangular contraction processing. A mask tensor may indicate whether corresponding tensor elements contribute to triangular contraction stage 110 or to subsequent computations. The transpose operation reorders axes from the pair-feature layout to a feature-leading layout in which the feature-channel axis precedes the first pair-index axis and the second pair-index axis. In one example, when the batch axis is present, the batch axis and the feature-channel axis precede the pair-index axes in the feature-leading layout. In one example, input projection, gating, mask, and transpose stage 106 performs the transpose operation by storing computed tensor values directly to memory addresses corresponding to the feature-leading layout during execution of a fused accelerator kernel, such that downstream operand generation stage 108 and triangular contraction stage 110 consume tensor values already stored in a contraction-ready layout. In at least one embodiment, input normalization stage 104 may preserve a pair-feature layout, and the reordered output storage used to prepare contraction operands may be performed by the fused accelerator kernel of input projection, gating, mask, and transpose stage 106.

In one or more embodiments, input projection, gating, masking, and transpose stage 106 applies an optional mask during execution of the fused operation that generates the projected tensor. In one example, the fused operation computes a gate branch and a value branch from the input tensor, applies a sigmoid activation to the gate branch, combines the gate branch and the value branch by elementwise multiplication, and then applies the optional mask before storing resulting tensor values in the selected output layout. In some embodiments, the optional mask is therefore applied within the fused operation rather than in a separate masking pass after the projected tensor has been generated. In some embodiments, the optional mask is associated with pair positions of the input tensor and indicates whether corresponding pair positions are to contribute to downstream processing. In one example, the optional mask has values corresponding to combinations of the first pair-index axis and the second pair-index axis, and the optional mask is broadcast across feature-channel values associated with a corresponding pair position. In some embodiments, application of the optional mask suppresses one or more pair positions before operand generation and triangular contraction. In some embodiments, masked and unmasked variants of input projection, gating, masking, and transpose stage 106 are supported. For example, when a mask is provided, the fused operation applies the mask to projected and gated tensor values before storing the tensor values in the selected layout. When a mask is not provided, the fused operation stores projected and gated tensor values in the selected layout without mask application. In either case, the stored tensor values are arranged for downstream operand generation and triangular contraction.

In at least one embodiment, the projected tensor generated by input projection, gating, mask, and transpose stage 106 is a feature-expanded tensor arranged for partitioning into contraction operands. In one example, the projected tensor has shape (2D,B,I,J). That layout places an expanded feature-channel axis and the batch axis ahead of the pair-index axes so that projected channels are arranged for downstream partitioning into separate tensors used by triangular contraction stage 110.

An operand generation stage 108 generates a first tensor and a second tensor from the projected tensor. The first tensor and the second tensor are contraction operands arranged for participation in a tensor contraction that sums over an intermediate index while preserving the feature-channel axis. In one example, operand generation stage 108 partitions or otherwise transforms a leading axis of the projected tensor of shape (2D,B,I,J) to generate the first tensor and the second tensor, each having shape (D,B,I,J). For a given directional arrangement, pair-index positions of the first tensor and the second tensor may correspond to output indices or to the intermediate index used by triangular contraction stage 110. In one example, the first tensor corresponds to operand a and the second tensor corresponds to operand b. Operand generation stage 108 therefore provides contraction operands in a feature-leading layout in which the feature-channel axis and the batch axis precede the pair-index axes. In at least one embodiment, the first tensor and the second tensor each may be stored according to a feature-leading layout having shape (D, B, I, J), where the two trailing positions correspond to pair-index positions having equal extent. For a selected directional arrangement, those trailing pair-index positions may be interpreted according to contraction roles used by triangular contraction stage 110. For example, in an outgoing arrangement the first tensor and the second tensor may be indexed as dbik and dbjk, respectively, whereas in an incoming arrangement the first tensor and the second tensor may be indexed as dbki and dbkj, respectively. Accordingly, references herein to tensors having stored shape (D, B, I, J) and to direction-specific forms such as (D, B, I, K), (D, B, J, K), (D, B, K, I), or (D, B, K, J) may describe the same stored operand tensors at different levels of abstraction, including stored layout and contraction-role indexing.

A triangular contraction stage 110 computes a triangular multiplicative update tensor by performing a tensor contraction between the contraction operands. In one example, triangular contraction stage 110 computes a sum of products over an intermediate index k while preserving the feature-channel axis and the batch axis, such that the feature-channel axis is not summed over the intermediate index. For each pair (i,j) identified by values of the first pair-index axis and the second pair-index axis, triangular contraction stage 110 updates the feature vector associated with that pair by computing, for each intermediate index k, a contribution from feature vectors associated with two index pairs that share the intermediate index k, and summing the contributions over k to obtain an updated feature vector for (i,j).

In one directional arrangement, triangular contraction stage 110 combines features associated with a pair identified by the first pair-index axis and the intermediate index and features associated with a pair identified by the second pair-index axis and the intermediate index to produce an updated feature associated with the first pair-index axis and the second pair-index axis. In one example, an outgoing form of triangular contraction stage 110 is expressed as dbik, dbjk→dbij. The notation dbik, dbjk→dbij indicates a tensor contraction between a first tensor indexed by feature axis d, batch axis b, first output index i, and intermediate index k, and a second tensor indexed by feature axis d, batch axis b, second output index j, and intermediate index k. The shared index k appears in both input tensors but not in the output tensor, indicating that products are summed over k. The indices d and b are preserved as leading batching axes, and the indices i and j define output indices. For fixed values of d and b, the contraction performs a matrix multiplication over intermediate index k using corresponding slices of the input tensors, and different fixed values of d and b correspond to different matrix multiplications of a batched matrix multiplication. The sum-of-products formula is:

x_{d,b,i,j}=Σₖa_{d,b,i,k}b_{d,b,j,k}

where:
a is indexed by d, b, i, and k
b is indexed by d, b, j, and k, and
the shared index k is summed over, with d and b preserved rather than reduced, such that
fixed values of d and b identify a matrix instance of a batched matrix multiplication executed by a parallel processor.

So for each fixed d, b, i, and j, the output value is the sum over all intermediate-index values k of the product of the corresponding elements of the two input tensors, with d and b being preserved rather than reduced so that different values of d and b identify different matrix instances. Both outgoing and incoming triangular contraction may be used in a triangular multiplicative update. In an outgoing triangular contraction, the update for pair (i,j) is formed by looking outward from i and j to a shared third index k, and combining information from pairs (i,k) and (j,k). In an incoming triangular contraction, the update for pair (i,j) is instead formed by looking at information coming into i and j from the shared third index k, and combining information from pairs (k,i) and (k,j). In an outgoing triangular contraction, the contraction combines features associated with pair indices (i,k) and (j,k) to generate an updated feature associated with pair (i,j), such that the shared intermediate index k appears in a trailing position of the input operands. In an incoming triangular contraction, the contraction instead combines features associated with pair indices (k,i) and (k,j) to generate the updated feature associated with pair (i,j), such that the shared intermediate index k appears in a leading position of the pair-index portion of the input operands. In each case, the tensor operands may be arranged in the feature-leading layout before execution of triangular contraction stage 110 so that the contraction is performed in a matrix-multiplication form over the intermediate index k by a parallel processor.

In another directional arrangement, triangular contraction stage 110 combines features associated with a pair identified by the intermediate index and the first pair-index axis and features associated with a pair identified by the intermediate index and the second pair-index axis to produce the updated feature associated with the first pair-index axis and the second pair-index axis. In one example, an incoming form of triangular contraction stage 110 is expressed as dbki, dbkj→dbij, such that fixed values of the feature-channel axis and the batch axis identify a matrix instance and the intermediate index k is a reduction index of the matrix multiplication.

In one or more embodiments, triangular contraction stage 110 is configurable for an outgoing directional arrangement or an incoming directional arrangement. In one example, the outgoing directional arrangement combines features associated with index pairs identified by the first pair-index axis and an intermediate index and by the second pair-index axis and the intermediate index. In another example, the incoming directional arrangement combines features associated with index pairs identified by the intermediate index and the first pair-index axis and by the intermediate index and the second pair-index axis. In some embodiments, direction-specific operand layouts and contraction expressions are selected so that, for either directional arrangement, the contraction remains executable in a batched matrix-multiplication form while preserving the feature-channel axis and, when present, the batch axis.

The triangular multiplicative update tensor produced by triangular contraction stage 110 remains in a layout in which the feature-channel axis and the batch axis are leading axes. In one example, triangular contraction stage 110 produces the triangular multiplicative update tensor in shape (D,B,I,J). For fixed values of the feature-channel axis and the batch axis, the tensor contraction performs a matrix multiplication over the intermediate index k using corresponding slices of the contraction operands, with the first pair-index axis and the second pair-index axis defining output indices of the contraction result. Different fixed values of the feature-channel axis and the batch axis correspond to different matrix multiplications of a batched matrix multiplication. Triangular contraction stage 110 therefore computes the triangular multiplicative update tensor in a batched matrix-multiplication form over the intermediate index k using the feature-leading layout of the contraction operands without first restoring a pair-feature layout for the contraction.

An output normalization and transpose stage 112 generates a post-contraction tensor from the triangular multiplicative update tensor. As used herein, a post-contraction tensor refers to a tensor derived from the triangular multiplicative update tensor after output-side normalization and layout handling, and in some figure-specific embodiments the post-contraction tensor may also be referred to as a restored tensor. In one example, output normalization and transpose stage 112 performs layer normalization on the triangular multiplicative update tensor and stores the post-contraction tensor in a pair-feature layout in which the feature-channel axis trails the pair-index axes. In one example, output normalization and transpose stage 112 receives a tensor having shape (D,B,I,J) and stores a post-contraction tensor having shape (B,I,J,D). In one example, output normalization and transpose stage 112 performs the layout restoration by storing normalized values directly to memory locations corresponding to the restored pair-feature layout, such that normalization and layout restoration are performed during output-side processing without requiring a separate layout-conversion stage after normalization.

An output projection and gating stage 114 generates an updated pair representation using the post-contraction tensor and bypass tensor 120. In one example, output projection and gating stage 114 performs an output linear projection using the post-contraction tensor from output normalization and transpose stage 112, performs a gating operation using bypass tensor 120 from input normalization stage 104, applies a sigmoid activation to a gating branch, and combines projected values and gating values by elementwise multiplication. In that arrangement, the gating operation generates control values that modulate corresponding projected values so that the updated pair representation reflects a selected contribution of the post-contraction tensor according to information preserved from the input-side path. In one example, output projection and gating stage 114 generates gating values from bypass tensor 120, applies the sigmoid activation to place the gating values in a bounded range, and multiplies the gating values elementwise with projected values derived from the post-contraction tensor. In one example, the post-contraction tensor provides a value branch and bypass tensor 120 provides a gating branch. Output projection and gating stage 114 therefore receives an output-side tensor derived from triangular contraction stage 110 through output normalization and transpose stage 112 and an input-side tensor derived from input normalization stage 104.

An output pair tensor 116 stores updated pairwise feature values generated by triangular multiplicative update neural-network block 100. In one example, output pair tensor 116 is stored according to a layout having shape (B,I,J,D). FIG. 1 therefore shows a neural-network block in which input pair tensor 102 is received in a pair-feature layout, transformed by input projection, gating, mask, and transpose stage 106 into a feature-expanded tensor in a feature-leading layout, partitioned by operand generation stage 108 into contraction operands, processed by triangular contraction stage 110 to compute a triangular multiplicative update tensor by computing a sum of products over an intermediate index while preserving the feature-channel axis, transformed by output normalization and transpose stage 112 into a post-contraction tensor stored in a pair-feature layout, and combined with bypass tensor 120 at output projection and gating stage 114 to generate output pair tensor 116.

The triangular multiplicative update neural-network block 100 can be used in protein-folding applications to predict the 3D structure of a protein from a 1D amino acid sequence. The input 1D sequence is more specifically a sequence of residues, in which each residue corresponds to an amino acid. The output 3D structure indicates the positions of the residues in 3D space. A neural network is trained on known protein structures to use transformers and self-attention to identify residue pairs that are likely to interact in 3D space by identifying patterns of interactions between amino acids. The neural network learns pair representations that reflect inductive biases, including triangle-based inductive biases, thereby generating a pair representation that captures the likelihood of each pair of residues being close in 3D space.

More particularly, the neural-network block 100 refines a learned pairwise representation by, for each pair of indices ij, computing an updated feature as a sum of contributions over possible intermediate indices k. For a fixed pair ij, the neural-network block 100 combines pair-features associated with two sides of a triangle that share the intermediate index k, and accumulates those contributions over k to produce the updated feature for ij. This sum of products over the intermediate index k is referred to herein as a triangular contraction.

In a protein-related example, i, j, and k may denote residue indices, and k may correspond to a candidate third residue that, together with residues i and j, forms a triangle in a learned pairwise interaction representation.

By aggregating information across such residue triangles, the neural-network block 100 incorporates triangular consistency into the learned representation. The neural-network block 100 encourages predicted pairwise proximity or distance information for pairs (i, j), (j, k), and (i, k) to be mutually consistent in view of triangle-based relationships among the corresponding residue pairs. For example, in some contexts, such triangle-based relationships may include relationships consistent with triangle-inequality-type behavior (e.g., if residue i is predicted to be close to j and j is predicted to be close to k, then i may also be predicted to be relatively close to k).

In a larger protein-structure prediction network, the neural-network block 100 can be applied repeatedly to update a learned pair representation that captures, for each residue pair (i, j), a likelihood (or estimate) of being close in 3D space, which is then used by downstream network components to generate a predicted 3D structure for the input sequence.

In at least one embodiment, the neural-network block 100 is executed on a GPU to perform a triangular multiplicative update graph that includes: (i) an input layer normalization stage applied to an input tensor of pairwise features (to re-center and re-scale the channels of the input tensor to have approximately zero mean and unit variance), (ii) an input projection and gating stage in which one or more linear projections are combined with a sigmoid gate and elementwise multiplication (to transform the input tensor to a new space of a specified size), optionally with masking and layout-aware output storage, (iii) splitting projected channels into two operands (a) and (b) corresponding to two element pairs, (iv) an einsum-style tensor contraction that sums over an intermediate index to produce an updated pairwise-feature tensor (having a refined learned representation of which element pairs are likely to interact), and (v) an output normalization and output projection/gating stage to produce an output tensor, where one or more stages may write tensor values directly in layouts selected for downstream processing.

In one or more embodiments, the triangular multiplicative update neural-network block 100 is configured for backward propagation in addition to forward propagation. In such embodiments, one or more backward operations compute gradients associated with the triangular multiplicative update neural-network block 100, including gradients associated with one or more of input normalization, input projection, input gating, optional masking, triangular contraction, output normalization, output projection, and output gating. In some embodiments, backward propagation for the triangular multiplicative update neural-network block 100 propagates gradients from an output tensor of the block 100 to one or more earlier tensors and parameters associated with the block. For example, backward propagation may propagate gradients through an output projection-and-gating stage, an output normalization-and-transpose stage, a triangular contraction stage, an input projection-and-gating stage, and an input normalization stage. In some embodiments, backward propagation computes gradients with respect to one or more input tensors of the block and with respect to one or more learned parameters used by the block. In some embodiments, backward propagation for the triangular multiplicative update neural-network block is performed using one or more fused backward kernels. For example, a fused backward kernel may compute gradients for multiple operations that, in a baseline implementation, would otherwise be performed as separate backward kernels. In some embodiments, the one or more fused backward kernels reduce repeated reading and writing of intermediate tensors during gradient computation. In some embodiments, one or more backward operations of the triangular multiplicative update neural-network block 100 are configured to preserve one or more layout advantages used in forward propagation. For example, one or more backward operations may read tensors stored in a reordered layout, compute gradients while accounting for the reordered layout, and write one or more gradient tensors in a selected layout without requiring a separate standalone layout-conversion kernel between backward stages. In some embodiments, one or more backward operations are performed in association with tensors arranged so that a feature-channel axis or a batch axis remains a leading axis for one or more gradient-related computations.

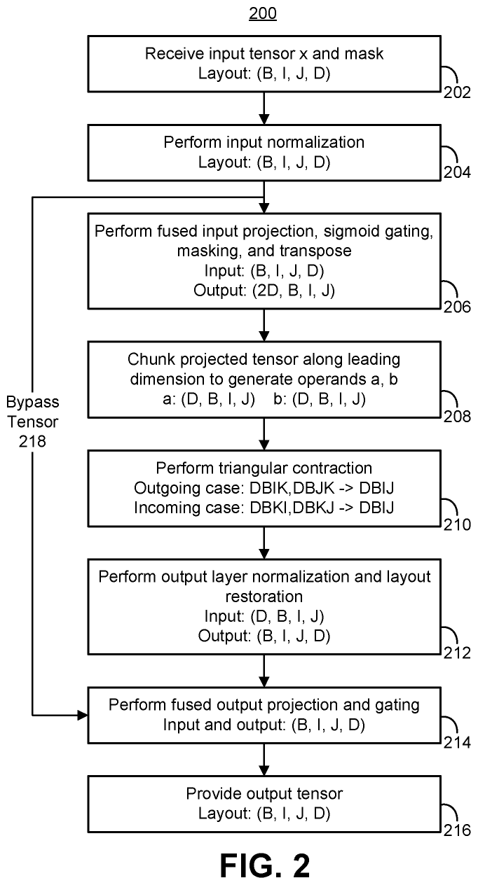

FIG. 2 illustrates an example of a process 200 to perform a triangular multiplicative update operation, according to at least one embodiment. In at least one embodiment, some or all of process 200, or any other processes described herein, or variations and combinations thereof, are performed under control of one or more computer systems configured with computer-executable instructions and are implemented as code executing collectively on one or more processors, by hardware, software, or combinations thereof. In at least one embodiment, the code is stored on a computer-readable storage medium in the form of a computer program comprising a plurality of computer-readable instructions executable by one or more processors. In at least one embodiment, the computer-readable storage medium is a non-transitory computer-readable medium. At least some computer-readable instructions usable to perform process 200 are not stored solely using transitory signals, such as a propagating transient electric or electromagnetic transmission. A non-transitory computer-readable medium does not necessarily include non-transitory data storage circuitry, such as buffers, caches, and queues, within transceivers of transitory signals.

In at least one embodiment, process 200 is performed by one or more systems such as those described in this present disclosure. For example, process 200 may be performed using triangular multiplicative update neural-network block 100 of FIG. 1, including input normalization 104, input projection, gating, mask, and transpose 106, operand generation 108, triangular contraction 110, output normalization and transpose 112, output projection and gating 114, and bypass tensor 120. In at least one embodiment, process 200 is performed by a system of one or more programming models, such as CUDA, HIP, oneAPI, or variations thereof. One or more portions of process 200 are performed in any suitable order, including sequential, parallel, or variations thereof, and by any suitable system, such as those described herein, and using any suitable processing unit, such as a CPU, GPU, PPU, GPGPU, or variations thereof. Although process 200 is depicted as a series of steps or operations, process 200 may include altered or reordered steps or operations, or omit certain steps or operations, except where explicitly noted or logically required, such as when an output of one step or operation is used as input for another.

The system performing at least a part of process 200 includes code to at least receive 202 an input tensor x and, optionally, a mask. The input tensor x is a tensor representing features associated with pairs of data items. In one example, the input tensor x may be stored according to a pair-feature layout having shape (B,I,J,D), where B denotes a batch axis, I denotes a first pair-index axis, J denotes a second pair-index axis, and D denotes a feature-channel axis. In that arrangement, the first pair-index axis and the second pair-index axis identify a pair of data items, and the feature-channel axis indexes components of a feature vector associated with the identified pair of data items. In one example, in a protein application, the first pair-index axis and the second pair-index axis identify respective residues, and the feature vector encodes learned information related to a three-dimensional relationship between the residues. When a mask is received at step 202, the mask is a tensor that identifies pair locations to be retained or suppressed during subsequent processing. In one example, the mask has shape (B,I,J).

The system performing at least a part of process 200 includes code to at least perform 204 input normalization on the input tensor x. Input normalization generates a normalized tensor for downstream processing. In one example, step 204 performs layer normalization across the feature-channel axis while preserving the pair-feature layout of the input tensor x, such that the normalized tensor remains arranged according to shape (B,I,J,D). Step 204 also provides bypass tensor 218. Bypass tensor 218 is a tensor retained from an input-side portion of process 200 for later use in output gating, and corresponds to a normalized version of the input tensor x generated at step 204. As shown in FIG. 2 and consistent with FIG. 1, bypass tensor 218 bypasses step 206, step 208, step 210, and step 212 so that step 214 receives both a post-contraction tensor and bypass tensor 218.

The system performing at least a part of process 200 includes code to at least perform 206 fused input projection, sigmoid gating, masking, and transpose processing. Step 206 generates a projected tensor arranged for operand generation and triangular contraction. In one example, step 206 performs one or more linear projections using the normalized tensor from step 204, performs a gating operation, applies a sigmoid activation to a gate branch, combines projected values and gated values by elementwise multiplication, and, when a mask is received at step 202, applies the mask, where the mask may indicate whether corresponding tensor elements contribute to triangular contraction at step 210 or to subsequent computations, and performs a transpose operation by storing computed tensor values directly to memory locations corresponding to a feature-leading layout. The transpose operation reorders axes from the pair-feature layout to a feature-leading layout in which the feature-channel axis precedes the first pair-index axis and the second pair-index axis. In one example, when the batch axis is present, the batch axis and the feature-channel axis precede the pair-index axes in the feature-leading layout. FIG. 2 indicates that step 206 produces an output tensor having shape (2D,B,I,J). That shape corresponds to a feature-expanded tensor in which projected channels are doubled and placed in a leading position before the batch axis and the pair-index axes, such that a downstream contraction of tensors derived from the output tensor is executable in a batched matrix-multiplication form over an intermediate index.

In one or more embodiments, step 206 includes applying an optional mask within the fused projection-and-gating operation before storing output tensor values in the reordered layout. In one example, the optional mask is associated with pair positions of the input tensor and is applied to projected and gated tensor values before the projected tensor is partitioned into contraction operands. In some embodiments, integrating mask application into the fused operation reduces a separate read-modify-write pass that would otherwise be used to apply the mask after projection and gating. In at least one embodiment, the fused processing of step 206 may directly generate and store tensor values for operand tensor a and operand tensor b in the feature-leading layout used by step 210, such that a separately materialized feature-expanded tensor is omitted. In such an embodiment, step 208 may correspond to logical identification, selection, or separation of the first tensor and the second tensor rather than a distinct runtime chunk operation.

The system performing at least a part of process 200 includes code to at least chunk 208 the projected tensor along a leading axis to generate operands a and b. Operands a and b are contraction operands arranged for participation in a tensor contraction that sums over an intermediate index while preserving the feature-channel axis. In one example, step 208 partitions the projected tensor of shape (2D,B,I,J) along the leading axis to generate operand tensor a and operand tensor b, each having shape (D,B,I,J). Step 208 therefore produces a first tensor and a second tensor in a feature-leading layout in which the feature-channel axis and the batch axis are leading axes, such that fixed values of the feature-channel axis and the batch axis identify matrix instances for batched matrix multiplication at step 210. For a given directional arrangement, pair-index positions of operand tensor a and operand tensor b may correspond to output indices or to the intermediate index used at step 210. In at least one embodiment, the shapes shown for operand tensor a and operand tensor b at step 208 denote stored operand layouts having two trailing pair-index positions. At step 210, a selected directional arrangement may interpret those trailing pair-index positions as output-related and intermediate-index positions. Thus, the same stored operands may participate in an outgoing contraction as dbik and dbjk or in an incoming contraction as dbki and dbkj. As shown in FIG. 1, step 208 corresponds to operand generation 108 of triangular multiplicative update neural-network block 100.

The system performing at least a part of process 200 includes code to at least compute 210 a triangular contraction. Step 210 computes a triangular multiplicative update tensor by performing a tensor contraction between operand tensor a and operand tensor b stored in the feature-leading layout generated by step 208. In one example, step 210 computes a sum of products over an intermediate index k while preserving the feature-channel axis and the batch axis, such that the feature-channel axis is not summed over the intermediate index. For each pair (i,j) identified by values of the first pair-index axis and the second pair-index axis, step 210 updates the feature vector associated with that pair by computing, for each intermediate index k, a contribution from feature vectors associated with two index pairs that share the intermediate index k, and summing the contributions over k to obtain an updated feature vector for (i,j). In one example, step 210 executes the sum of products using a batched matrix multiplication in which the preserved feature-channel axis and batch axis identify matrix instances and the intermediate index k is a reduction index.

In one directional arrangement, step 210 performs an outgoing contraction according to dbik, dbjk→dbij. In that arrangement, the contraction combines features associated with a pair identified by the first pair-index axis and the intermediate index and features associated with a pair identified by the second pair-index axis and the intermediate index to produce an updated feature associated with the first pair-index axis and the second pair-index axis. In another directional arrangement, step 210 performs an incoming contraction according to dbki, dbkj→dbij. In that arrangement, the contraction combines features associated with a pair identified by the intermediate index and the first pair-index axis and features associated with a pair identified by the intermediate index and the second pair-index axis to produce the updated feature associated with the first pair-index axis and the second pair-index axis. In one example, step 210 produces a contraction output tensor having shape (D,B,I,J). For fixed values of the feature-channel axis and the batch axis, the contraction performs a matrix multiplication over the intermediate index k using corresponding slices of the contraction operands, with the first pair-index axis and the second pair-index axis defining output indices of the contraction result. Different fixed values of the feature-channel axis and the batch axis correspond to different matrix multiplications of a batched matrix multiplication, such that step 210 computes the triangular contraction in a batched matrix-multiplication form without first restoring a pair-feature layout for the contraction.

The system performing at least a part of process 200 includes code to at least perform 212 output layer norm and layout restoration. Step 212 generates a post-contraction tensor from the contraction output of step 210. A post-contraction tensor is a tensor derived from the triangular multiplicative update tensor after output-side normalization and layout handling, and in some figure-specific embodiments may also be referred to as a restored tensor. In one example, step 212 performs layer normalization on the contraction output and restores the tensor according to layout transformation dbij→bijd. Step 212 thereby stores the post-contraction tensor in a layout in which the feature-channel axis trails the first pair-index axis and the second pair-index axis. In one example, step 212 receives a tensor having shape (D,B,I,J) and produces a post-contraction tensor having shape (B,I,J,D). As shown in FIG. 1, step 212 corresponds to output normalization and transpose 112 of triangular multiplicative update neural-network block 100. In one example, step 212 stores normalized tensor values directly to memory locations corresponding to the restored layout of a pair-feature layout so that output-side normalization and layout restoration are performed without a separate layout conversion stage after normalization.

The system performing at least a part of process 200 includes code to at least perform 214 fused output projection and gating using bypass tensor and post-contraction tensor. Step 214 generates an updated pair representation using the post-contraction tensor from step 212 and bypass tensor 218 from step 204. In one example, step 214 performs an output linear projection using the post-contraction tensor, performs a gating operation using bypass tensor 218, applies a sigmoid activation to a gating branch, and combines projected values and gating values by elementwise multiplication. In one example, the post-contraction tensor provides a value branch and bypass tensor 218 provides a gating branch. Step 214 therefore receives an output-side tensor derived from triangular contraction at step 210 and an input-side tensor derived from input normalization at step 204. As shown in FIG. 1, step 214 corresponds to output projection and gating 114 and uses a bypass path corresponding to bypass tensor 120.

The system performing at least a part of process 200 includes code to at least provide 216 an output tensor. The output tensor is a tensor storing updated pairwise feature values generated by process 200. In one example, the output tensor is stored according to a layout having shape (B,I,J,D). Process 200 therefore receives the input tensor x in a pair-feature layout, performs fused input projection, sigmoid gating, masking, and transpose at step 206 to generate a feature-expanded tensor in a reordered layout, chunks the feature-expanded tensor at step 208 into operand tensor a and operand tensor b, computes a triangular multiplicative update tensor at step 210 by computing a sum of products over an intermediate index while preserving the feature-channel axis and the batch axis, performs output layer norm and layout restoration at step 212 to generate a post-contraction tensor, and performs fused output projection and gating at step 214 using bypass tensor 218 to provide the output tensor at step 216.

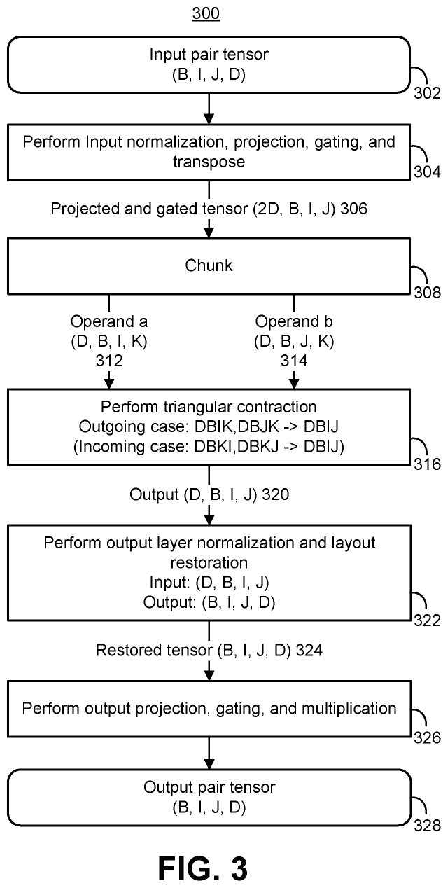

FIG. 3 illustrates an example of a process 300 to generate intermediate tensors, contraction operands, and output tensors for a triangular multiplicative update, according to at least one embodiment. In at least one embodiment, some or all of process 300, or any other processes described herein, or variations and combinations thereof, are performed under control of one or more computer systems configured with computer-executable instructions and are implemented as code executing collectively on one or more processors, by hardware, software, or combinations thereof. In at least one embodiment, the code is stored on a computer-readable storage medium in the form of a computer program comprising a plurality of computer-readable instructions executable by one or more processors. In at least one embodiment, the computer-readable storage medium is a non-transitory computer-readable medium. At least some computer-readable instructions usable to perform process 300 are not stored solely using transitory signals, such as a propagating transient electric or electromagnetic transmission. A non-transitory computer-readable medium does not necessarily include non-transitory data storage circuitry, such as buffers, caches, and queues, within transceivers of transitory signals.

For example, process 300 may be performed using triangular multiplicative update neural-network block 100 of FIG. 1, including input normalization 104, input projection, gating, mask, and transpose 106, operand generation 108, triangular contraction 110, output normalization and transpose 112, and output projection and gating 114, and may further correspond to a tensor-layout-specific implementation of process 200 of FIG. 2. In at least one embodiment, process 300 is performed by one or more systems such as those described in this present disclosure. In at least one embodiment, process 300 is performed by the system described in connection with FIGS. 1-2. In at least one embodiment, process 300 is performed by a system of one or more programming models, such as CUDA, HIP, oneAPI, or variations thereof. One or more portions of process 300 are performed in any suitable order, including sequential, parallel, or variations thereof, and by any suitable system, such as those described herein, and using any suitable processing unit, such as a CPU, GPU, PPU, GPGPU, or variations thereof. Although process 300 is depicted as a series of steps or operations, process 300 may include altered or reordered steps or operations, or omit certain steps or operations, except where explicitly noted or logically required, such as when an output of one step or operation is used as input for another. In at least one embodiment, FIG. 3 more particularly illustrates the main contraction path of FIG. 2 by showing intermediate tensors and their layouts, including projected and gated tensor 306, operand a 312, operand b 314, contraction output 320, and restored tensor 324 and, in the illustrated arrangement, FIG. 3 shows a direction-specific organization (e.g., the outgoing direction) of the contraction operands.

The system performing at least a part of process 300 includes code to at least provide 302 an input pair tensor. Input pair tensor 302 stores features associated with pairs of data items. In one example, input pair tensor 302 may be stored according to a pair-feature layout having shape (B,I,J,D), where B denotes a batch axis, I denotes a first pair-index axis, J denotes a second pair-index axis, and D denotes a feature-channel axis. In that arrangement, the first pair-index axis and the second pair-index axis identify a pair of data items, and the feature-channel axis indexes components of a feature vector associated with the identified pair of data items. FIG. 3 accordingly begins with the canonical pair-feature layout and then shows how process 300 transforms that tensor into a contraction-ready layout.

The system performing at least a part of process 300 includes code to at least perform 304 input normalization, projection, gating, masking, and transpose. Step 304 generates a projected and gated tensor from input pair tensor 302 while reordering tensor storage for downstream contraction processing. In one example, step 304 performs input normalization across the feature-channel axis, performs one or more linear projections, performs gating, applies a sigmoid activation to a gating branch, combines projected values and gated values by elementwise multiplication, and performs a transpose operation by storing tensor values according to a feature-leading layout, and may apply masking. In that respect, FIG. 3 focuses on the tensor-production path that leads to the contraction, rather than separately illustrating mask handling or bypass routing as in FIG. 2.

The system performing at least a part of process 300 includes code to at least provide 306 a projected and gated tensor. In the illustrated embodiment, projected and gated tensor 306 has shape (2D,B,I,J). Projected and gated tensor 306 is therefore a feature-expanded tensor in which projected channels occupy a leading axis of extent 2D, followed by the batch axis and the pair-index axes. FIG. 3 thus makes explicit that the projected tensor is already written in a feature-leading layout before operand generation occurs.

The system performing at least a part of process 300 includes code to at least chunk 308 projected and gated tensor 306 to generate operand a 312 and operand b 314. In one example, step 308 partitions projected and gated tensor 306 along the leading axis. In one example, step 308 splits projected and gated tensor 306 into two contraction operands that respectively provide corresponding inputs to a triangular contraction.

In the illustrated embodiment, operand a 312 is represented, for purposes of contraction-role indexing, as D, B, I, K. In the illustrated embodiment, operand b 314 is represented, for purposes of contraction-role indexing, as D, B, J, K. In at least one embodiment, projected and gated tensor 306 may be partitioned into stored tensors each having shape (D, B, I, J), and FIG. 3 depicts an outgoing directional interpretation of the trailing pair-index positions of those stored tensors. In that arrangement, both operand a 312 and operand b 314 preserve a leading feature-channel axis and a leading batch axis, while one trailing pair-index position functions as an output-related index position and another trailing pair-index position functions as an intermediate-index position, such that the feature-channel axis and the batch axis are preserved axes of the contraction, different fixed values of the feature-channel axis and the batch axis correspond to different matrix multiplications of a batched matrix multiplication, and the intermediate index axis K is a reduction axis of the triangular contraction. In another directional arrangement, the same stored tensors may instead be interpreted according to an incoming directional contraction in which the pair-index positions correspond to K, I and K, J, respectively.

The system performing at least a part of process 300 includes code to at least compute 316 a triangular contraction. Step 316 computes a triangular multiplicative update tensor by performing a tensor contraction between operand a 312 and operand b 314, while operand a 312 and operand b 314 remain stored in the feature-leading layout produced before performance of step 316. In the illustrated embodiment, step 316 computes a sum over the values of K as Σ_{K} a[d,b,i,K]·b[d,b,j,K], with the feature-channel axis and the batch axis preserved rather than reduced. In the illustrated outgoing directional arrangement, step 316 corresponds to a contraction of the form dbik, dbjk→dbij. Step 316 therefore computes a sum of products over intermediate index K while preserving the feature-channel axis and the batch axis. For each pair (i,j) identified by values of the first pair-index axis and the second pair-index axis, step 316 computes, for each intermediate index K, a contribution from feature vectors associated with two index pairs that share intermediate index K, and sums the contributions over K to obtain an updated feature vector for (i,j). In one example, step 316 performs a batched matrix multiplication in which the intermediate index K is a reduction index and fixed values of the feature-channel axis and the batch axis correspond to different matrix multiplications of the batched matrix multiplication. In another directional arrangement, corresponding contraction operands may be indexed such that the intermediate index precedes an output-related pair-index axis while the contraction remains executable in a batched matrix-multiplication form.

The system performing at least a part of process 300 includes code to at least provide 320 a contraction output. In the illustrated embodiment, contraction output 320 is represented as x[D,B,I,J]. Contraction output 320 therefore remains in a layout in which the feature-channel axis and the batch axis are leading axes after performance of the triangular contraction. For fixed values of the feature-channel axis and the batch axis, step 316 performs a matrix multiplication over the intermediate index K using corresponding slices of operand a 312 and operand b 314, with the first pair-index axis and the second pair-index axis defining output indices of the contraction result. Different fixed values of the feature-channel axis and the batch axis correspond to different matrix multiplications of a batched matrix multiplication. FIG. 3 accordingly emphasizes the tensor-layout consequence of the contraction, namely, that the contraction output remains in a feature-leading layout before output-side restoration, and, in the illustrated outgoing directional arrangement, the contraction output is produced from operands indexed as dbik and dbjk, such that the intermediate index axis trails the output-related pair-index axes.

The system performing at least a part of process 300 includes code to at least perform 322 output layer normalization and transpose. Step 322 generates a post-contraction tensor from contraction output 320. In one example, step 322 performs layer normalization on contraction output 320 and stores the resulting tensor according to a restored pair-feature layout in which the feature-channel axis trails the pair-index axes, such that normalized tensor values are written directly to memory locations corresponding to the restored layout during execution of output-side processing. Step 322 therefore performs output-side normalization and layout restoration on the tensor produced by step 316 without requiring a separate layout-conversion stage after normalization.

The system performing at least a part of process 300 includes code to at least provide 324 a restored tensor. In the illustrated embodiment, restored tensor 324 has shape (B,I,J,D). Restored tensor 324 thus returns the contraction result from the feature-leading contraction layout to a pair-feature layout in which the batch axis is followed by the first pair-index axis, the second pair-index axis, and the feature-channel axis, so that downstream output projection, gating, and multiplication consume a tensor already arranged for output-side processing.

The system performing at least a part of process 300 includes code to at least perform 326 output projection, sigmoid gating, and multiplication. Step 326 generates an updated pair representation from restored tensor 324. In one example, step 326 performs an output linear projection, performs a gated operation, applies a sigmoid activation to a gating branch, and combines projected values and gated values by elementwise multiplication. FIG. 3 accordingly illustrates the output-side path in terms of the tensor produced after restoration and the operations performed on that restored tensor. In some embodiments, output projection, sigmoid gating, and multiplication may additionally receive a bypass tensor from an input-side path, although that bypass path is not separately illustrated in FIG. 3.

The system performing at least a part of process 300 includes code to at least provide 328 an output pair tensor. In the illustrated embodiment, output pair tensor 328 has shape (B,I,J,D). Output pair tensor 328 therefore preserves the overall pair-feature organization of input pair tensor 302 while reflecting updates introduced by the triangular contraction and the output-side projection and gating operations.

Accordingly, FIG. 3 illustrates a tensor-layout-specific process in which input pair tensor 302 in layout (B,I,J,D) is transformed at step 304 into projected and gated tensor 306 in layout (2D,B,I,J), and is represented at step 308 as operand a 312 and operand b 314 according to direction-specific contraction-role indexing D,B,I,K and D,B,J,K, respectively, for the illustrated outgoing arrangement, contracted at step 316 to generate contraction output 320 in layout D,B,I,J, normalized and transposed at step 322 to generate restored tensor 324 in layout (B,I,J,D), and further processed at step 326 to generate output pair tensor 328. Whereas FIG. 2 illustrates an overall triangular multiplicative update process including broader process flow, FIG. 3 more particularly illustrates intermediate tensors, operand layouts, and contraction-specific tensor organization used within that process.

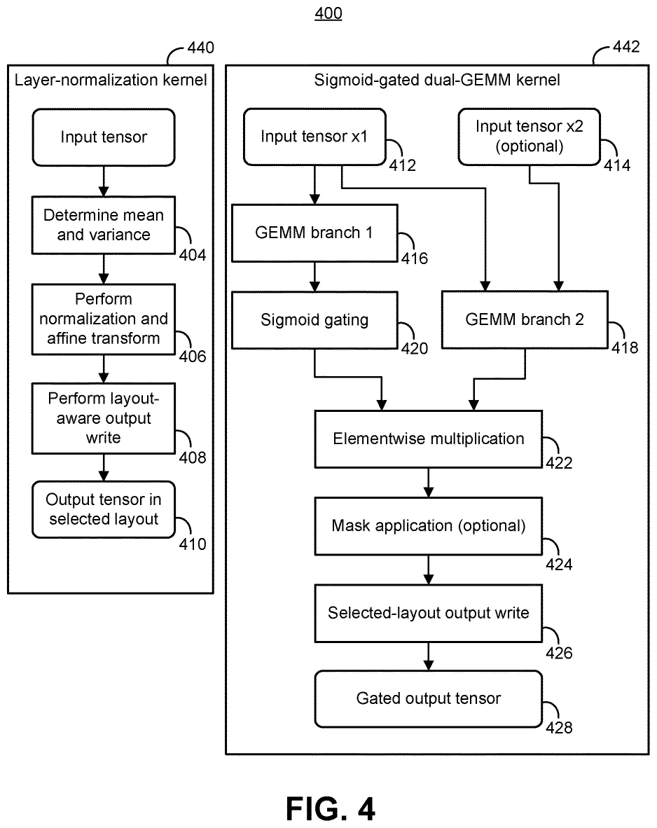

FIG. 4 illustrates example GPU kernels 400 usable in a triangular multiplicative update neural-network block, according to at least one embodiment. In the illustrated embodiment, FIG. 4 includes a layer-normalization kernel 440 and a sigmoid-gated dual-General Matrix Multiply (GEMM) kernel 442. The kernels 440, 442 may be used to implement operations of triangular multiplicative update neural-network block 100 of FIG. 1, including input normalization 104, input projection, gating, mask, and transpose 106, output normalization and transpose 112, and output projection and gating 114. The kernels of FIG. 4 may also be used to implement corresponding operations of process 200 of FIG. 2 and process 300 of FIG. 3, including writing intermediate tensors directly in layouts selected for downstream triangular contraction and downstream output processing.

An input tensor 402 provides input values to the layer-normalization kernel. In one example, input tensor 402 is a tensor representing features associated with pairs of data items and includes a feature-channel axis over which normalization is performed. In one example, input tensor 402 is provided in a pair-feature layout having shape (B,I,J,D). In another example, input tensor 402 is provided in a feature-leading layout having shape (D,B,I,J). Accordingly, input tensor 402 may correspond to an input-side tensor before contraction or an output of a triangular contraction before restoration to a pair-feature layout, such that the layer-normalization kernel may be used on either side of the triangular contraction while preserving or changing layout during output storage.

A mean and variance computation 404 computes normalization statistics for input tensor 402. In one example, mean and variance computation 404 computes a mean and a variance across the feature-channel axis for each position identified by non-feature indices of input tensor 402. In implementations in which input tensor 402 is logically a four-dimensional tensor, the layer-normalization kernel may flatten non-feature axes for kernel execution while preserving the logical relationship among the batch axis and pair-index axes. Mean and variance computation 404 thereby generates normalization statistics used to normalize feature values of input tensor 402.

A normalization and affine transform 406 generates normalized values from input tensor 402 using the statistics computed at mean and variance computation 404. In one example, normalization and affine transform 406 subtracts the mean, scales by a reciprocal standard deviation, and applies an affine scale and bias. Thus, normalization and affine transform 406 performs layer normalization across the feature-channel axis and may further apply learned scale and bias parameters to the normalized values before the normalized values are written according to a selected layout.

A layout-aware output write 408 stores normalized values according to a selected output layout. In one example, layout-aware output write 408 stores the normalized values directly to memory locations corresponding to a target layout instead of first storing the normalized values in one layout and then performing a separate transpose operation. In one example, the layer-normalization kernel performs layer normalization and layout conversion within a same kernel invocation so that normalized values are written directly to memory locations corresponding to the selected output layout. In one example, layout-aware output write 408 stores values in a feature-leading layout in which the feature-channel axis precedes pair-index axes, such as a layout corresponding to shape (D,B,I,J) or (B,D,I,J). In another example, layout-aware output write 408 stores values in a pair-feature layout in which the feature-channel axis trails the pair-index axes, such as a layout corresponding to shape (B,I,J,D). Layout-aware output write 408 therefore implements layout selection during kernel execution, which may reduce repeated memory accesses and may avoid allocating an intermediate tensor between normalization and storage in the selected output layout.

An output tensor in selected layout 410 stores normalized tensor values produced by the layer-normalization kernel. In one example, output tensor in selected layout 410 is a normalized tensor written directly in a layout selected for a downstream operation. Thus, output tensor in selected layout 410 may provide a contraction-ready tensor for an input-side path or a restored post-contraction tensor for an output-side path, and a downstream stage may consume output tensor in selected layout 410 without executing a separate layout-conversion stage between the layer-normalization kernel and the downstream stage.

An input tensor x1 412 provides a first input to the sigmoid-gated dual-GEMM kernel. In one example, input tensor x1 412 is an input tensor representing features associated with pairs of data items. In one example, input tensor x1 412 is flattened along non-feature axes for purposes of matrix multiplication, such that the kernel treats input tensor x1 412 as a matrix having an extent M along a flattened non-feature axis and an extent Kalong a feature axis. Input tensor x1 412 may correspond to a normalized input tensor used for input-side projection and gating, or to a bypass tensor used in output-side gating.

An optional input tensor x2 414 provides an optional second input to the sigmoid-gated dual-GEMM kernel. In one example, optional input tensor x2 414 is omitted, and both GEMM branches operate on input tensor x1 412. In another example, optional input tensor x2 414 is provided, such that a first GEMM branch operates on input tensor x1 412 and a second GEMM branch operates on optional input tensor x2 414. This permits the same kernel family to support both a single-input embodiment, such as input-side projection and gating, and a dual-input embodiment, such as output-side projection and gating using a bypass tensor and a post-contraction tensor, while retaining projected values within the same kernel for downstream gating and output storage.

A GEMM branch 1 416 computes a first projected tensor from input tensor x1 412. In one example, GEMM branch 1 416 performs a matrix multiplication and optional bias addition according to

$${A}_{1} = {X}_{1} {W}_{1}^{T} + {b}_{1} .$$

In one example, GEMM branch 1 416 generates values used for a gating branch of the sigmoid-gated dual-GEMM kernel, and the generated values are combined with values of GEMM branch 2 418 within the same kernel before output values are written to memory. In some embodiments, the fused layer-normalization-and-transpose operation has a corresponding backward operation configured to compute gradients associated with the fused layer-normalization-and-transpose operation. For example, the backward operation may compute a gradient with respect to an input tensor of the fused layer-normalization-and-transpose operation and, in embodiments using an affine normalization, may further compute a gradient with respect to a scale parameter and a gradient with respect to a bias parameter. In some embodiments, the backward operation computes such gradients while accounting for a layout mapping used in the fused layer-normalization-and-transpose operation, such that gradient computation corresponds to normalized values that were written according to a selected output layout during forward propagation. In some embodiments, the backward operation computes one or more intermediate normalization values, including one or more of a mean or a reciprocal standard deviation, and uses the one or more intermediate normalization values in determining gradients for normalized tensor values.

A GEMM branch 2 418 computes a second projected tensor from input tensor x1 412 or optional input tensor x2 414. In one example, GEMM branch 2 418 performs a matrix multiplication and optional bias addition according to

$${A}_{2} = {X}_{2} {W}_{2}^{T} + {b}_{2} ,$$

or, when optional input tensor x2 414 is omitted,

$${A}_{2} = {X}_{1} {W}_{2}^{T} + {b}_{2} .$$

In one example, GEMM branch 2 418 generates values used for a value branch of the sigmoid-gated dual-GEMM kernel, and the value branch is combined with the gating branch before optional mask application and storage in a selected layout.

A sigmoid gating 420 applies a sigmoid activation to output values of GEMM branch 1 416. In one example, sigmoid gating 420 computes

G=σ(A₁).

Sigmoid gating 420 thereby generates gating values that modulate output values of GEMM branch 2 418 within the sigmoid-gated dual-GEMM kernel. An elementwise multiplication 422 combines outputs of sigmoid gating 420 and GEMM branch 2 418. In one example, elementwise multiplication 422 computes an elementwise product between σ(A1) and A2 (e.g., a Hadamard product).

Elementwise multiplication 422 thereby generates a gated projected tensor. In an input-side embodiment, the gated projected tensor may correspond to a feature-expanded tensor that is later split into contraction operands. In an output-side embodiment, the gated projected tensor may correspond to an updated pair representation produced from a bypass tensor and a post-contraction tensor. In one example, the gated projected tensor is generated before a selected-layout output write so that the sigmoid-gated dual-GEMM kernel writes output values directly in a layout used by a downstream stage.

An optional mask application 424 applies a mask to output values of elementwise multiplication 422. In one example, optional mask application 424 multiplies each output row or tensor position by a corresponding mask value to suppress or retain selected pair locations. In one example, the mask indicates whether corresponding tensor elements contribute to a downstream triangular contraction or to subsequent computations. Optional mask application 424 is therefore usable in embodiments in which a pair mask is provided to the triangular multiplicative update.

A selected-layout output write 426 stores output values of the sigmoid-gated dual-GEMM kernel according to a selected layout. In one example, selected-layout output write 426 stores output values directly to memory addresses corresponding to a feature-leading layout in which a feature-channel axis precedes pair-index axes. In one example, selected-layout output write 426 performs a transposed write such that a matrix result having logical shape (M,N) is stored as (N,M) before restoration to higher-dimensional tensor form. In one example, selected-layout output write 426 stores a feature-expanded tensor directly in shape (2D,B,I,J) for subsequent chunking into contraction operands arranged in a feature-leading layout for triangular contraction. In another example, selected-layout output write 426 stores output values in a layout suitable for downstream output use. Selected-layout output write 426 therefore implements layout selection during output storage rather than by a separate later transpose operation, and, in an input-side embodiment, may implement a layout conversion associated with a triangular contraction stage during projection-and-gating processing so that the downstream triangular contraction consumes operands already stored in a contraction-ready layout.

In at least one embodiment, a fused kernel that performs normalization and layout conversion is parameterized by a layout configuration that specifies both an input-side tensor layout and an output-side tensor layout. The layout configuration may be selected at compile time and may define how pointer arithmetic used by the kernel accesses tensor elements of an input tensor and writes tensor elements of an output tensor. For example, a kernel implementation may support multiple combinations of input-side and output-side layouts, and compile-time selection of a layout configuration may specialize address-generation logic used for reading and writing tensor elements. By configuring input-side and output-side layouts independently and specializing memory-access pointer arithmetic according to the selected layout configuration, a fused kernel may support multiple tensor-layout transformations while avoiding runtime layout-conversion logic and while enabling efficient memory-access patterns. In at least one embodiment, the fused kernel supports a plurality of layout transformations using a single kernel implementation. For example, a layout configuration may identify a particular combination of an input tensor layout and an output tensor layout, and the fused kernel may generate memory addresses for loading tensor elements from the input tensor and storing tensor elements of the output tensor according to pointer arithmetic associated with the identified layout combination. Different layout configurations may correspond to different ordering relationships among batch, feature-channel, and pair-index axes, and the fused kernel may use different pointer-arithmetic expressions for input accesses and output writes based on the selected layout configuration.

A gated output tensor 428 stores output values produced by the sigmoid-gated dual-GEMM kernel. In one example, gated output tensor 428 is a projected and gated tensor written in a layout selected for downstream processing. In one example, gated output tensor 428 has a feature-expanded shape and is later split into a first tensor and a second tensor for triangular contraction. In another example, gated output tensor 428 is an output tensor produced from a bypass tensor and a post-contraction tensor. Accordingly, gated output tensor 428 may be consumed by a downstream stage while remaining stored in the selected layout written by selected-layout output write 426.

FIG. 4 therefore illustrates two kernel structures used in the disclosed GPU embodiment. The layer-normalization kernel receives input tensor 402, computes normalization statistics at mean and variance computation 404, generates normalized values at normalization and affine transform 406, and stores output tensor in selected layout 410 through layout-aware output write 408, such that normalization and layout conversion may be performed within a same kernel and normalized values may be written directly in a layout selected for downstream processing. The sigmoid-gated dual-GEMM kernel receives input tensor x1 412 and, optionally, input tensor x2 414, computes projected tensors at GEMM branch 1 416 and GEMM branch 2 418, applies sigmoid gating 420, combines values at elementwise multiplication 422, optionally applies a mask at optional mask application 424, and stores gated output tensor 428 through selected-layout output write 426. In this manner, FIG. 4 shows kernel-level structures that support direct storage of intermediate tensors in layouts selected for downstream triangular contraction and downstream output processing, including use of a fused kernel to write tensor values directly in a layout used by a downstream triangular contraction, such that a separate layout-conversion stage before the triangular contraction is omitted.

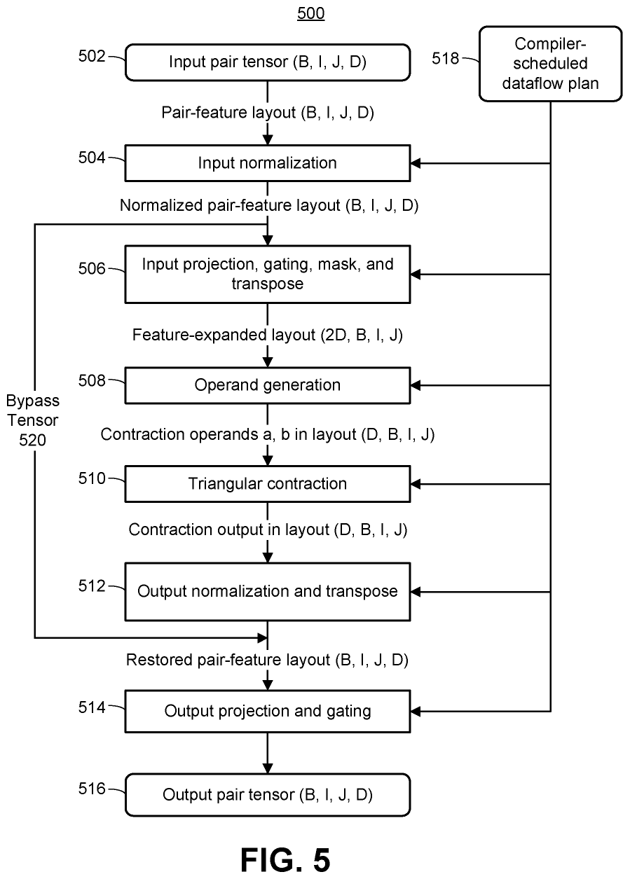

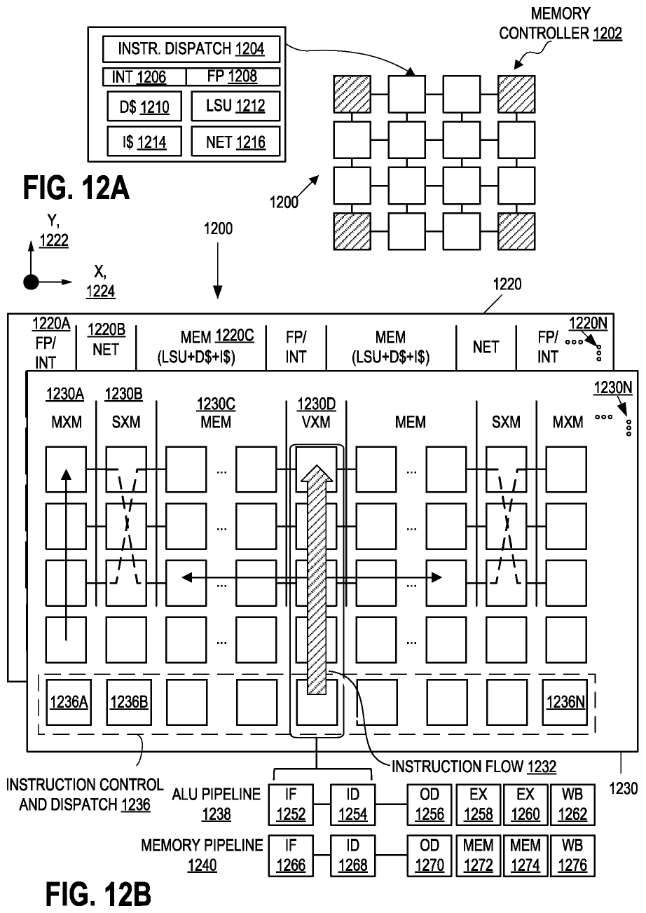

FIG. 5 illustrates an example of a compiler-scheduled triangular multiplicative update neural-network block 500, according to at least one embodiment. For example, compiler-scheduled triangular multiplicative update neural-network block 500 may implement a triangular multiplicative update corresponding to triangular multiplicative update neural-network block 100 of FIG. 1 and processes 200 and 300 of FIGS. 2 and 3, while a compiler-scheduled dataflow plan 518 controls scheduling and memory layout of intermediate tensors used by downstream operations. In the illustrated embodiment, compiler-scheduled triangular multiplicative update neural-network block 500 includes an input pair tensor 502, an input normalization stage 504, an input projection, gating, mask, and transpose stage 506, an operand generation stage 508, a bypass tensor 520, a triangular contraction stage 510, an output normalization and transpose stage 512, an output projection and gating stage 514, and an output pair tensor 516. A compiler-scheduled triangular multiplicative update neural-network block 500 may be executed using a language processing unit (LPU), examples of which are illustrated in FIGS. 12A and 12B, or another compiler-scheduled processor according to at least one embodiment, in at least one embodiment, compiler-scheduled dataflow plan 518 determines scheduling, communication, buffer assignment, and layout handling for intermediate tensors used by the stages of compiler-scheduled triangular multiplicative update neural-network block 500.

An input pair tensor 502 stores features associated with pairs of data items. In one example, input pair tensor 502 may be stored according to a pair-feature layout having shape (B,I,J,D), where B denotes a batch axis, I denotes a first pair-index axis, J denotes a second pair-index axis, and D denotes a feature-channel axis. In that arrangement, the first pair-index axis and the second pair-index axis identify a pair of data items, and the feature-channel axis indexes components of a feature vector associated with the identified pair of data items.

A compiler-scheduled dataflow plan 518 controls execution of compiler-scheduled triangular multiplicative update neural-network block 500. In one example, compiler-scheduled dataflow plan 518 is generated by analyzing a graph of operations of the triangular multiplicative update and decomposing the graph into scheduled stages or sub-tasks, including input normalization stage 504, input projection, gating, mask, and transpose stage 506, operand generation stage 508, triangular contraction stage 510, output normalization and transpose stage 512, and output projection and gating stage 514. The compiler-scheduled dataflow plan 518 may identify data dependencies among the stages, assign the stages to processing resources of a language processing unit, and determine a static execution order in which producer stages generate intermediate tensors before dependent consumer stages consume the intermediate tensors. In one example, compiler-scheduled dataflow plan 518 further assigns output buffers for intermediate tensors, including output buffers that store the first tensor and the second tensor used by triangular contraction stage 510, determines memory locations and buffer lifetimes for the intermediate tensors, and permits reuse of memory storage across stages whose buffer lifetimes do not overlap. Accordingly, compiler-scheduled dataflow plan 518 may control not only which stage computes a given tensor, but also when the tensor is produced, where the tensor is stored, and when the tensor is made available to a downstream stage, including assignment of output-buffer layouts for tensors generated by input normalization stage 504, input projection, gating, mask, and transpose stage 506, operand generation stage 508, triangular contraction stage 510, output normalization and transpose stage 512, and output projection and gating stage 514.

In one example, compiler-scheduled dataflow plan 518 further specifies communication and layout handling for intermediate tensors passed between scheduled stages. For example, when a producer stage generates a normalized tensor, a projected tensor, contraction operands, or a contraction output, the compiler may assign the producer stage to write tensor elements directly to memory locations corresponding to a selected layout expected by a downstream consumer stage, including assigning output buffers that store the first tensor and the second tensor according to the selected layout expected by triangular contraction stage 510, and may schedule communication of the tensor to a local memory region, a distributed memory region, or another processing resource that executes the downstream consumer stage. In at least one embodiment, the selected layout is a feature-leading layout in which the feature-channel axis and, when present, the batch axis are leading axes for downstream triangular contraction stage 510. A downstream consumer stage may then read tensor elements from the assigned buffer according to the selected layout without executing a separate transpose stage or without generating a separate intermediate tensor in the selected layout. By coordinating graph decomposition, static scheduling, buffer assignment, communication of tensor data, and layout-aware producer and consumer behavior, compiler-scheduled dataflow plan 518 causes triangular contraction stage 510 to execute on operands already arranged for batched matrix multiplication over the intermediate index, while downstream stages restore or continue propagation of a selected layout as needed. In one example, compiler-scheduled dataflow plan 518 causes a producer stage to write tensor elements directly to memory locations corresponding to a selected reordered layout expected by a downstream consumer stage, rather than producing a tensor in a canonical layout and then executing a separate transpose stage or generating a separate intermediate tensor in the selected reordered layout.

An input normalization stage 504 generates a normalized tensor from input pair tensor 502. In one example, input normalization stage 504 performs layer normalization across the feature-channel axis while preserving the pair-feature organization of input pair tensor 502. As indicated in FIG. 5, input normalization stage 504 produces a normalized tensor in a normalized pair-feature layout having shape (B,I,J,D). In one example, compiler-scheduled dataflow plan 518 schedules input normalization stage 504 so that the normalized tensor is produced in a layout selected for downstream processing by input projection, gating, mask, and transpose stage 506, and so that a normalized tensor is retained as bypass tensor 520 for downstream output gating.

A bypass tensor 520 provides input-side feature information to output projection and gating stage 514. In one example, bypass tensor 520 corresponds to a normalized tensor generated by input normalization stage 504 and retained for downstream gating. Bypass tensor 520 bypasses input projection, gating, mask, and transpose stage 506, operand generation stage 508, triangular contraction stage 510, and output normalization and transpose stage 512 so that output projection and gating stage 514 receives both a restored tensor and bypass tensor 520. In one example, compiler-scheduled dataflow plan 518 schedules storage and communication of bypass tensor 520 so that bypass tensor 520 is provided to output projection and gating stage 514 according to a layout used by a gating branch of output projection and gating stage 514.

An input projection and gating, masking, and transpose stage 506 generates a feature-expanded tensor from the normalized tensor produced by input normalization stage 504. In one example, input projection, gating, mask, and transpose stage 506 performs one or more linear projections, gating, sigmoid activation, and elementwise multiplication, optional mask application, and layout-mapped output storage to generate projected and gated values. A mask tensor may indicate whether corresponding tensor elements contribute to triangular contraction stage 510 or to subsequent computations. As indicated in FIG. 5, input projection and gating stage 506 produces a feature-expanded layout having shape (2D,B,I,J). That arrangement places an expanded feature-channel axis and the batch axis ahead of the pair-index axes. In one example, compiler-scheduled dataflow plan 518 assigns the output of input projection, gating, mask, and transpose stage 506 to a feature-leading layout in which the feature-channel axis precedes the pair-index axes, such that a transpose is implemented by layout-mapped writes rather than by a separate transpose operation. In at least one embodiment, one or more producer operations scheduled according to compiler-scheduled dataflow plan 518 may directly write tensor values of the first tensor and tensor values of the second tensor to respective output buffers in the selected layout, such that operand generation stage 508 corresponds to logical identification or separation of the contraction operands rather than a separate runtime partitioning step.

In at least one embodiment, input projection, gating, masking, and transpose stage 506 is implemented by one or more producer operations scheduled according to compiler-scheduled dataflow plan 518. In one example, a producer operation receives a common tensor derived from input pair tensor 502, such as a normalized tensor produced from input normalization stage 504, and performs a first matrix multiplication and a second matrix multiplication using the common tensor. In some embodiments, the common tensor is loaded once for use in both the first matrix multiplication and the second matrix multiplication, such that the producer operation generates a first result corresponding to a gate-projection result and a second result corresponding to a value-projection result. In some embodiments, the producer operation applies a sigmoid activation to the gate-projection result and combines the gate-projection result with the value-projection result by elementwise multiplication to generate projected and gated tensor values. In some embodiments, the producer operation further applies an optional mask to the projected and gated tensor values. The producer operation stores the projected and gated tensor values directly to one or more output buffers assigned according to the second ordered memory layout, such that the feature-channel axis is a leading axis in the stored tensor. In some embodiments, the tensor written by the producer operation is a feature-expanded tensor from which operand generation stage 508 generates the first tensor and the second tensor for triangular contraction stage 510. For example, the feature-expanded tensor may include gate-modulated projected values having a feature-channel extent greater than that of input pair tensor 502, and operand generation stage 508 may partition the feature-expanded tensor along the feature-channel axis while the feature-expanded tensor remains stored in the second ordered memory layout. By generating the gate-projection result and the value-projection result from the common tensor and by writing resulting tensor values directly in the second ordered memory layout, the compiler-scheduled embodiment reduces separate loading, intermediate buffering, and layout-conversion overhead.

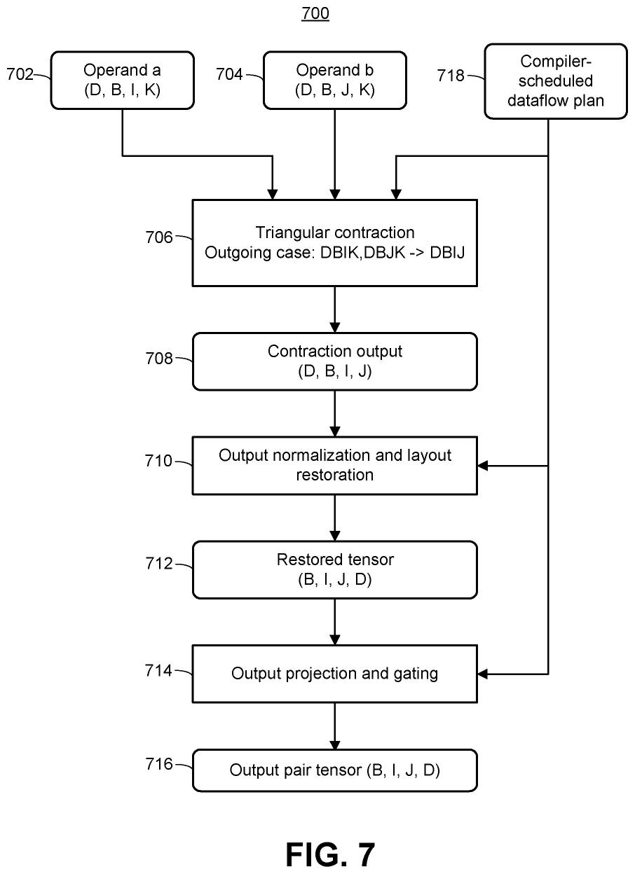

An operand generation stage 508 generates contraction operands from the feature-expanded tensor produced by input projection, gating, mask, and transpose stage 506. In one example, operand generation stage 508 partitions or otherwise transforms the feature-expanded tensor of shape (2D,B,I,J) into a first tensor and a second tensor, identified in FIG. 5 as contraction operands a and bin feature-leading layout. In one example, each of contraction operands a and b has shape (D,B,I,J). Compiler-scheduled dataflow plan 518 may assign output buffers that store the first tensor and the second tensor according to the feature-leading layout, so that operand generation stage 508 writes the first tensor and the second tensor directly to the assigned output buffers for downstream triangular contraction stage 510. Operand generation stage 508 therefore provides contraction operands in a layout in which the feature-channel axis and the batch axis are leading axes for downstream triangular contraction stage 510, and, for a given directional arrangement, pair-index positions of the contraction operands may correspond to output indices or to an intermediate index used by triangular contraction stage 510. In at least one embodiment, the notation (D,B,I,J) used for contraction operands a and b in FIG. 5 denotes stored feature-leading tensors having two trailing pair-index positions, and a selected directional arrangement determines how those trailing pair-index positions are interpreted at triangular contraction stage 510. FIG. 7 illustrates one example of a direction-specific outgoing arrangement in which the corresponding operands are indexed as (D,B,I,K) and (D,B,J,K).

In at least one embodiment, output projection and gating stage 514 receives a bypass tensor derived from input pair tensor 502 at a gating branch and receives a post-contraction tensor derived from output normalization and transpose stage 512 at a value branch. Output projection and gating stage 514 generates gating values from the bypass tensor and generates projected values from the post-contraction tensor, and combines the gating values and the projected values by elementwise multiplication to generate output pair tensor 516. The compiler-scheduled embodiment therefore preserves a distinction between a gating branch and a value branch while allowing dataflow scheduling and buffer assignment to be selected by compiler-scheduled dataflow plan 518.

A triangular contraction stage 510 computes a triangular multiplicative update tensor using the contraction operands produced by operand generation stage 508. In one example, triangular contraction stage 510 performs a tensor contraction that sums over an intermediate index while preserving the feature-channel axis and the batch axis. Thus, the feature-channel axis is not summed over the intermediate index. In one example, for each pair (i,j) identified by values of the first pair-index axis and the second pair-index axis, triangular contraction stage 510 computes, for each intermediate index k, a contribution from feature vectors associated with two index pairs that share the intermediate index k, and sums the contributions over k to obtain an updated feature vector for (i,j). As indicated in FIG. 5, triangular contraction stage 510 produces a contraction output in feature-leading layout having shape (D,B,I,J). For fixed values of the feature-channel axis and the batch axis, triangular contraction stage 510 performs a matrix multiplication over the intermediate index using corresponding slices of the contraction operands, and different fixed values of the feature-channel axis and the batch axis correspond to different matrix multiplications of a batched matrix multiplication. Triangular contraction stage 510 is therefore executable in a batched matrix-multiplication form over the intermediate index, such that compiler-scheduled dataflow plan 518 schedules triangular contraction stage 510 on operands already stored in the feature-leading layout assigned by upstream producer operations.

An output normalization and transpose stage 512 generates a restored tensor from the contraction output of triangular contraction stage 510. In one example, output normalization and transpose stage 512 performs layer normalization on the contraction output and produces a restored pair-feature layout having shape (B,I,J,D). Thus, output normalization and transpose stage 512 restores the feature-channel axis to a trailing position following the first pair-index axis and the second pair-index axis. In one example, compiler-scheduled dataflow plan 518 schedules output normalization and transpose stage 512 to write normalized tensor values directly in the restored pair-feature layout, such that layout restoration is implemented by layout-mapped writes during output-side processing.

An output projection and gating stage 514 generates an updated pair representation using the restored tensor produced by output normalization and transpose stage 512 and bypass tensor 520 from input normalization stage 504. In one example, output projection and gating stage 514 performs an output projection using the restored tensor, performs a gating operation using bypass tensor 520, applies a sigmoid activation to a gating branch, and combines projected values and gating values by elementwise multiplication to generate output values for downstream use. As indicated in FIG. 5, output projection and gating stage 514 receives a restored tensor in a pair-feature layout and bypass tensor 520 and produces output pair tensor 516. An output pair tensor 516 stores updated pairwise feature values generated by compiler-scheduled triangular multiplicative update neural-network block 500. In one example, output pair tensor 516 is stored in a pair-feature layout having shape (B,I,J,D). FIG. 5 therefore illustrates a compiler-scheduled embodiment in which input pair tensor 502 is received in a pair-feature layout, intermediate tensors are produced according to layouts selected by compiler-scheduled dataflow plan 518, bypass tensor 520 is retained from input normalization stage 504 for downstream gating, contraction operands are generated in a feature-leading layout for triangular contraction stage 510, and a restored pair-feature layout is produced for output projection and gating stage 514 and output pair tensor 516.

FIG. 5 further illustrates that compiler-scheduled dataflow plan 518 influences multiple points of compiler-scheduled triangular multiplicative update neural-network block 500 rather than only triangular contraction stage 510. In one example, compiler-scheduled dataflow plan 518 assigns output layouts for producer operations so that intermediate tensors are written directly in layouts used by downstream consumer operations. In that arrangement, a selected reordered layout is propagated across multiple stages of compiler-scheduled triangular multiplicative update neural-network block 500, reducing or eliminating separate layout-conversion stages between production of an intermediate tensor and consumption of that intermediate tensor by a downstream stage and, in some embodiments, output-side restoration to a pair-feature layout is performed only when needed by a downstream stage. FIG. 5 may simplify aspects of storage, communication, or timing of bypass tensor 520 within that dataflow.

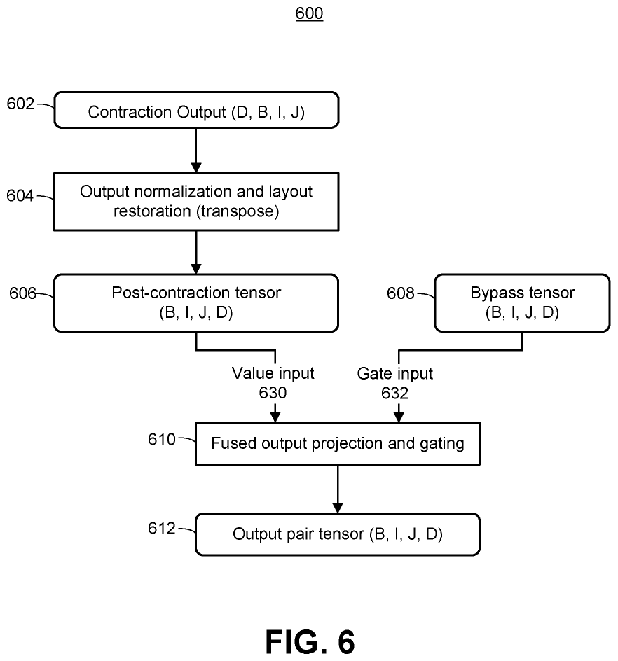

FIG. 6 illustrates an example of output-side processing 600 for a triangular multiplicative update, according to at least one embodiment. Whereas FIG. 1 illustrates a triangular multiplicative update neural-network block 100 and FIG. 5 illustrates a compiler-scheduled triangular multiplicative update neural-network block 500, FIG. 6 more particularly illustrates output-side processing usable in either embodiment, including a contraction output 602, output normalization and layout restoration 604, a post-contraction tensor 606, a bypass tensor 608, fused output projection and gating 610, and an output pair tensor 612.

For example, the interactions of FRG 6 may be implemented using output normalization and transpose 112 and output projection and gating 14 of FIG. 1 and, in one compiler-scheduled example, output normalization and transpose stage 512 and output projection and gating stage 514 of FIG. 5. In at least one embodiment, FIG. 6 illustrates tensor interactions that occur after a triangular contraction has been computed and before final output pair values are provided. Thus, FIG. 6 focuses on output-side tensor flow and output-side gating relationships, rather than on the full end-to-end arrangement shown in FIG. 5.

A contraction output 602 stores updated pairwise values produced by a triangular contraction. In one example, contraction output 602 corresponds to a triangular multiplicative update tensor produced by a tensor contraction that sums over an intermediate index while preserving a feature-channel axis. In one example, contraction output 602 is stored in a feature-leading layout having shape (D,B,I,J), where D denotes a feature-channel axis, B denotes a batch axis, I denotes a first pair-index axis, and J denotes a second pair-index axis. In that arrangement, the feature-channel axis and the batch axis are leading axes, and the first pair-index axis and the second pair-index axis define output indices of the contraction result for fixed values of the feature-channel axis and the batch axis.

Output normalization and layout restoration 604 generates a post-contraction tensor 606 from contraction output 602. In one example, output normalization and layout restoration 604 performs layer normalization on contraction output 602 and stores normalized values in a pair-feature layout in which the feature-channel axis trails the first pair-index axis and the second pair-index axis. Output normalization and layout restoration 604 therefore converts contraction output 602 from a feature-leading layout to a pair-feature layout by writing normalized tensor values directly to memory locations corresponding to the restored pair-feature layout. In one example, output normalization and layout restoration 604 receives contraction output 602 in shape (D,B,I,J) and generates post-contraction tensor 606 in shape (B,I,J,D), without requiring a separate layout-conversion stage after normalization, such that post-contraction tensor 606 is a restored tensor for downstream output-side processing.

A post-contraction tensor 606 stores normalized output-side values derived from contraction output 602. In one example, post-contraction tensor 606 is stored according to a pair-feature layout having shape (B,I,J,D). FIG. 6 identifies post-contraction tensor 606 as a value input to fused output projection and gating 610. In that arrangement, post-contraction tensor 606 supplies output-side values to be projected in a final output-side operation, after layout restoration from the feature-leading layout of contraction output 602, and post-contraction tensor 606 may accordingly be regarded as a restored tensor in the output-side path.

A bypass tensor 608 supplies input-side information to fused output projection and gating 610. In one example, bypass tensor 608 is derived from an earlier tensor of the triangular multiplicative update neural-network block, such as a normalized input-side tensor retained for later gating. In one example, bypass tensor 608 is stored in a pair-feature layout having shape (B,I,J,D). FIG. 6 identifies bypass tensor 608 as a gate input to fused output projection and gating 610. In that arrangement, bypass tensor 608 supplies values used to generate a gating signal for modulating projected output-side values, such that a gating branch and a value branch are provided from different tensors.

Fused output projection and gating 610 generates output pair tensor 612 using post-contraction tensor 606 and bypass tensor 608. In one example, fused output projection and gating 610 performs an output linear projection using post-contraction tensor 606, performs a gating operation using bypass tensor 608, applies a sigmoid activation to a gating branch, and combines projected values and gating values by elementwise multiplication. Thus, fused output projection and gating 610 receives a value input derived from contraction output 602 through output normalization and layout restoration 604 and separately receives a gate input derived from an earlier input-side path.

In one example, fused output projection and gating 610 computes gating values according to g=σ(W_{g}x_{g}+b_{g}) and computes projected values according to v=Wₚxᵥ+bₚ, where x_{g} corresponds to bypass tensor 608 and xᵥ corresponds to post-contraction tensor 606. Fused output projection and gating 610 then computes an elementwise product between g and v to produce output tensor y, such that g⊙v. In that example, each element of output tensor y is generated by multiplying a corresponding element of g with a corresponding element of v, and output pair tensor 612 corresponds to tensor y.

In at least one embodiment, a fused sigmoid-gated dual matrix multiplication operation of the triangular multiplicative update neural-network block 100 has a corresponding backward operation configured to compute gradients associated with the fused sigmoid-gated dual matrix multiplication operation. In one example, the backward operation computes a first gradient term associated with a gating branch and a second gradient term associated with a projected-value branch. In embodiments in which the fused sigmoid-gated dual matrix multiplication operation uses a single input tensor for both matrix multiplications, the backward operation computes gradients corresponding to both matrix multiplications with respect to the single input tensor. In embodiments in which the fused sigmoid-gated dual matrix multiplication operation uses a first input tensor for the gating branch and a second input tensor for the projected-value branch, the backward operation computes gradients corresponding to the first input tensor and the second input tensor separately.

In at least one embodiment, backward propagation for the fused sigmoid-gated dual matrix multiplication operation of the triangular multiplicative update neural-network block recomputes one or more intermediate values used during forward propagation rather than storing all such intermediate values from the forward pass. For example, a backward operation corresponding to the fused sigmoid-gated dual matrix multiplication operation may recompute one or more projection accumulations, one or more gating accumulations, or both, and may use the recomputed accumulations in determining one or more gradients. Such recomputation may reduce storage of forward intermediate values and improve memory efficiency during training. In some embodiments, backward propagation for the fused sigmoid-gated dual matrix multiplication operation of the triangular multiplicative update neural-network block computes one or more gradients with respect to one or more weight tensors, one or more bias tensors, one or more input tensors, or a mask tensor, or any combination thereof. In one example, the backward operation computes a gradient associated with a mask that was applied during forward propagation after sigmoid gating and elementwise combination. In some embodiments, the backward operation computes one or more bias gradients by accumulation over one or more rows or tiles associated with output channels of the fused sigmoid-gated dual matrix multiplication operation.

An output pair tensor 612 stores updated pairwise feature values produced by output-side processing 600. In one example, output pair tensor 612 is stored in a pair-feature layout having shape (B,I,J,D). Output pair tensor 612 therefore preserves the overall pair-feature organization used by downstream pair-representation processing while incorporating values generated from contraction output 602 and modulation provided by bypass tensor 608 through the elementwise combination performed by fused output projection and gating 610.

Accordingly, FIG. 6 illustrates a focused output-side tensor interaction in which contraction output 602 in a feature-leading layout is normalized and restored at output normalization and layout restoration 604 to generate post-contraction tensor 606 in a pair-feature layout, bypass tensor 608 is provided as a gate input, and fused output projection and gating 610 combines post-contraction tensor 606 and bypass tensor 608 to generate output pair tensor 612. Unlike FIG. 5, which illustrates a full compiler-scheduled triangular multiplicative update neural-network block 500 and a compiler-scheduled dataflow plan 518 spanning multiple stages, FIG. 6 more particularly illustrates output-side tensor relationships and the separate value-input and gate-input roles of post-contraction tensor 606 and bypass tensor 608, including generation of gating values from bypass tensor 608, generation of projected values from post-contraction tensor 606, and elementwise multiplication of the gating values and the projected values to produce output pair tensor 612.

FIG. 7 illustrates an example of compiler-scheduled contraction and output-side handling 700 for a triangular multiplicative update, according to at least one embodiment. Whereas FIG. 6 illustrates output-side processing that uses a post-contraction tensor and a bypass tensor as separate value and gate inputs, FIG. 7 more particularly illustrates a compiler-scheduled arrangement that begins with reordered contraction operands, performs a triangular contraction, and then processes the contraction output through output-side layout handling and output projection and gating. FIG. 7 therefore emphasizes compiler-controlled dataflow from contraction operands through output generation, rather than the bypass-based output-side interaction emphasized in FIG. 6. In the illustrated embodiment, FIG. 7 shows an outgoing contraction arrangement.

For example, the interactions of FIG. 7 may be implemented using compiler-scheduled triangular multiplicative update neural-network block 500 of FIG. 5, including operand generation stage 508, triangular contraction stage 510, output normalization and transpose stage 512, output projection and gating stage 514, and compiler-scheduled dataflow plan 518. In at least one embodiment, FIG. 7 illustrates a more detailed contraction-to-output portion of the compiler-scheduled embodiment introduced in FIG. 5, including an outgoing contraction performed on reordered operands.

An operand a 702 stores a first contraction operand for triangular contraction 706. In the illustrated embodiment, operand a 702 has shape DBIK, where D denotes a feature-channel axis, B denotes a batch axis, I denotes an output-related pair-index axis, and K denotes an intermediate index axis. Operand a 702 is therefore arranged in a feature-leading layout in which the feature-channel axis and the batch axis precede the output-related pair-index axis and the intermediate index axis. In one example, operand a 702 is produced by an upstream compiler-scheduled producer operation that stores tensor values directly in a reordered layout selected for downstream triangular contraction 706.

An operand b 704 stores a second contraction operand for triangular contraction 706. In the illustrated embodiment, operand b 704 has shape DBJK, where J denotes an output-related pair-index axis and K denotes the intermediate index axis. Operand b 704 is therefore likewise arranged in a feature-leading layout suitable for contraction with operand a 702. FIG. 7 accordingly begins at a point in the dataflow after operand generation has already occurred, and more particularly shows that both contraction operands are already stored in a reordered layout before performance of triangular contraction 706. In the illustrated embodiment, operand a 702 and operand b 704 are arranged for an outgoing triangular contraction.

A compiler-scheduled dataflow plan 718 controls execution, scheduling, and layout handling for a contraction-to-output portion of the triangular multiplicative update graph shown in FIG. 7. In one example, compiler-scheduled dataflow plan 718 specifies scheduled stages or sub-tasks, producer-consumer dependencies among the stages, assignment of the stages to processing resources of a compiler-scheduled processor, and output-buffer layout assignments for operand a 702, operand b 704, triangular contraction 706, contraction output 708, output normalization and layout restoration 710, restored tensor 712, and output projection and gating 714. In one example, compiler-scheduled dataflow plan 718 is generated by analyzing a graph of operations of the triangular multiplicative update and decomposing the graph into the scheduled stages or sub-tasks. Compiler-scheduled dataflow plan 718 may identify data dependencies among the stages, determine a static execution order in which a producer stage generates an intermediate tensor before a dependent consumer stage consumes the intermediate tensor, assign output buffers for intermediate tensors, determine memory locations and buffer lifetimes for the intermediate tensors, and permit reuse of memory storage across stages whose buffer lifetimes do not overlap. In one example, compiler-scheduled dataflow plan 718 further controls how contraction output 708 is provided to output normalization and layout restoration 710 and how restored tensor 712 is provided to output projection and gating 714. Thus, compiler-scheduled dataflow plan 718 governs dataflow through the contraction-to-output portion of the triangular multiplicative update graph.

In one example, compiler-scheduled dataflow plan 718 further specifies communication and layout handling for intermediate tensors passed between scheduled stages of the contraction-to-output portion of the triangular multiplicative update graph. For example, when an upstream producer stage generates operand a 702, operand b 704, or contraction output 708, compiler-scheduled dataflow plan 718 may schedule communication of the tensor to a memory region or processing resource assigned to triangular contraction 706, output-side layout handling 710, or output projection and gating 714, and may cause the producer stage to write tensor elements directly to memory locations corresponding to a layout selected for the downstream consumer stage. In some embodiments, the selected layout is a feature-leading layout in which the feature-channel axis and, when present, the batch axis are leading axes for triangular contraction 706. A downstream consumer stage may then read tensor elements from an assigned buffer according to the selected layout without executing a separate transpose stage or generating a separate intermediate tensor in the selected layout. By coordinating graph decomposition, static scheduling, buffer assignment, communication of tensor data, and layout-aware producer and consumer behavior, compiler-scheduled dataflow plan 718 causes triangular contraction 706 to execute on operands already arranged for batched matrix multiplication over the intermediate index, while downstream stages restore or continue propagation of a selected layout as needed.

In a compiler-scheduled embodiment, the triangular multiplicative update graph further refers to an arrangement of producer and consumer operations that are scheduled so intermediate tensors are written and consumed according to selected ordered memory layouts. For example, the compiler schedules the graph so that a producer operation writes a tensor directly in a reordered layout used by downstream triangular contraction 706, rather than producing the tensor in a canonical layout and then executing a separate transpose stage or generating a separate intermediate tensor in the reordered layout.

In at least one embodiment, triangular multiplicative update graph 700 includes one or more producer operations that are scheduled so a common tensor derived from an input tensor is consumed by both a first matrix multiplication and a second matrix multiplication within a common scheduled region of the graph. In one example, the common tensor is loaded once for use in both the first matrix multiplication and the second matrix multiplication, and results of the first matrix multiplication and the second matrix multiplication are used to generate a gate-projection result and a value-projection result. In some embodiments, graph 700 further applies a sigmoid activation to the gate-projection result, combines the gate-projection result and the value-projection result by elementwise multiplication, optionally applies a mask, and stores a resulting tensor directly in a reordered layout used by downstream triangular contraction 706. In some embodiments, compiler scheduling of the producer operations avoids separately materializing a gating-projection tensor in a first layout and a value-projection tensor in the first layout before layout conversion. Instead, compiler scheduling causes tensor values generated from the common tensor to be written directly to memory locations corresponding to the reordered layout used by downstream triangular contraction 706. In some embodiments, the reordered layout is propagated across multiple operations of graph 700 before restoration to another layout used by a downstream stage.

A triangular contraction 706 computes a triangular multiplicative update tensor using operand a 702 and operand b 704. In the illustrated embodiment, triangular contraction 706 performs an outgoing contraction according to dbik, dbjk→dbij. In that arrangement, features associated with a pair identified by the output-related index i and the intermediate index k are combined with features associated with a pair identified by the output-related index j and the intermediate index k to produce an updated feature associated with index pair ij. Operand a 702 and operand b 704 are already stored in the feature-leading layout selected by compiler-scheduled dataflow plan 718, such that fixed values of the feature-channel axis and the batch axis identify matrix instances and the intermediate index k is a reduction index of a matrix multiplication. In another embodiment not shown in FIG. 7, an incoming contraction may be performed according to dbki, dbkj→dbij.

In one example, triangular contraction 706 performs a sum of products over the intermediate index k while preserving the feature-channel axis and the batch axis. For fixed values of the feature-channel axis and the batch axis, triangular contraction 706 performs a matrix multiplication over the intermediate index k using corresponding slices of operand a 702 and operand b 704, and different fixed values of the feature-channel axis and the batch axis correspond to different matrix multiplications of a batched matrix multiplication. FIG. 7 therefore emphasizes that the reordered layouts of operand a 702 and operand b 704 permit the contraction to be scheduled in a batched matrix-multiplication form under control of compiler-scheduled dataflow plan 718, such that compiler-scheduled dataflow plan 718 schedules triangular contraction 706 on operands already written in the feature-leading layout rather than after a separate layout-conversion stage.

A contraction output 708 stores output values generated by triangular contraction 706. In the illustrated embodiment, contraction output 708 has shape (D,B,I,J). Contraction output 708 therefore remains in a feature-leading layout after performance of triangular contraction 706. In one example, compiler-scheduled dataflow plan 718 causes triangular contraction 706 to write contraction output 708 directly to a buffer arrangement selected for downstream output-side layout handling 710, such that downstream processing consumes contraction output 708 in the feature-leading layout produced by triangular contraction 706 without first executing a separate transpose stage. FIG. 7 thus highlights the immediate output of the contraction itself, which FIG. 6 does not separately emphasize.

Output normalization and layout restoration 710 generates a restored tensor 712 from contraction output 708. In one example, output normalization and layout restoration 710 performs one or more output-side operations that prepare contraction output 708 for downstream output projection and gating 714. In one example, output normalization and layout restoration 710 includes normalization and layout restoration. In another example, output normalization and layout restoration 710 includes compiler-scheduled write handling in which tensor values are written directly according to a target output layout rather than first materializing a separate transposed intermediate tensor, so that compiler-scheduled dataflow plan 718 schedules output-side layout conversion by layout-mapped writes during execution of output normalization and layout restoration 710 and a downstream stage consumes tensor values already written in the target output layout. FIG. 7 accordingly focuses on output-side normalization and layout restoration of a contraction result in a compiler-scheduled embodiment, rather than on the separate value-input and gate-input roles shown in FIG. 6.

A restored tensor 712 stores output-side values derived from contraction output 708 after output-side normalization and layout restoration. In the illustrated embodiment, restored tensor 712 has shape BIJD. Restored tensor 712 is therefore arranged in a pair-feature layout in which the batch axis is followed by the first pair-index axis, the second pair-index axis, and the feature-channel axis. FIG. 7 correspondingly shows restoration from the feature-leading layout of contraction output 708 to a pair-feature layout suitable for downstream processing.

An output projection and gating 714 generates an updated pair representation from output-side handled tensor 712. In one example, output projection and gating 714 performs an output projection and a gating operation to generate final updated pairwise feature values. In one example, compiler-scheduled dataflow plan 718 schedules output projection and gating 714 to consume output-side handled tensor 712 in the restored pair-feature layout. Unlike FIG. 6, FIG. 7 does not focus on a bypass tensor as a separate gate input. Instead, FIG. 7 focuses on compiler-scheduled movement of tensor data from reordered operands through contraction and output-side handling to output generation. In at least one embodiment, output projection and gating 714 may additionally receive a bypass tensor derived from an input-side path, although that bypass tensor is omitted from FIG. 7 for simplicity.

An output pair tensor 716 stores updated pairwise feature values produced by compiler-scheduled contraction and output-side handling 700. In the illustrated embodiment, output pair tensor 716 has shape (B,I,J,D). Output pair tensor 716 therefore preserves the pair-feature organization of the input-side representation while reflecting updates introduced by triangular contraction 706 and output projection and gating 714.

Accordingly, FIG. 7 illustrates a compiler-scheduled arrangement in which operand a 702 and operand b 704 are provided in reordered feature-leading layouts to triangular contraction 706, contraction output 708 is generated in shape (D,B,I,J), output-side layout handling 710 produces output-side handled tensor 712 in shape (B,I,J,D), and output projection and gating 714 generates output pair tensor 716. Unlike FIG. 6, which more particularly illustrates output-side value-input and gate-input interaction using a post-contraction tensor and a bypass tensor, FIG. 7 more particularly illustrates how compiler-scheduled dataflow plan 718 governs the contraction-to-output portion of the graph, including reordered operands, feature-leading contraction output, output-side layout handling, and downstream output generation.

### Data Center

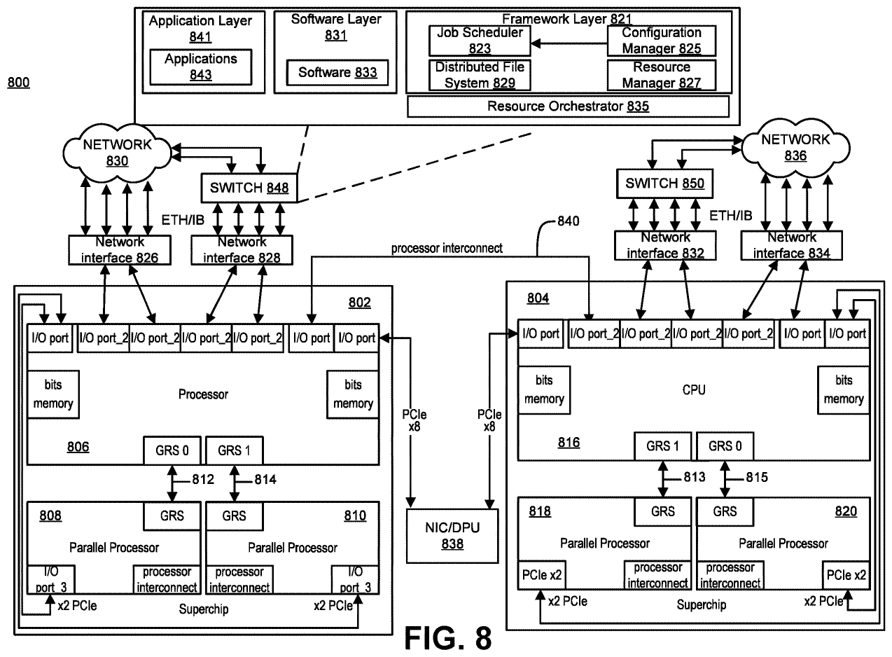

FIG. 8 demonstrates an example architecture of a multi-GPU architecture. As illustrated in the figure, computing system 800 includes a processing device 802 with a multi-GPU architecture. In particular, processing device 802 may be a system-on-chip and includes multiple subsystems such as a CPU 806, a GPU 808, and a GPU 810. CPU 806 can be coupled to GPU 808 via a die-to-die (D2D) or chip-to-chip (C2C) interconnect 812, such as a Ground-Referenced Signaling interconnect (GRS interconnect). CPU 806 can be coupled to GPU 810 via a D2D or C2C interconnect 814. CPU 806 can also couple to GPU 808 and GPU 810 via PCIe interconnects.

CPU 806 can be coupled to one or more NICs or DPUs, which are coupled to one or more networks. For example, as illustrated in FIG. 8, CPU 806 is coupled to a first NIC/DPU 826, which is coupled to a network 830. CPU 806 is also coupled to a second NIC/DPU 828, which is coupled to network 830 via switch 848. NIC/DPU 826 and NIC/DPU 828 can be coupled to network 830 over Ethernet (ETH), NVLINK or InfiniBand (IB) connections, for example.

Computing system 800 also includes a processing device 804 with a multi-GPU architecture. In particular, processing device 804 includes multiple subsystems including a CPU 816, a GPU 818, and a GPU 820. CPU 816 can be coupled to GPU 818 via an D2D or C2C interconnect 813. CPU 816 can be coupled to GPU 820 via a D2D or C2C interconnect 815. CPU 816 can also couple to GPU 818 and GPU 820 via PCIe interconnects. CPU 816 can be coupled to one or more NICs or DPUs, which are coupled to one or more networks. For example, as illustrated in FIG. 8, CPU 816 is coupled to a first NIC/DPU 832, which is coupled to a network 836 via switch 850. CPU 816 is also coupled to a second NIC/DPU 834, which is coupled to network 836. NIC/DPU 832 and NIC/DPU 834 can be coupled to network 836 over Ethernet (ETH), NVLINK or InfiniBand (IB) connections.

In at least one embodiment, processing device 802 and processing device 804 can communication with each other via a NIC/DPU 838, such as over PCIe interconnects. Processing device 802 and processing device 804 can also communicate with each other over a high-bandwidth communication interconnects 840, such as an NVLink interconnect or other high-speed interconnects. The packet switches in FIG. 8 may comprise, for example, Nvidia Quantum-2 switches. The NICs/DPUs in the figure may comprise, for example, Nvidia Bluefield DPUs.

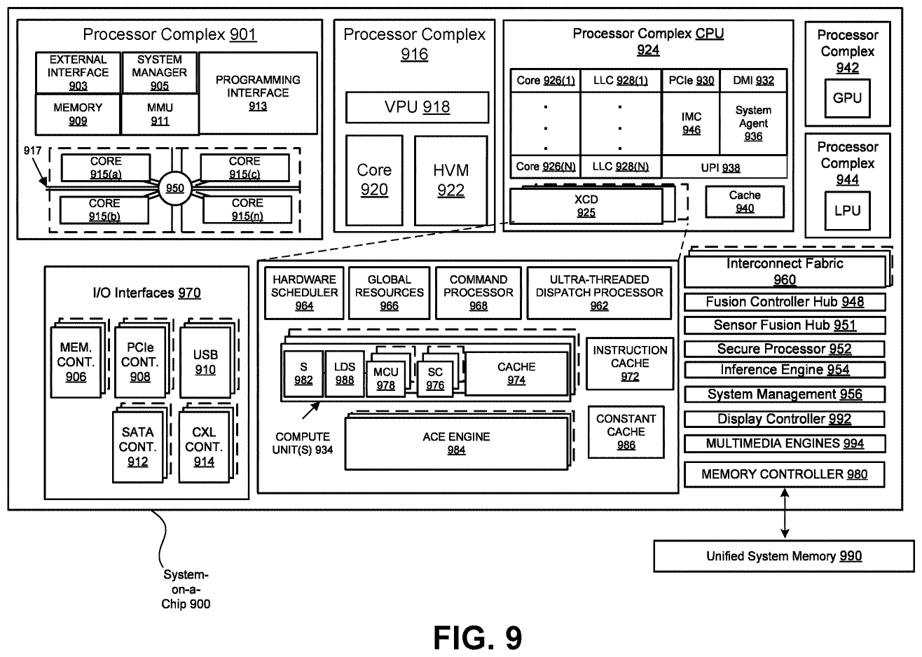

In at least one embodiment, processing device 802 and processing device 804 can include sub-systems, modules, add-in cards, and other semiconductor components. processing devices may include any number of processors, such as, but not limited to, central processing units (“CPUs”), graphics processing units (“GPUs”), or other processors (including accelerators, field programmable gate arrays (FPGAs), graphics processors, etc.), including any processors described herein, such as, but not limited to, processors in FIGS. 9-12B. Processing devices can include one or more memory storage devices (e.g., dynamic read-only memory, solid state storage or disk drives), as well as network input/output (“NW I/O”) devices, network switches, virtual machines (“VMs”), power modules, and cooling modules, etc.

Processing devices can include separate groupings of computing units housed within one or more racks (not shown), or many racks housed in data centers at various geographical locations (also not shown). Separate groupings of computing units may include grouped compute, network, memory or storage resources that may be configured or allocated to support one or more workloads. Several computing units (e.g., including CPUs and/or other processors) may be grouped within one or more racks to provide compute resources to support one or more workloads. A resource orchestrator 835 may configure or otherwise control one or more processing devices or groups of computing units. Resource orchestrator 835 may include a software design infrastructure (“SDI”) management entity for computing system 800. Resource orchestrator 835 may include hardware, software or some combination thereof.

Computing system 800 can include any one of or any combination of a framework layer 821, a software layer 831 and an application layer 841. As shown in FIG. 8, framework layer 821 includes a job scheduler 823, a configuration manager 825, a resource manager 827 and a distributed file system 829. Framework layer 821 may include a framework to support software 833 of software layer 831 and/or one or more application(s) 843 of application layer 841. Software 833 or application(s) 843 may respectively include web-based service software or applications, such as, but not limited to, those provided by Amazon Web Services, Google Cloud and Microsoft Azure. Framework layer 821 may be a type of free and open-source software web application framework such as, but not limited to, Apache Spark™ (hereinafter “Spark”) that may utilize distributed file system 829 for large-scale data processing (e.g., “big data”). Job scheduler 823 may include a Spark driver to facilitate scheduling of workloads supported by various layers of computing system 800. Configuration manager 825 may be capable of configuring different layers such as, but not limited to, software layer 831 and framework layer 821 including Spark and distributed file system 829 for supporting large-scale data processing. Resource manager 827 may be capable of managing clustered or grouped processing devices mapped to or allocated for support of distributed file system 829 and job scheduler 823. Resource manager 827 may coordinate with resource orchestrator 835 to manage these mapped or allocated computing resources.

Software 833 can be included in software layer 831 and may include software used by at least portions of processing devices, and/or distributed file system 829 of framework layer 821. One or more types of software may include, but are not limited to, Internet web page search software, e-mail virus scan software, database software, and streaming video content software.

Application(s) 843 can be included in application layer 841 and may include one or more types of applications used by at least portions of processing devices, and/or distributed file system 829 of framework layer 821. One or more types of applications may include, but are not limited to, any number of a genomics application, a cognitive compute, application and a machine learning application, including training or inferencing software, machine learning framework software (e.g., PyTorch, TensorFlow, Caffe, etc.) or other machine learning applications used in conjunction with one or more embodiments.

Any of configuration manager 825, resource manager 827, and resource orchestrator 835 may implement any number and type of self-modifying actions based on any amount and type of data acquired in any technically feasible fashion. Self-modifying actions may relieve a data center operator of data center 800 from making possibly bad configuration decisions and possibly avoiding underutilized and/or poor performing portions of a data center.

Any of configuration manager 825, resource manager 827, and resource orchestrator 835 may implement any number and type of self-modifying actions based on any amount and type of data acquired in any technically feasible fashion. Self-modifying actions may relieve a data center operator of computing system 800 from making possibly bad configuration decisions and possibly avoiding underutilized and/or poor performing portions of a data center.

Computing system 800 may include tools, services, software or other resources to train one or more machine learning models or predict or infer information using one or more machine learning models in accordance with one or more embodiments described herein. For example, a machine learning model may be trained by calculating weight parameters in accordance with a neural network architecture using software and computing resources described above with respect to computing system 800. Trained machine learning models corresponding to one or more neural networks may be used to infer or predict information using resources described above with respect to computing system 800 by using weight parameters calculated through one or more training techniques described herein.

Computing system 800 may use CPUs, application-specific integrated circuits (ASICs), GPUs, FPGAs, language processing units (LPUs), or other hardware (e.g., embodiments in FIGS. 9-12B) to perform some or all of processes and techniques described elsewhere herein, such as, but not limited to, training and/or inferencing using above-described resources. Moreover, one or more software and/or hardware resources described above may be configured as a service to allow users to train or perform inferencing of information, such as, but not limited to, image recognition, speech recognition, content generation (e.g., image generation, video generation, code generation), or other artificial intelligence services.

As another example, computing system 800 may represent a server farm. As another example, computing system 800 may represent a data cloud or a processing cloud. The data cloud or processing cloud may comprise an interface to which web service or other application programming interface (API) calls can be submitted to cause the system or components thereof to perform operations described herein. As another example, computing system 800 can represent a supercomputer. Computing system 800 may include tens, hundreds, or thousands of nodes. With respect to any of processors in system 800 and any of its components described above or elsewhere herein, one or more of APIs or equivalents described herein can, for example, get compiled into instructions or equivalents, which may be fetched by instruction fetch logic or equivalents, decoded by a processor decoder or equivalents, scheduled (e.g., in order or out of order) for execution by a scheduler or equivalents, executed by execution logic or equivalents, reordered, and then retired by retirement logic or equivalents. API(s) (and/or compiled instructions including API(s)) can be stored in any storage outside or inside of a processor or node (e.g., in cache and/or memory). A result of API(s) can then be stored in storage within or outside of a processor or node, including registers, DRAM, flash, SRAM, cache, or other memory equivalents. System 800 may include over nine thousand nodes, with each node including two Intel Xeon Max processors, six Intel Max series GPUs and a unified memory architecture, such as, but not limited to, that used in Intel Aurora Supercomputer from Intel Corporation in Santa Clara, CA or another supercomputer that shares at least some of the components described herein.

System 800 can include one or more racks, which represent structural and interconnect resources to house and interconnect multiple computation nodes. A rack can include multiple nodes. A rack may host multiple blade components. Blades can refer to computing resources on printed circuit boards (PCBs), where a PCB houses hardware components for one or more nodes. Blades may or may not include a chassis or housing or other “box” other than that provided by rack. Blades may include housing with exposed connector to connect into a rack. System may or may not include a rack, and each blade can include a chassis or housing that can stack or otherwise reside in close proximity to other blades and allow interconnection of nodes. System may include 10,624 compute blades, which include 63,744 Intel Max Series GPUs and 21,248 Intel Xeon Max CPUs across 166 racks.

System 800 can include a fabric, which represents one or more interconnectors for nodes. The fabric can include multiple switches or routers or other hardware to route signals among nodes. Additionally, the fabric can couple system 800 to network 830 for access by clients 802. Likewise, the fabric can couple system 800 to network 836 for access by clients 804. The fabric can have one or more associated protocols to manage routing of signals through system 800. A protocol or protocols can be at least partly dependent on hardware equipment used in system 800.

A rack can include N blades. In addition to a first rack, system 800 can include a second rack. As illustrated, the second rack may include M blades. Blades of the second rack can be the same or similar to blades of the first rack. Nodes can be any type of node as described herein, and may not be necessarily all the same type of node. System 800 is not limited to being homogenous, nor is it limited to not being homogenous.

In at least one embodiment, a node in a blade may be computation nodes, with processor and memory. A computation node refers to a node with processing resources (e.g., one or more processors) that executes an operating system and can receive and process one or more tasks. At least some nodes can include storage server nodes with a server as processing resources and memory. A storage server refers to a node with more storage resources than a computation node, and rather than having processors for execution of tasks, a storage server includes processing resources to manage access to storage nodes within a storage server.

A node can include interface controller, which can represent logic to control access by node to fabric. Logic can include hardware resources to interconnect to physical interconnection hardware. Logic can include software or firmware logic to manage interconnection. Interface controller can include a host fabric interface, which can include a fabric interface in accordance with any embodiment described herein.

A node may include a memory subsystem. Memory can include memory computation resources (comp), which represent one or more capabilities by memory to perform memory computations. System 800 enables remote memory operations, such as, but not limited to, the operations described elsewhere herein. Thus, nodes can request memory computations by remote nodes, where data for computation remains local to an executing node instead of being sent over fabric or instead of being sent from memory to a fabric interface. In response to execution of memory computation, an executing node can provide a result to a requesting node.

Reference to memory devices can apply to different memory types. Memory devices generally refer to volatile memory technologies. Volatile memory can be memory whose state (and therefore data stored on it) is indeterminate if power is interrupted. Nonvolatile memory refers to memory whose state is determinate even if power is interrupted. Dynamic volatile memory can refresh data stored in a device to maintain state. One example of dynamic volatile memory includes DRAM (dynamic random access memory), or some variant such as, but not limited to, synchronous DRAM (SDRAM). A memory subsystem as described herein may be compatible with a number of memory technologies, such as, but not limited to, DDR3 (dual data rate version 3, original release by JEDEC (Joint Electronic Device Engineering Council) on Jun. 27, 2007, currently on release 21), DDR4 (DDR version 4, initial specification published in September 2012 by JEDEC), DDR4E (DDR version 4, extended, currently in discussion by JEDEC), LPDDR3 (low power DDR version 3, JESD209-3B, August 2013 by JEDEC), LPDDR4 (LOW POWER DOUBLE DATA RATE (LPDDR) version 4, JESD209-4, originally published by JEDEC in August 2014), WIO2 (Wide I/O 2 (WideI02), JESD229-2, originally published by JEDEC in August 2014), HBM (HIGH BANDWIDTH MEMORY DRAM, JESD235, originally published by JEDEC in October 2013), DDR5 (DDR version 5, currently in discussion by JEDEC), LPDDR5 (currently in discussion by JEDEC), HBM2 (HBM version 2), HBM3 (HBM version 3), HBM3E (HBM version 3, extended), HBM4 (HBM version 4), HBM5 (HBM version 5, currently in discussion by JEDEC), or others or combinations of memory technologies, and technologies based on derivatives or extensions of such specifications.

In addition to, or alternatively to, volatile memory, in one embodiment, reference to memory devices can refer to a nonvolatile memory device whose state is determinate even if power is interrupted. In one embodiment, nonvolatile memory device is a block addressable memory device, such as, but not limited to, NAND or NOR technologies. Thus, a memory device can also include a future generation nonvolatile devices, such as, but not limited to, a three-dimensional crosspoint (3DXP) memory device, other byte addressable nonvolatile memory devices, or memory devices that use chalcogenide phase change material (e.g., chalcogenide glass). In one embodiment, a memory device can be or include multi-threshold level NAND flash memory, NOR flash memory, single or multi-level phase change memory (PCM) or phase change memory with a switch (PCMS), a resistive memory, nanowire memory, ferroelectric transistor random access memory (FeTRAM), magnetoresistive random access memory (MRAM) memory that incorporates memristor technology, or spin transfer torque (STT)-MRAM, or a combination of any of the above, or other memory.

In at least one embodiment, processor 800 can include circuitry (e.g., one or more circuits described above and elsewhere herein) to generate, from an input tensor, contraction operands by directly storing the operands in a reordered feature-leading layout and perform a feature-preserving triangular multiplicative update by contraction over an intermediate index or otherwise perform any of the operations described above or elsewhere herein. In at least one embodiment, processing device 802 is configured by software 833 to generate, from an input tensor, contraction operands by directly storing the operands in a reordered feature-leading layout and perform a feature-preserving triangular multiplicative update by contraction over an intermediate index or otherwise perform any of the operations described above or elsewhere herein. Data center 800 may use logic, CPUs, application-specific integrated circuits (ASICs), GPUs, FPGAs, or other hardware (e.g., embodiments in FIGS. 9-12B) to perform any of the operations described above or elsewhere herein.

### Processors

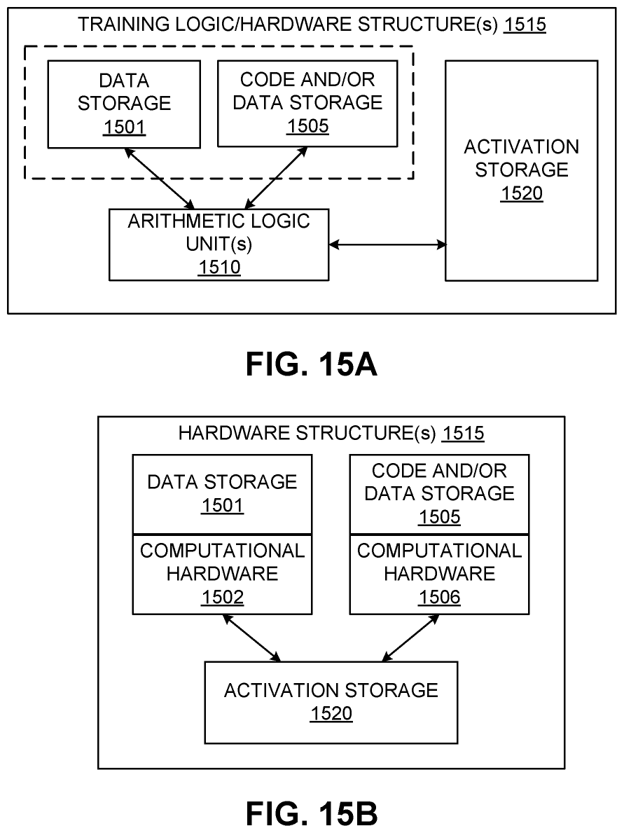

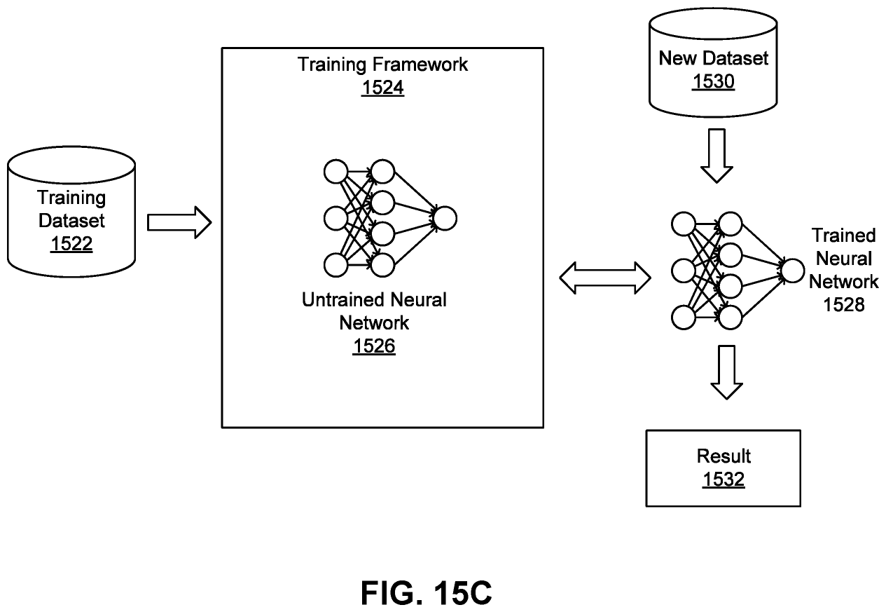

The following figures set forth, without limitation, example processors and processing systems that can be used to generate, from an input tensor, contraction operands by directly storing the operands in a reordered feature-leading layout and perform a feature-preserving triangular multiplicative update by contraction over an intermediate index or otherwise perform some or all of processes, operations and/or and techniques described elsewhere herein. Example processors and processing systems can be configured by software to generate, from an input tensor, contraction operands by directly storing the operands in a reordered feature-leading layout and perform a feature-preserving triangular multiplicative update by contraction over an intermediate index or otherwise perform any of the operations described above or elsewhere herein. Processors and processing systems can include logic, central processing units (CPUs), application-specific integrated circuits (ASICs), graphics processing units (GPUs), field programmable arrays (FPGAs), XPUs (i.e., any compute architecture that best fits the need of an application), network interface cards (NICs), switches, network adapters, data processing units (DPUs), or other hardware (e.g., embodiments in FIGS. 9-12B) to perform any of the operations described above, below, or elsewhere herein. Processors and/or processing systems described herein can include circuitry (e.g., one or more circuits) that can be used to generate, from an input tensor, contraction operands by directly storing the operands in a reordered feature-leading layout and perform a feature-preserving triangular multiplicative update by contraction over an intermediate index or otherwise perform any of the operations described above or elsewhere herein. As used herein, one or more circuits can be configured by software to generate, from an input tensor, contraction operands by directly storing the operands in a reordered feature-leading layout and perform a feature-preserving triangular multiplicative update by contraction over an intermediate index or otherwise perform any of the operations described above or elsewhere herein. FIGS. 15A and 15B illustrate logic 1515 which, as described elsewhere herein, can be used in one or more devices to perform operations such as, but not limited to, those discussed herein in accordance with at least one embodiment. Logic can refer, for example, to any combination of software logic, hardware logic, and/or firmware logic to provide functionality and/or operations described herein, wherein logic may be, collectively or individually, embodied as circuitry that forms part of a larger system, for example, an integrated circuit (IC), an application-specific integrated circuit (ASIC), a field programmable array (FPGA), system-on-chip (SoC), or one or processors (e.g., CPU, GPU).

FIG. 9 illustrates a processor which is a system-on-a-chip (SOC) 900 (which may be referred to as system-on-chip, a superchip, or another name), in accordance with at least one embodiment. SOC 900 can include one or more processor complexes. SOC 900 can include any number of processor complexes that may include any number of processors that are described herein, such as, but not limited to, those in FIGS. 9-12B, in any combination. For example, processor complex 924 may include a central processing unit (CPU), processor complex 942 may include a graphics processor (GPU) or tensor processor (TPU), processor complex 916 may include a vision processing unit (VPU), processor complex 901 may include a neural processing unit (NPU), and processor complex 944 may include a language processing unit (LPU), any of which may be implemented as separate or combined processor complexes. For example, processor 924 may include a graphics processor, and processor 942 may include a graphics processor. SOC 900 may include any number of display controllers 992, any number of multimedia engines 994, any number of I/O Interfaces 970, any number of memory controllers 980, and any number of fabrics 960 in any combination. For explanatory purposes, multiple instances of like objects are denoted herein with reference numbers identifying the object and parenthetical numbers identifying the instance where needed. SOC 900 can include a processor from Broadcom in Palo Alto, CA. I/O Interfaces 970 can include one or more memory controllers 906 that can manage memory usage (e.g., DDR5 memory) for SOC 900. I/O Interfaces 970 may include one or more SATA disk controllers 912 for managing storage and one or more Compute Express Link (CXL™) 1.1+ memory controllers 914 that can provide CPU-to-device and CPU-to-memory connections and can be flexibly assigned to specific functions at server design time. I/O Interfaces 970 may include PCIe controller 908 for connecting peripherals and other components connected to SOC 900. I/O Interfaces 970 may include USB ports 910 for connecting to other components separate from SOC 900. Memory controller 906, PCIe controller 908, USB ports 910, SATA controller 912, and/or CXL controller 914 can be integrated anywhere within SOC 900 either separately or in any groups or combinations thereof.

Processor complex 924 can include a CPU, processor complex 942 can include a GPU, and SOC 900 can include a processing unit that integrates 924 and 942 onto a single chip. Some tasks may be assigned to processor complex 924 and other tasks may be assigned to processor complex 942. Processor complex 924 can be configured to execute main control software associated with SOC 900, such as, but not limited to, an operating system. Processor complex 924 can be the master processor of SOC 900, controlling and coordinating operations of other processors. Processor complex 924 can issue commands that control the operation of processor complex 942 to perform some or all of the operations described herein. Processor complex 924 can be configured to execute host executable code derived from CUDA or other source code (e.g., HIP source code), and processor complex 942 can be configured to execute device executable code derived from CUDA or other source code in order to perform any of the operations described herein.

Processor complex 924 can include cores 926-926(N) and a cache (e.g., L3 cache) 940 to store information to perform operations described herein. Processor complex 924 may include any number of cores 926 and any number and type of caches in any combination. Each core can be associated with one lower level cache (LLC) slice 928(1)-928(N), or cores 926(1)-926(N) can share cache, e.g., lower level cache. LLCs 928(1)-928(N) can be inclusive by incorporating blocks in higher level cache (e.g., L2 cache) or non-inclusive (having blocks that may be not present in higher level cache). Each core and LLC slice can include a Caching and Home Agent (CHA) (not shown) that can maintain cache coherency by providing scalability of resources across mesh interconnects for Intel® Ultra Path Interconnect (Intel® UPI 938) cache coherency functionality. UPI 938 can provide a coherent interconnect for scalable systems and can allow for multiple processors to share a single shared address space through links, such as, but not limited to, two or three UPI links per processor. Cores 926 can be configured to execute instructions of a particular instruction set architecture (“ISA”) to perform some or all of the operations described herein. Each core 926 can include a CPU core. Core 926-926(N) can be referred to as a computing units or compute units. SOC 900 can include any number of processor complexes 924, fabric 960, I/O interfaces 970, and memory controllers 980.

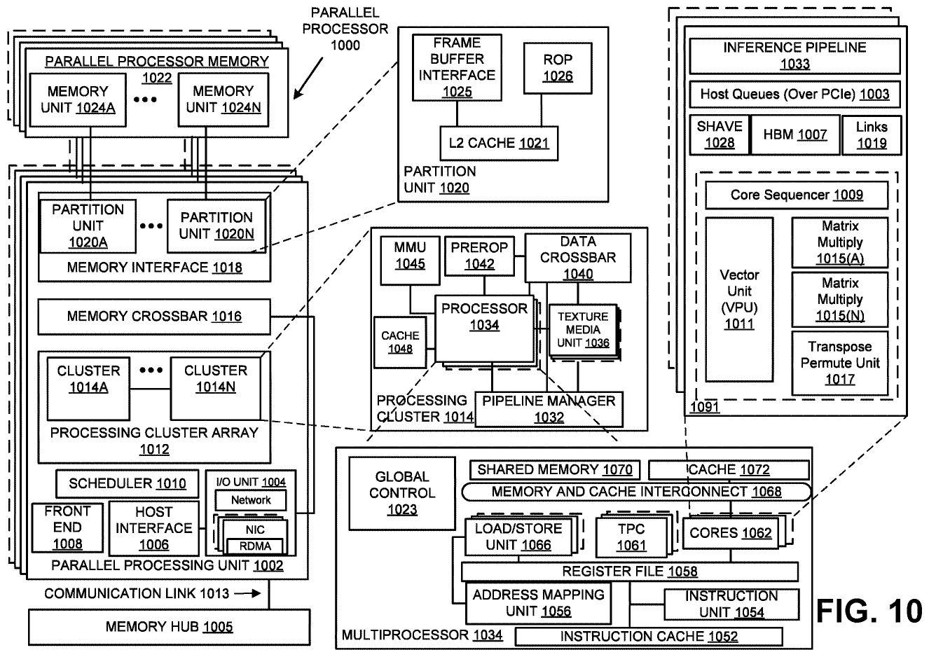

Processor complex 942 can be a graphics complex that can be configured to perform compute operations (e.g., compute operations involved in operations described herein) in a highly-parallel fashion. Processor complex 942 can be configured to execute graphics pipeline operations such as, but not limited to, draw commands, pixel operations, geometric computations, and other operations associated with rendering an image to a display. Processor complex 942 can be configured to execute operations unrelated to graphics, such as, but not limited to, neural network training and/or simulations. Processor complex 942 can be configured to execute both operations related to graphics and operations unrelated to graphics. Processor complex 942 can include any number of compute units that are described herein, such as, but not limited to, those in FIG. 10.

Fabric 960 can be a system interconnect that facilitates data and control transmissions across processor complex 924, processor complex 942, I/O interfaces 970, memory controllers 980, display controller 992, and multimedia engine 994, e.g., to perform some or all of the operations described herein. SOC 900 may include any amount and type of system interconnect in addition to or instead of fabric 960 that facilitates data and control transmissions across any number and type of directly or indirectly linked components that may be internal or external to SOC 900. I/O interfaces 970 can be representative of any number and type of I/O interfaces (e.g., PCI, PCI-Extended (“PCI-X”), PCIe, gigabit Ethernet (“GBE”), USB, etc.). Various types of peripheral devices can be coupled to I/O interfaces 970. Peripheral devices that can be coupled to I/O interfaces 970 may include keyboards, mice, printers, scanners, joysticks or other types of game controllers, media recording devices, external storage devices, network interface cards, and so forth.

Display controller 992 may display images on one or more display device(s), such as, but not limited to, a liquid crystal display (“LCD”) device. Multimedia engine 994 can include any amount and type of circuitry that is related to multimedia, such as, but not limited to, a video decoder, a video encoder, an image signal processor, etc. Memory controllers 980 may facilitate data transfers between SOC 900 and a unified system memory 990. Processor complex 924 and processor complex 942 may share unified system memory 990. Unified system memory 990 can include various types of memory devices, including dynamic random access memory (DRAM) or graphics random access memory, such as, but not limited to, synchronous graphics random access memory (SGRAM), including graphics double data rate (GDDR) memory. Unified system memory 990 may include 3D stacked memory, including but not limited to one or more high bandwidth memory generations (e.g., HBM, HBM2e, HBM3, HBM3e, HBM4, HBM5, etc.).

SOC 900 may implement a memory subsystem that includes any amount and type of memory controllers 980 and memory devices (e.g., shared memory) that may be dedicated to one component or shared among multiple components in order to perform any of the operations described herein. SOC 900 can implement a cache subsystem that includes one or more cache memories (e.g., L1, L2, L3, and/or last-level cache) that may each be private to or shared between any number of components (e.g., cores 920, core complex 924, SIMD units, compute units, and processor complex 942).

Processor complex 901 may include a processor, in accordance with at least one embodiment. Processor complex 901 can include a processor with hybrid architecture (e.g., Lunar Lake or Meteor Lake) from Intel Corporation in Santa Clara, CA or another processor that shares at least some of the components described herein. Processor complex 901 can include one or more CPU(s), one or more GPU(s), and/or one or more Neural Processing Unit(s) (NPU) that can be, e.g., a dedicated AI accelerator that offloads artificial intelligence (AI) workloads from CPU and GPU. Processor complex 901 can use instructions that, if executed cause processor complex 901 and/or any of its components to perform some or all of processes and techniques described elsewhere herein. Processor complex 901 may include any number of memory and cache units 909 to facilitate processing amongst different components of processor complex 901. Memory and cache 909 on processor complex 901 may include one or more levels of cache (e.g., L1, L2, L3, and/or last-level cache) and high-bandwidth memory (e.g., HBM2e or HBM3) in any combination. With respect to processor complex 901 and any of its components described above or elsewhere herein, one or more of APIs described herein can, for example, get compiled into instructions, which may be fetched by instruction fetch logic or equivalents, decoded by a processor decoder or equivalents, scheduled (e.g., in order or out of order) for execution by a scheduler or equivalents, executed by execution logic or equivalents, reordered, and then retired by retirement logic or equivalents. API(s) (and/or compiled instructions including API(s)) can be stored in any storage outside or inside of processor complex 901 (e.g., in cache and/or memory). A result of API(s) can then be stored in storage within or outside of processor complex 901, including registers, DRAM, flash, SRAM, cache, or other memory. One or more of APIs described herein can include a call.

A Intel® Thread Director, which includes firmware that can be built into processor complex 901, can prioritize and manage distribution of workloads, sending tasks to optimized cores. This instruction set may be optimized with OpenVINO™ Toolkit and oneAPI to accelerate INT8 inferencing. A software stack, e.g., as described elsewhere herein, can be used to enable AI inference using OpenVINO™ toolkit. Processor complex 901 can be configured to execute an application program, such as, but not limited to, a CUDA program.

Processor complex 901 can alternatively include a processor based on AI Engine Direct architecture from Qualcomm Corporation in Santa Clara, CA or another processor that shares at least some of the components described herein. that may include any number of NPUs, GPUs, CPUs and other related components, such as, but not limited to, NPU as a Hexagon NPU, GPU as an Adreno GPU, CPU as a Kryo or Qualcomm Oryon CPU, as well as a Qualcomm Sensing Hub and a memory subsystem, in any combination. Hexagon NPU can include a power rail a micro-tile inferencing unit, a hardware acceleration unit, a tensor unit, a scalar unit, and a vector unit (all not shown), which can have dedicated memory or share memory (e.g., cache or memory, such HBM3) for, e.g., storing instructions to perform any of the operations described above or elsewhere herein. Adreno GPU can provide graphics and parallel processing for AI in formats, such as, but not limited to, 32-bit floating point (FP32), 16-bit floating point (FP16), and 8-bit integer (INT8). Kryo or Qualcomm Oryon CPUs can perform AI workloads, and can handle contextualization for pervasive generative AI applications. CPU can also include an instruction fetch unit, a rename and retire unit, a memory management unit, a vector execution unit, an integer execution unit, and a load and store unit for processing and instruction management. With respect to processor and any of its components described above or elsewhere herein, one or more of APIs described herein can, for example, get compiled into instructions, which may be fetched by instruction fetch unit, decoded by a processor decoder or equivalents, scheduled (e.g., in order or out of order) for execution by a scheduler or equivalents, executed by execution logic or equivalents, reordered, and then retired by rename and retire unit. API(s) (and/or compiled instructions including API(s)) can be stored in any storage outside or inside of processor complex 901 (e.g., in cache and/or memory). Any number of CPU cores may be included in any number of CPU cluster(s) that can be coupled to memory and/or cache, such as, but not limited to a shared L2 cache. Memory can be separate or shared, e.g., CPU clusters of CPU cores can couple to memory subsystem that can include fabric, system level cache and any number of memory management units that can, for example, read and write memory (e.g., DRAM). Qualcomm Sensing Hub (not shown) includes micro NPUs, a power rail, and traditional sensors (a gyrometer, accelerometer, even a barometer) with voice and data streams. Memory subsystem can include memory and cache on processor complex 901, which may include one or more levels of cache (e.g., L1, L2, L3, and/or last-level cache) and high-bandwidth memory (e.g., HBM2e or HBM3) in any combination, e.g., for storing information and/or instructions to perform any of the operations described above or elsewhere herein. All or some of memory and/or cache in memory subsystem can be shared or used individually by any one or combinations of components (e.g., GPU, NPU, and CPU) on processor complex 901.

Qualcomm AI Engine on a processor complex 901 may be programmed and controlled with a software stack to perform some or all of the operations described herein, and include, e.g., a Qualcomm® Neural Processing SDK for inferencing with versions for Android, Linux, and Windows. Developer libraries and services support programming languages, virtual platforms, and compilers. At a lower level of software stack, system software includes basic real-time operating system (RTOS), system interfaces, and drivers. Software stack supports different operating systems, including Android, Windows, Linux, and QNX, and deployment and monitoring infrastructure like Prometheus, Kubernetes, and Docker. For direct cross-platform access to GPU, OpenCL and DirectML may be supported. For CPU, a LLVM compiler infrastructure optimizations enable accelerated and efficient AI inference. With respect to Qualcomm AI Engine and any of its components described above or elsewhere herein, one or more of APIs described herein can, for example, get compiled into instructions, which may be fetched by instruction fetch logic or equivalents, decoded by a processor decoder or equivalents, scheduled (e.g., in order or out of order) for execution by a scheduler or equivalents, executed by execution logic or equivalents, reordered, and then retired by retirement logic or equivalents. API(s) (and/or compiled instructions including API(s)) can be stored in any storage outside or inside of Qualcomm AI Engine (e.g., in cache and/or memory). A result of API(s) can then be stored in storage within or outside of Qualcomm AI Engine, including registers, DRAM, flash, SRAM, cache, or other memory.

Processor complex 924 can include a processor with scalable family from Intel Corporation in Santa Clara, CA or another processor that shares at least some of the components described herein. Processor complex 924 can include one or more cores 926(1)-926 (N), where N is any integer greater than 1 that can perform the operations described elsewhere herein. Cores 926(1)-926 (N) can be interlinked together using ring and/or mesh interconnects. With a mesh interconnects architecture, an array of vertical and horizontal communication paths may allow traversal from one core to another 926(1)-926(N) through a shortest path (hop on vertical path to correct row, and hop across horizontal path to correct column).

Processor complex 924 can also include System Agent 936 that can house and/or perform various functionalities, such as, but not limited to, memory management, display functions, and/or input/output (I/O) functions. For example, processor complex 924 can include one or more integrated memory controller(s) (IMC) 946. IMC 946 can control and manage memory, such as, but not limited to, different memory types e.g., DDR ram, like DDR4 or others described elsewhere herein. System Agent 936 can include a display controller (not shown) to support display(s). System Agent 936 can also incorporate PCIe 930 (e.g., up to 20 lanes of PCIe), e.g., that can connect with an external dedicated graphics hookup over DMI bus (e.g., Intel's DMI 3.0 bus) 932. System Agent 936 can include an Image Processing Unit (IPU) (not shown) which incorporates an image signal processor (ISP) on-die.

A neuromorphic computing system is described that adopts a multicore architecture where each core houses computing elements including neurons, synapses with on-chip learning capability, and local memory to store synaptic weights and routing tables. Processor complex 901 include a simplified block diagram illustrating an example of at least a portion of such a neuromorphic computing device, in accordance with at least one embodiment. Neuromorphic computing device 901 can include a neuromorphic processor from Intel Corporation in Santa Clara, CA or another processor that shares at least some of the components described herein. As shown in this example, a device 901 may be provided with a network 917 of multiple neural network cores interconnected by an on-device network such that multiple different connections may be potentially defined between cores. For instance, a network 917 of spiking neural network cores may be provided in device 901 and may each communicate via short packetized spike messages sent from core to core over network channels. Each core (e.g., 915) may possess processing and memory resources and logic to implement some number of primitive nonlinear temporal computing elements, such as, but not limited to, multiple (e.g., 1000+) distinct artificial neurons (referred to herein as “neurons”). For instance, each core may be capable of concurrently implementing multiple neurons such that neuromorphic cores may implement many multiples of neurons using device 901. With respect to neuromorphic computing device 901 and any of its components described above or elsewhere herein, one or more of APIs or equivalents described herein can, for example, get compiled into instructions or equivalents, which may be fetched by instruction fetch logic or equivalents, decoded by a processor decoder or equivalents, scheduled (e.g., in order or out of order) for execution by a scheduler or equivalents, executed by execution logic or equivalents, reordered, and then retired by retirement logic or equivalents.

In at least one embodiment, neuromorphic computing device 901 may additionally include a processor and system memory 909 to implement one or more components, such as via a system manager 905, a memory management unit (MMU) 911, or other components, to manage and provide functionality of neuromorphic computing device 901. For instance, system manager 905 may be provided to manage global attributes and operations of neuromorphic computing device 901 (e.g., attributes affecting network of cores 915, multiple cores in network 917, interconnections of neuromorphic computing device 901 with other devices, manage access to global system memory 990, as assisted by MMU 911 which may provide address translation and check permissions, among other potential examples). In one example, system manager 905 may manage the definition and provisioning of a specific routing tables to various routers in network, orchestration of a network definition and attributes (e.g., weights, decay rates, etc.) to be applied in network, core synchronization and time multiplexing management, routing of inputs to appropriate cores, among other potential functions.

As another example, neuromorphic computing device 901 may additionally include programming interface 913 through which a user or system may specify a neural network definition to be applied (e.g., through a routing table and individual neuron properties) and implemented by mesh 917 of neuromorphic cores. Programming interface 913 may take an input of a programmer to then generate corresponding routing tables and populate local memory of individual neuromorphic cores (e.g., 915) with specified parameters to implement a corresponding, customized network of artificial neurons implemented by neuromorphic cores 915.

In some cases, neuromorphic computing device 901 may advantageously interface with and interoperate with other devices, including general purpose computing devices, to realize certain applications and use cases. Accordingly, external interface logic 903 may be provided in some cases to communicate (e.g., over one or more defined communication protocols) with one or more other devices. An external interface 903 may be utilized to accept input data from another device or external memory controller acting as a source of input data. External interface 903 may be additionally or alternatively utilized to allow results or output of computations of a neural network implemented using neuromorphic computing device 901 to be provided to another device (e.g., another general purpose processor implementing a machine learning algorithm) to realize additional applications and enhancements, among other examples.

In at least one embodiment, a network 917 of multiple neural network cores interconnected by an on-device network is shown illustrating a portion of a network fabric interconnecting multiple neuromorphic cores (e.g., 915). For instance, a number of neuromorphic cores (e.g., 915) may be provided in a mesh, with each core being interconnected by a network including a number of routers (e.g., 950). In one implementation, each neuromorphic core (e.g., 915) may be connected to a single one of routers (e.g., 950) and routers may be connected to at least one other router. As an example, in one particular implementation, four neuromorphic cores (e.g., 915) may be connected to a single router (e.g., 950) and each of routers 950 may be connected to two or more other routers to form a manycore mesh, allowing each neuromorphic core to interconnect with each other neuromorphic core in neuromorphic computing device 901. Moreover, as each neuromorphic core may be configured to implement multiple distinct neurons, router network of neuromorphic computing device 901 may similarly enable connections, or artificial synapses (or, simply, “synapses”), to be defined between any two of potentially many (e.g., 30,000+) neurons defined using network of neuromorphic cores 917 provided in neuromorphic computing device 901.

Processor complex 924 can include an accelerated processing unit. Accelerated processing unit 924 can include a processor for a processor complex based on CDNA architecture from AMD Corporation in Santa Clara, CA or another processor that shares at least some of the components described herein. Accelerated processing unit 924 can include one or more accelerator complex dies (XCDs) 925 for performing operations described elsewhere herein, such as, but not limited to, graphics processing and/or parallel processing as well as computations with instruction-level parallelism, including support for a broad range of precisions (INT8, FP8, BF16, FP16, TF32, FP32, and FP64) and sparse matrix data (i.e. sparsity). XCDs may, in some instances, be referred to as Graphics Compute Dies (GCDs). Accelerated processing unit 924 can include one or more complex compute dies (CCDs) 926 for performing operations described elsewhere herein, such as, but not limited to, those operations performed by host processors.

Accelerated processing unit 924 can include one or more memory units for storing instructions and other information used to perform operations described elsewhere herein. Memory units can include any volatile memory, such as, but not limited to, memory types described elsewhere herein and can include, e.g., high-bandwidth memory (e.g., HMB3) or high-bandwidth DRAM. Memory associated with accelerated processing unit 924 (e.g., memory units) can include system memory that can be used, for example, for commands, instructions and constants, and inputs and outputs. Memory units can also include device memory that can be used as storage and, for example, for commands, instructions and constants, and inputs and outputs, as return buffer(s) and for private data. Memory units can be linked to one or more IODs. L1 cache starts a memory hierarchy that includes shared L2 cache, e.g., within XCDs. AMD Infinity Cache™, which can be a last level cache (LLC) located on an active I/O die (IOD). CCDs 926 and XCDs 925 may have separate or shared memory. AMD Infinity Architecture and AMD Infinity Fabric™ technology can enable coherent, high-throughput unification of GPU and CPU chiplet technologies (e.g., XCDs, CCDs, and/or CCXs) with memory (e.g., stacked HBM3 memory) in single devices and across multi-device platforms.

As shown in FIG. 9, an XCD 925 can include a shared set of global resources 966, which can include hardware scheduler 964 and Asynchronous Compute Engines (ACE) 984 that send tasks (e.g., compute shader workgroups) to Compute Units (CUs or cores) 934. ACEs 984 (e.g., four) can be each associated with CUs 934 (e.g., 40 CUs), and some of CUs 934 can be disabled for yield management. CUs 934 can have dedicated cache or share cache (e.g., L2 cache) 974 that may be used to coalesce all memory traffic for a die. CUs 934 can include threaded and parallel processor cores including instruction fetching and scheduling with Scheduler (S) 982, matrix core unit (MCU) 978 and shader core (SC) 976 (e.g., execution units for scalar, vector and matrix data types), as well as load/store pipelines with an L1 cache 974 and Local Data Share (LDS) 988. Local data share can include, for example, a scratch RAM with built-in arithmetic capabilities that allow data to be shared between threads in a workgroup. An instruction cache 972 (e.g., for storing and providing instructions for performing operations described elsewhere herein) and a constant cache 986 can be connected to one or more CUs and can be shared between two CUs. Matrix cores 978 can process a variety of data types, such as, but not limited to, INT8, FP8, FP16, BF16 and TF32 data types. Processor complex 924 can include compute units 934 that may be arranged in an array format, e.g., as a data-parallel-processor (DPP) array. Ultra-threaded dispatch processor 962 can communicate with compute units 934, and command processor 968 can read commands that a host has written to memory-mapped registers in a system-memory address space (not shown). Command processor 968 can send hardware-generated interrupts to a host processor (e.g., a CCD) when a command is completed. Memory controller 980 can also have direct access to all device memory and host-specified areas of system memory. To satisfy read and write requests, memory controller can perform functions of a direct-memory access (DMA) controller, including computing memory-address offsets based on a format of requested data in memory. For example, one or more of APIs described herein can, for example, get compiled into instructions that can be stored in instruction cache 972 and then fetched by instruction fetch logic in processor complex 924, decoded by a processor decoder or equivalents, scheduled (e.g., in order or out of order) for execution by a scheduler or equivalents, executed by execution logic or equivalents, reordered, and then retired by retirement logic or equivalents. API(s) (and/or compiled instructions including API(s)) can be stored in any storage outside or inside of processor complex 924 (e.g., in cache and/or memory). A result of API(s) can then be stored in storage within or outside of processor complex 924, including registers, DRAM, flash, SRAM, cache, or other memory equivalents.

An application can include a program running on a host processor (e.g., a CCD) and programs, called kernels, running on one or more XCDs. Programs can be controlled by host commands that set internal base-address and other configuration registers, specify a data domain on which accelerated processor complex 924 can operate, invalidate and flush caches on accelerated processor complex 924, and cause accelerated processor complex 924 to begin execution of a program. Kernels can be referred to as programs executed by accelerated processor complex 924. A kernel can be executed independently on every work item, or as groups of work-items that can be referred to as a wavefront, which can execute a kernel on all work-items in a group (e.g., 64) in one pass. Compute units 934 can include a scalar arithmetic logic unit (ALU), which can operates on one value per wavefront (common to all work items), a vector ALU, which can operate on unique values per work-item, a local data share 988, which can allow work-items within a workgroup to communicate and share data, a scalar memory (not shown), which can transfer data between scalar general-purpose registers (SGPRs) and memory through a cache, and vector memory, which can transfer data between vector general-purpose registers (VGPRs) and memory, including sampling texture maps. Kernel control flow can be handled using scalar ALU instructions, which can include if/else, branches and looping. Scalar ALU (SALU) and memory instructions can work on an entire wavefront and operate on one or more SGPRs. Vector memory and ALU instructions can operate on all work-items in a wavefront at one time.

SOC 900 can include Infinity Fabric 960 interconnects (which can be similar to or based on PCIe architectures) that can provide connections among CPUs (e.g., CPU dies 926(1)-926(N)), graphics processor(s), inference engine(s), and other components in a multi-chip architecture, such as secure processor(s) and I/O unit 970. One or more AMD Infinity Fabric™ interconnects can connect to CPU dies 926(1)-926(N) and serve as a connection that is used between CPUs. One or more Infinity Fabric connections can connect each CPU die to I/O unit 970.

Inference engine 954 can provide neural processing capabilities for any processors disclosed herein for computational processes that are used for neural networks, deep learning, and other artificial intelligence-related operations described further herein. Processors disclosed herein can include secure processor(s) 952 for managing security of processors, display controller 992 for controlling displays, a system management unit 956 for managing and operating some or all of the components on processors disclosed herein, multimedia engines 994 for audio and video operations, fusion controller hub 948 for managing USB, SATA and PCIe connections to processors, and sensor fusion hub 951 for managing sensors, such as accelerometers. Processors can also include that include different memory types, such as LPDDR5 and/or DDR5, or others described elsewhere herein.

For performing operations described further herein, processors can include an execution pipeline including a front-end that can include a cache (e.g., L1 cache) that stores instructions (not shown). Flow of instructions can be modified by a branch predictor. Instructions can be decoded by a decoder, dispatched to a back-end for execution, and renamed. Instruction fetch and decode pipes, for example, can be dispatched to integer or floating point execution operations that can be scheduled by a scheduler and transferred to vector and/or general-purpose registers. Floating point multiplier and/or add operations can be processed, and arithmetic logic units (ALUs) can also be used to perform computations, such as arithmetic and logic operations. Outputs from computation units can be coupled to a load/store queue, which can be connected to cache, such as L1 cache and/or L2 cache.

Processor complex 916 may include one or more processors, in accordance with at least one embodiment. Vector processor 918 may support a RISC-V standard. Vector processing unit (VPU) 918 can include one or more vector functional units (FUs) that can be chained together for parallel processing, independent memory paths for RISC-V vector (RVV) load/store via ACE-RVV and Andes Streaming port (ASP) load/store, and a vector load/store unit (VLSU).

Vector processor 918 can include bus interfaces, such as, but not limited to, L2 cache memory port for cacheable access, a MMIO port for non-cacheable access, an input-output coherence Port (IOCP) for cacheless bus master, local memory access ports for ILM/DLM, which can be coupled to SRAM, and high-bandwidth vector memory (HVM) 922 access, a shared peripheral port (SPP) for external peripherals. Other memory ports include LM slave port AXI, HVM subordinate port AXI, MEM (AXI), and AXI. Trace I/F can capture, encode, and transmit off-chip via Inst. Trace I/F, e.g., a record of executed processor instructions, which software tools can use to reconstruct the exact execution sequence of a program.

FIG. 10 illustrates a parallel processor 1000, in accordance with at least one embodiment. Parallel processor 1000 may be implemented using one or more circuits and may be referred to as a programmable processor (e.g., a CPU and/or GPU), logic, an application specific integrated circuit (ASIC), a field programmable gate array (FPGA) or other hardware (e.g., embodiments in FIGS. 9-12B) to perform any of the operations described above or elsewhere herein.

Parallel processor 1000 can include a parallel processing unit 1002 to perform any of the operations described above or elsewhere herein. Parallel processing unit 1002 can include an I/O unit 1004 that enables communication with other devices, including other instances of parallel processing unit 1002. I/O unit 1004 may be directly connected to other devices. I/O unit 1004 may connect with other devices via use of a hub or switch interface, such as, but not limited to, a memory hub 1005. Connections between memory hub 1005 and I/O unit 1004 can form a communication link 1013. I/O unit 1004 may connect with a host interface 1006 and a memory crossbar 1016, where host interface 1006 receives commands directed to performing processing operations and memory crossbar 1016 receives commands directed to performing memory operations.

When host interface 1006 receives a command buffer via I/O unit 1004, host interface 1006 can direct work operations to perform those commands to a front end 1008. Front end 1008 can couple with a scheduler 1010 (which may be referred to as a sequencer), which can be configured to distribute commands or other work items to a processing cluster array 1012. Scheduler 1010 can ensure that processing cluster array 1012 is properly configured and in a valid state before tasks may be distributed to a cluster of processing cluster array 1012. Scheduler 1010 may be implemented via firmware logic executing on a microcontroller. Microcontroller-implemented scheduler 1010 can be configurable to perform complex scheduling and work distribution operations at coarse and fine granularity, enabling rapid preemption and context switching of threads executing on processing array 1012. Host software can prove workloads for scheduling on processing cluster array 1012 via one of multiple graphics processing paths. Workloads can then be automatically distributed across processing array cluster 1012 by scheduler 1010 logic within a microcontroller including scheduler 1010.

Processing cluster array 1012 can perform any of the operations described above or elsewhere herein and can include up to “N” processing clusters (e.g., cluster 1014A, cluster 1014B, through cluster 1014N), where “N” represents a positive integer (which may be a different integer “N” than used in other figures). Each cluster 1014A-1014N of processing cluster array 1012 can execute a large number of concurrent threads. Scheduler 1010 can allocate work to clusters 1014A-1014N of processing cluster array 1012 using various scheduling and/or work distribution algorithms, which may vary depending on workload arising for each type of program or computation. Scheduling can be handled dynamically by scheduler 1010, or can be assisted in part by compiler logic during compilation of program logic configured for execution by processing cluster array 1012. Different clusters 1014A-1014N of processing cluster array 1012 can be allocated for processing different types of programs or for performing different types of computations.

Processing cluster array 1012 can be configured to perform various types of parallel processing operations, such as, but not limited to, any of the operations described above or elsewhere herein. Processing cluster array 1012 can be configured to perform general-purpose parallel compute operations. For example, processing cluster array 1012 can include logic to execute processing tasks including filtering of video and/or audio data, performing modeling operations, including physics operations, and performing data transformations.

Processing cluster array 1012 can be configured to perform parallel graphics processing operations. Processing cluster array 1012 can include additional logic to support execution of such graphics processing operations, including but not limited to, texture sampling logic to perform texture operations, as well as tessellation logic and other vertex processing logic. Processing cluster array 1012 can be configured to execute graphics processing related shader programs such as, but not limited to, vertex shaders, tessellation shaders, geometry shaders, and pixel shaders. Parallel processing unit 1002 can transfer data from system memory via I/O unit 1004 for processing. During processing, transferred data can be stored to on-chip memory (e.g., parallel processor memory 1022) during processing, then written back to system memory.

When parallel processing unit 1002 is used to perform graphics processing, scheduler 1010 can be configured to divide a processing workload into approximately equal sized tasks, to better enable distribution of graphics processing operations to multiple clusters 1014A-1014N of processing cluster array 1012. Portions of processing cluster array 1012 can be configured to perform different types of processing. For example, a first portion may be configured to perform vertex shading and topology generation, a second portion may be configured to perform tessellation and geometry shading, and a third portion may be configured to perform pixel shading or other screen space operations, to produce a rendered image for display. Intermediate data produced by one or more of clusters 1014A-1014N may be stored in buffers to allow intermediate data to be transmitted between clusters 1014A-1014N for further processing.

Processing cluster array 1012 can receive processing tasks to be executed via scheduler 1010, which receives commands defining processing tasks from front end 1008. Processing tasks can include indices of data to be processed, e.g., surface (patch) data, primitive data, vertex data, and/or pixel data, as well as state parameters and commands defining how data is to be processed (e.g., what program is to be executed). Scheduler 1010 may be configured to fetch indices corresponding to tasks or may receive indices from front end 1008. Front end 1008 can be configured to ensure processing cluster array 1012 is configured to a valid state before a workload specified by incoming command buffers (e.g., batch-buffers, push buffers, etc.) is initiated.

Each of one or more instances of parallel processing unit 1002 can couple with a parallel processor memory 1022 to perform any of the operations described above or elsewhere herein. Parallel processor memory 1022 can be accessed via memory crossbar 1016, which can receive memory requests from processing cluster array 1012 as well as I/O unit 1004. Memory crossbar 1016 can access parallel processor memory 1022 via a memory interface 1018. Memory interface 1018 can include multiple partition units (e.g., partition unit 1020A, partition unit 1020B, through partition unit 1020N) that can each couple to a portion (e.g., memory unit) of parallel processor memory 1022. A number of partition units 1020A-1020N can be configured to be equal to a number of memory units, such that a first partition unit 1020A has a corresponding first memory unit 1024A, a second partition unit 1020B has a corresponding memory unit 1024B, and an N-th partition unit 1020N has a corresponding N-th memory unit 1024N. A number of partition units 1020A-1020N may not be equal to a number of memory units.

Memory units 1024A-1024N can include various types of memory devices, including dynamic random access memory (DRAM) or graphics random access memory, such as, but not limited to, synchronous graphics random access memory (SGRAM), including graphics double data rate (GDDR) memory. Memory units 1024A-1024N may also include 3D stacked memory, including but not limited to high bandwidth memory (HBM), HBM2e, or HBM3. Render targets, such as, but not limited to, frame buffers or texture maps may be stored across memory units 1024A-1024N, allowing partition units 1020A-1020N to write portions of each render target in parallel to efficiently use available bandwidth of parallel processor memory 1022. A local instance of parallel processor memory 1022 may be excluded in favor of a unified memory design that utilizes system memory in conjunction with local cache memory.

Any one of clusters 1014A-1014N of processing cluster array 1012 can process data that will be written to any of memory units 1024A-1024N within parallel processor memory 1022. Memory crossbar 1016 can be configured to transfer an output of each cluster 1014A-1014N to any partition unit 1020A-1020N or to another cluster 1014A-1014N, which can perform additional processing operations on an output. Each cluster 1014A-1014N can communicate with memory interface 1018 through memory crossbar 1016 to read from or write to various external memory devices. Memory crossbar 1016 can have a connection to memory interface 1018 to communicate with I/O unit 1004, as well as a connection to a local instance of parallel processor memory 1022, enabling processing units within different processing clusters 1014A-1014N to communicate with system memory or other memory that is not local to parallel processing unit 1002. Memory crossbar 1016 can use virtual channels to separate traffic streams between clusters 1014A-1014N and partition units 1020A-1020N.

Multiple instances of parallel processing unit 1002 can be provided on a single add-in card, or multiple add-in cards can be interconnected. Different instances of parallel processing unit 1002 can be configured to interoperate even if different instances have different numbers of processing cores, different amounts of local parallel processor memory, and/or other configuration differences. For example, some instances of parallel processing unit 1002 can include higher precision floating point units relative to other instances. Systems incorporating one or more instances of parallel processing unit 1002 or parallel processor 1000 can be implemented in a variety of configurations and form factors, including but not limited to desktop, laptop, or handheld personal computers, servers, workstations, game consoles, and/or embedded systems.

FIG. 10 further includes a block diagram of a partition unit 1020, in accordance with at least one embodiment. Partition unit 1020 can be an instance of one of partition units 1020A-1020N of FIG. 10. Partition unit 1020 can include an L2 cache 1021, a frame buffer interface 1025, and a ROP 1026 (raster operations unit). L2 cache 1021 can be a read/write cache that is configured to perform load and store operations received from memory crossbar 1016 and ROP 1026. Read misses and urgent write-back requests can be output by L2 cache 1021 to frame buffer interface 1025 for processing. Updates can also be sent to a frame buffer via frame buffer interface 1025 for processing. Frame buffer interface 1025 may interface with one of memory units in parallel processor memory, such as, but not limited to, memory units 1024A-1024N (shown as 1024) of FIG. 10 (e.g., within parallel processor memory 1022).

ROP 1026 can be a processing unit that performs raster operations such as, but not limited to, stencil, z test, blending, etc. ROP 1026 can then output processed graphics data that can be stored in graphics memory. ROP 1026 can include compression logic to compress depth or color data that is written to memory and decompress depth or color data that is read from memory. Compression logic can be lossless compression logic that makes use of one or more of multiple compression algorithms. A type of compression that is performed by ROP 1026 can vary based on statistical characteristics of data to be compressed. For example, delta color compression is performed on depth and color data on a per-tile basis.

ROP 1026 can be included within each processing cluster (e.g., cluster 1014A-1014N of FIG. 10) instead of within partition unit 1020. Read and write requests for pixel data may be transmitted over memory crossbar 1016 instead of pixel fragment data. Processed graphics data may be displayed on a display routed for further processing by processor(s), or routed for further processing by one of processing entities within parallel processor 1000 of FIG. 10.

In at least one embodiment, parallel processor 1000 can include circuitry (e.g., one or more circuits) to generate, from an input tensor, contraction operands by directly storing the operands in a reordered feature-leading layout and perform a feature-preserving triangular multiplicative update by contraction over an intermediate index or otherwise perform any of the operations described above or elsewhere herein. One or more circuits can be configured by software to generate, from an input tensor, contraction operands by directly storing the operands in a reordered feature-leading layout and perform a feature-preserving triangular multiplicative update by contraction over an intermediate indexgenerate, from an input tensor, contraction operands by directly storing the operands in a reordered feature-leading layout and perform a feature-preserving triangular multiplicative update by contraction over an intermediate index or otherwise perform any of the operations described above or elsewhere herein.

FIG. 10 includes a block diagram of a processing cluster 1014 within a parallel processing unit, in accordance with at least one embodiment. A processing cluster can be an instance of one of processing clusters 1014A-1014N of FIG. 10 that can be used to perform any of the operations described above or elsewhere herein. Processing cluster 1014 can be configured to execute many threads in parallel, where “thread” refers to an instance of a particular program executing on a particular set of input data. Single-instruction, multiple-data (SIMD) instruction issue techniques can be used to support parallel execution of a large number of threads without providing multiple independent instruction units. Single-instruction, multiple-thread (SIMT) techniques may be used to support parallel execution of a large number of generally synchronized threads, using a common instruction unit configured to issue instructions to a set of processing engines within each one of processing clusters.

Operation of processing cluster 1014 can be controlled via a pipeline manager 1032 that distributes processing tasks to SIMT parallel processors. Pipeline manager 1032 can receive instructions from scheduler 1010 of FIG. 10 and manages execution of those instructions via a graphics multiprocessor 1034 and/or a texture unit 1036. Graphics multiprocessor 1034 may be an example instance of a SIMT parallel processor. However, various types of SIMT parallel processors of differing architectures may be included within processing cluster 1014. One or more instances of graphics multiprocessor 1034 can be included within a processing cluster 1014. Graphics multiprocessor 1034 can process data and a data crossbar 1040 can be used to distribute processed data to one of multiple possible destinations, including other shader units. Pipeline manager 1032 can facilitate distribution of processed data by specifying destinations for processed data to be distributed via data crossbar 1040.

Each graphics multiprocessor 1034 within processing cluster 1014 can include an identical set of functional execution logic (e.g., arithmetic logic units, load-store units, etc.) to perform computations for any of the operations described above or elsewhere herein. Functional execution logic can be configured in a pipelined manner in which new instructions can be issued before previous instructions may be complete. Functional execution logic can support a variety of operations including integer and floating point arithmetic, comparison operations, Boolean operations, bit-shifting, and computation of various algebraic functions. Same functional-unit hardware can be leveraged to perform different operations and any combination of functional units may be present.

Instructions transmitted to processing cluster 1014 may constitute a thread, which can also be referred to as a warp, subgroup, wave, or a wavefront. A set of threads executing across a set of parallel processing engines can be referred to as a thread group. A thread group can execute a common program on different input data. Each thread within a thread group can be assigned to a different processing engine within a graphics multiprocessor 1034. A thread group may include fewer threads than a number of processing engines within graphics multiprocessor 1034. When a thread group includes fewer threads than a number of processing engines, one or more of processing engines may be idle during cycles in which that thread group is being processed. A thread group may also include more threads than a number of processing engines within graphics multiprocessor 1034. When a thread group includes more threads than number of processing engines within graphics multiprocessor 1034, processing can be performed over consecutive clock cycles. Multiple thread groups can be executed concurrently on a graphics multiprocessor 1034.

Graphics multiprocessor 1034 includes an internal cache memory to perform load and store operations, such as, but not limited to, any of the operations described above or elsewhere herein. Graphics multiprocessor 1034 can forego an internal cache and use a cache memory (e.g., L1 cache 1048) within processing cluster 1014. Each graphics multiprocessor 1034 may also have access to L2 caches within partition units (e.g., partition units 1020A-1020N of FIG. 10) that can be shared among all processing clusters 1014 and may be used to transfer data between threads. Graphics multiprocessor 1034 may also access off-chip global memory, which can include one or more of local parallel processor memory and/or system memory. Any memory external to parallel processing unit 1002 may be used as global memory. Processing cluster 1014 can include multiple instances of graphics multiprocessor 1034 and can share common instructions and data, which may be stored in L1 cache 1048.

Each processing cluster 1014 may include an MMU 1045 (memory management unit) that can be configured to map virtual addresses into physical addresses. One or more instances of MMU 1045 may reside within memory interface 1018 of FIG. 10. MMU 1045 can include a set of page table entries (PTEs) used to map a virtual address to a physical address of a tile and optionally a cache line index. MMU 1045 may include address translation lookaside buffers (TLB) or caches that may reside within graphics multiprocessor 1034 or L1 cache 1048 cache or processing cluster 1014. A physical address can be processed to distribute surface data access locally to allow for efficient request interleaving among partition units. A cache line index may be used to determine whether a request for a cache line is a hit or miss.

A processing cluster 1014 may be configured such that each graphics multiprocessor 1034 is coupled to a texture unit 1036 for performing texture mapping operations, e.g., determining texture sample positions, reading texture data, and filtering texture data. Texture data can be read from an internal texture L1 cache (not shown) or from an L1 cache within graphics multiprocessor 1034 and can be fetched from an L2 cache, local parallel processor memory, or system memory, as needed. Each graphics multiprocessor 1034 can output processed tasks to data crossbar 1040 to provide processed task to another processing cluster 1014 for further processing or to store processed task in an L2 cache, local parallel processor memory, or system memory via memory crossbar 1016. A preROP 1042 (pre-raster operations unit) can be configured to receive data from graphics multiprocessor 1034, and direct data to ROP units, which may be located with partition units as described herein (e.g., partition units 1020A-1020N of FIG. 10). PreROP 1042 unit can perform optimizations for color blending, organizing pixel color data, and performing address translations.

In at least one embodiment, graphics multiprocessor 1034 can couple with pipeline manager 1032 of processing cluster 1014. Graphics multiprocessor 1034 can include an execution pipeline including but not limited to an instruction cache 1052 (that, e.g., can store instructions, such as, not limited to compiled API instructions), an instruction unit 1054, an address mapping unit 1056, a register file 1058, one or more general purpose graphics processing unit (GPGPU) cores 1062, and one or more load/store units 1066, where one or more load/store units 1066 can perform load/store operations to load/store instructions corresponding to performing an operation. GPGPU cores 1062 and load/store units 1066 can be coupled with cache memory 1072 and shared memory 1070 via a memory and cache interconnect 1068. GPGPU cores 1062 can be part of an SoC such as, but not limited to, part of integrated circuit 900 in FIG. 9.

Instruction cache 1052 can receive a stream of instructions (e.g., to perform any of the operations described above or elsewhere herein) to execute from pipeline manager 1032. Instructions can be cached in instruction cache 1052 and dispatched for execution by an instruction unit 1054. Instruction unit 1054 can dispatch instructions as thread groups (e.g., warps, subgroups, wavefronts, or waves), with each thread of thread group assigned to a different execution unit within GPGPU cores 1062. An instruction can access any of a local, shared, or global address space by specifying an address within a unified address space. Address mapping unit 1056 can be used to translate addresses in a unified address space into a distinct memory address that can be accessed by load/store units 1066.

Register file 1058 can provide a set of registers for functional units of graphics multiprocessor 1034. Register file 1058 may provide temporary storage for operands connected to data paths of functional units (e.g., GPGPU cores 1062, load/store units 1066) of graphics multiprocessor 1034. Register file 1058 may be divided between each of functional units such that each functional unit is allocated a dedicated portion of register file 1058. Register file 1058 can be divided between different warps (which may be referred to as wavefronts, subgroups, and/or waves or threads) being executed by graphics multiprocessor 1034.

GPGPU cores 1062 can each include floating point units (FPUs) and/or integer arithmetic logic units (ALUs) that can be used to execute instructions of graphics multiprocessor 1034. GPGPU cores 1062 can be similar in architecture or can differ in architecture. A first portion of GPGPU cores 1062 can include a single precision FPU and an integer ALU while a second portion of GPGPU cores include a double precision FPU. FPUs can implement IEEE 754-2008 standard floating point arithmetic or enable variable precision floating point arithmetic. Graphics multiprocessor 1034 can additionally include one or more fixed function or special function units to perform specific functions such as, but not limited to, copy rectangle or pixel blending operations. One or more of GPGPU cores 1062 can also include fixed or special function logic.

GPGPU cores 1062 can include SIMD logic capable of performing a single instruction on multiple sets of data. GPGPU cores 1062 can physically execute SIMD4, SIMD8, and SIMD16 instructions and logically execute SIMD1, SIMD2, and SIMD32 instructions. SIMD instructions for GPGPU cores can be generated at compile time by a shader compiler or automatically generated when executing programs written and compiled for single program multiple data (SPMD) or SIMT architectures. Multiple threads of a program can be configured for an SIMT execution model that can be executed via a single SIMD instruction. For example, eight SIMT threads that perform same or similar operations can be executed in parallel via a single SIMD8 logic unit.

Memory and cache interconnect 1068 can include an interconnect network that connects each functional unit of graphics multiprocessor 1034 to register file 1058 and to shared memory 1070. Memory and cache interconnect 1068 may be a crossbar interconnect that allows load/store unit 1066 to implement load and store operations between shared memory 1070 and register file 1058. Register file 1058 can operate at a same frequency as GPGPU cores 1062, thus data transfer between GPGPU cores 1062 and register file 1058 can have very low latency. Shared memory 1070 can be used to enable communication between threads that execute on functional units within graphics multiprocessor 1034. Cache memory 1072 can be used as a data cache for example, to cache texture data communicated between functional units and texture unit 1036. Shared memory 1070 can also be used as a program managed cache. Threads executing on GPGPU cores 1062 can programmatically store data within shared memory in addition to automatically cached data that is stored within cache memory 1072.

A parallel processor or GPGPU as described herein may be communicatively coupled to host/processor cores to accelerate graphics operations, machine-learning operations, pattern analysis operations, and various general purpose GPU (GPGPU) functions. A GPU may be communicatively coupled to host processor/cores over a bus or other interconnect (e.g., a high-speed interconnect such as, but not limited to, PCIe or NVLink). An SoC may include a parallel processor or GPGPU as described herein, where said parallel processor or said GPGPU is performed on said SoC. A GPU may be integrated on a package or chip as cores and communicatively coupled to cores over an internal processor bus/interconnect internal to a package or chip. Regardless of a manner in which a GPU is connected, processor cores may allocate work to such GPU in a form of sequences of commands/instructions contained in a work descriptor. GPU then may use dedicated circuitry/logic for efficiently processing these commands/instructions to perform any of the operations described above or elsewhere herein.

In at least one embodiment, graphics multiprocessor 1034 can include circuitry (e.g., one or more circuits) to generate, from an input tensor, contraction operands by directly storing the operands in a reordered feature-leading layout and perform a feature-preserving triangular multiplicative update by contraction over an intermediate indexgenerate, from an input tensor, contraction operands by directly storing the operands in a reordered feature-leading layout and perform a feature-preserving triangular multiplicative update by contraction over an intermediate index or otherwise perform any of the operations described above or elsewhere herein. One or more circuits can be configured by software to generate, from an input tensor, contraction operands by directly storing the operands in a reordered feature-leading layout and perform a feature-preserving triangular multiplicative update by contraction over an intermediate indexgenerate, from an input tensor, contraction operands by directly storing the operands in a reordered feature-leading layout and perform a feature-preserving triangular multiplicative update by contraction over an intermediate index or otherwise perform any of the operations described above or elsewhere herein.

In at least one embodiment, processor 1000 can include a processor with AI accelerator architecture from Intel Corporation in Santa Clara, CA or another processor that shares at least some of the components described herein. AI accelerator 1000 may use instructions that, if executed by AI accelerator 1000, cause AI accelerator 1000 to perform some or all of processes and techniques described elsewhere herein. For example, with respect to AI accelerator 1000 and any of its components described above or elsewhere herein, one or more of APIs described herein can, for example, get compiled into instructions, which may be fetched by instruction fetch logic or equivalents, decoded by a processor decoder or equivalents, scheduled (e.g., in order or out of order) for execution by a scheduler or equivalents, executed by execution logic or equivalents, reordered, and then retired by retirement logic or equivalents. API(s) (and/or compiled instructions including API(s)) can be stored in any storage outside or inside of AI accelerator 1000 (e.g., in cache and/or memory). A result of API(s) can then be stored in storage within or outside of AI accelerator 1000, including registers, DRAM, flash, SRAM, cache, or other memory. AI accelerator 1000 may include one or more compute dies that can include homogeneous or heterogeneous processors. Compute dies may include one or more central processing units (CPU), one or more graphics processing units (GPU), or combinations of both.

In at least one embodiment, compute dies may include compute engines to perform AI computations. In at least one embodiment, AI accelerator 1000 compute dies may be split into any number of (e.g., four) clusters that may be referred to as a DCORE (Deep Learning Core) 1034 and contain any number of Matrix Multiplication Engines (MMEs), Tensor Processor Cores (TPCs) 1061, a global control 1023, a memory management unit, and an L2 Cache, in any combination. MME(s) can perform operations that use Matrix Multiplication, like fully connected layers, convolutions and batched-General Matrix Multiplications (GEMMs). MME(s) may be programmed with array dimensions, locations, data types, and various execution operands. MME(s) can retrieve tensors A and B from memory, pulling them into its streaming buffers for matrix multiplication to be performed in parallel by MACs. MME(s) may push tensor C back to memory upon completion. TPCs can support different types of parallel processing, e.g., Very Long Instruction Word (VLIW) Single-Instruction Multiple-Data (SIMD) that supports data types, such as, but not limited to, FP32, BF16, FP16 & FP8 (both E4M3 and E5M2), UINT32, INT32, UINT16, INT16, UINT8 and INT8 datatypes. Any number of compute dies may be connected through an interconnect. An interconnect that can connect compute dies can be over an interposer bridge that, e.g., is transparent to software.

Memory on AI Accelerator 1000 may include one or more levels of cache (e.g., L1, L2, L3, and/or last-level cache) and high-bandwidth memory (e.g., HBM2e or HBM3) in any combination. Memory and/or cache systems can be unified or separate. Compute dies of AI accelerator 1000 may include on-die memory that includes one or more levels (e.g., two-levels) of cache. On-die SRAM or other memory described elsewhere herein can be used as a uniformly accessible last-level cache (L3) or split to slices of L2 cache that may be accessible to groups of MMEs and TPCs 1061. Using on-die memory as L2 or L3 cache can be fully configurable by software, which dynamically may decide per I/O tensor its optimal cache allocation. AI Accelerator 1000 may include one or more Memory Management Units (MMUs) for managing memory, such as allowing AI accelerator 1000 memory subsystem to operate in a virtual space when accessing VRAM.

AI accelerator 1000 may include a communications port (e.g., a PCIe Gen5 X16 port) for communicating with a host and Scheduling and Synchronization Unit. AI accelerator 1000 may include Media Unit that may include any number or combinations of Media Decoder Engines (DECs) and Rotator Engines (ROT). AI accelerator 1000 may include a network unit that may include any number or combinations of network ports and accompanied RDMA Engine(s), L2 Cache, and memory (e.g., HBM2e or HBM3) stacks.

AI accelerator 1000 may include media decoding units that support Video Formats, such as, but not limited to, HEVC, Progressive H.264, SVC base layer, MVC, VP9, JPEG, Progressive JPEG. AI accelerator 1000 may support post processing of decoded media streams, such as, but not limited to, image down-scaling (resizing an image), vertical and horizontal scaling at different scaling ratios, Image up-scaling, Image cropping, bilinear scaling, and Lancos scaling. AI accelerator 1000 may implement two post processing channels per decoder unit, one with scalar (up and down) and one just to output the original image. AI accelerator 1000 may include a hardware rotator engine that performs the following transformations of an input image: 2D rotation, 3D rotation, Projection, distorting and undistorting images, resampling input data at user-defined coordinates, and rescaling.

RDMA over Converged Ethernet on AI accelerator 1000 may enable scaling from a single node (i.e., a single AI Accelerator 1000 to hundreds or thousands of nodes or AI Accelerators 1000). NW Subsystem can include an Intel® Gaudi® Communication Library (IGCL), a master conductor that orchestrates data movement, and a programable scheduling mechanism that can enable smooth activation of engines while maintaining task dependencies. A accelerator networking sub-system can include Gigabit Ethernet NIC ports.

AI Accelerator 1000 can be operated and controlled using software layer that may include low-level components, such as, but not limited to, a graph compiler, an automatic kernel fuser and a library of precompiled kernels, as well as integration to AI ecosystems, such as, but not limited to, PyTorch, JAX, TensorFlow, DeepSpeed, Hugging Face, vLLM, Ray and more, or as described elsewhere herein with respect to software and programming platforms. Software layer may include implementations of algorithms, such as, but not limited to, Paged Attention, Flash Attention and more. Software layer may generate optimized binary code that implements a given model topology, such as, but not limited to, performing operator fusion, data layout management, parallelization, pipelining and memory management, and graph-level optimizations.

In at least one embodiment, cores 1062 may be configured similar to a NPU and can include one or more Intel® AI Boost built-in neural processing unit(s) (NPUs). NPU can be enumerated to a host processor as an integrated PCIe device. NPU can include one or more (e.g., two) Neural Compute Engine (NCE) tiles. For general compute needs, NCE tiles can include inference pipeline 1033 and Streaming Hybrid Architecture Vector Engines (SHAVE) 1028 for high performance parallel computing, which can include DMA (Direct Memory Access) engines to shuttle data between system memory DRAM (Dynamic Random Access Memory) and a software managed cache.

In one example, a single neuromorphic core may implement some number of neurons (e.g., 1024) that share architectural resources of neuromorphic core 1062 in a time-multiplexed manner. In one example, each neuromorphic core 1062 may include processor block capable of performing arithmetic functions and routing in connection with the realization of a digitally implemented artificial neuron, such as, but not limited to, explained herein. Each neuromorphic core 1062 may additionally provide local memory in which a routing table may be stored and accessed for a neural network, accumulated potential of each soma of each neuron implemented using core 1062 may be tracked, parameters of each neuron implemented by core 1062 may be recorded, among other data and usage. Components, or architectural resources, of neuromorphic core 1062 may further include input interface to accept input spike messages generated by other neurons on other neuromorphic cores and output interface to send spike messages to other neuromorphic cores over mesh network. In some instances, routing logic for neuromorphic core 1062 may be at least partially implemented using output interface. Further, in some cases, core 1062 may implement multiple neurons within an example SNN and some of these neurons may be interconnected. In such instances, spike messages sent between neurons hosted on core 1062 may forego communication over routing fabric of neuromorphic computing device and may instead by managed locally at particular neuromorphic core 1062.

Each neuromorphic core 1062 may additionally include logic to implement, for each neuron, artificial dendrite and artificial soma (referred to herein, simply, as “dendrite” and “soma” respectively). Dendrite may be a hardware-implemented process that receives spikes from network. Soma may be a hardware-implemented process that receives each dendrite's accumulated neurotransmitter amounts for the current time and evolves each dendrite and soma's potential state to generate outgoing spike messages at the appropriate times. Dendrite may be defined for each connection receiving inputs from another source (e.g., another neuron). In one implementation, dendrite process may receive and handle spike messages as they serially arrive in time-multiplexed fashion from network. As spikes are received, neuron's activation (tracked using soma (and local memory)) may increase. When neuron's activation exceeds a threshold set for neuron, neuron may generate a spike message that is propagated to a fixed set of fanout neurons via output interface. Network distributes spike messages to all destination neurons, and in response those neurons, in turn, may update their activations in a transient, time-dependent manner, and so on, potentially causing the activation of some of these destination neurons to also surpass corresponding thresholds and trigger further spike messages, as in real biological neural networks.

In an improved implementation of a system capable of supporting SNNs, such as, but not limited to, a very large scale integration (VLSI) hardware device illustrated in the example of FIG. 10, high speed and reliable circuits may be provided to implement SNNs to model information processing algorithms as employed by a brain, but in a more programmable manner. For instance, while a biological brain can only implement a specific set of defined behaviors, as conditioned by years of development, a neuromorphic processor device may provide a capability to rapidly reprogram all neural parameters. Accordingly, a single neuromorphic processor may be utilized to realize a broader range of behaviors than those provided by a single slice of biological brain tissue. This distinction may be realized by adopting a neuromorphic processor with neuromorphic design realizations that differ markedly from those of neural circuits found in nature.

As an example, a neuromorphic processor 1034 may utilize time-multiplexed computation in both a spike communication network and neuron machinery of neuromorphic computing device to implement SNNs. Accordingly, physical circuitry of neuromorphic computing device may be shared among many neurons to realize higher neuron density. With time multiplexing, a network can connect N cores with O(N) total wiring length, whereas discrete point-to-point wiring would scale as O(N²), realizing a significant reduction in wiring resources to accommodate planar and non-plastic VLSI wiring technologies, among other examples. In neuromorphic cores, time multiplexing may be implemented through dense memory allocation, for instance, using Static Random Access Memory (SRAM), with shared buses, address decoding logic, and other multiplexed logic elements. State of each neuron may be stored in processor's memory, with data describing each neuron state including state of each neuron's collective synapses, all currents and voltages over its membrane, among other example information (such as, but not limited to, configuration and other information).

In operation, neuromorphic computing device 1000 may begin in an idle state with all neuromorphic cores inactive. As each core asynchronously cycles through its neurons, it generates spike messages that a mesh interconnect routes to appropriate destination cores containing all destination neurons. Implementation of multiple neurons on a single neuromorphic core may be time-multiplexed, and a time step may be defined in which all spikes involving multiple neurons may be processed and considered using shared resources of a corresponding core. As each core finishes servicing its neurons for a respective time step, cores may, in some implementations, communicate (e.g., using a handshake) with neighboring cores using synchronization messages to flush a mesh of all spike messages in flight, allowing cores to safely determine that all spikes have been serviced for a time step. At that point all cores may be considered synchronized, allowing them to advance their time step and return to an initial state and begin a next time step.

Given this context, and as introduced above, a device (e.g., 1000) implementing a mesh of interconnected neuromorphic cores may be provided, with core 1062 implementing potentially multiple artificial neurons capable of being interconnected to implement an SNN. Each neuromorphic core (e.g., 1062) may provide two loosely coupled asynchronous processes: an input dendrite process that receives spikes from network and applies them to an appropriate destination dendrite compartments at the appropriate future times, and output soma process that receives each dendrite compartment's accumulated neurotransmitter amounts for the current time and evolves each dendrite and soma's membrane potential state, generating outgoing spike messages at appropriate times (e.g., when a threshold potential of a soma has been reached). Note that, from a biological perspective, dendrite and soma names used here only approximate a role of these functions and should not be interpreted too literally.

In at least one embodiment, parallel processor 1000 may include one or more tensor processing units (TPUs), in accordance with at least one embodiment. TPUs can include application specific integrated circuits (ASICs), e.g., to perform some or all of the operations described above or elsewhere herein, such as, but not limited to, accelerate machine learning workloads performing matrix operations. TPUs may be ASICs from Alphabet Corporation in Mountain View, CA. Cloud TPU includes a cloud service that makes TPUs available as a scalable resource for processing tasks, such as, but not limited to, machine learning workloads that can run on frameworks such as, but not limited to, TensorFlow, Pytorch, and JAX.

Parallel processor 1000 can include any number of TPUs that can include tensor cores 1062. Tensor core 1062 can include one or more of core sequencer 1009, vector processing unit (VPU) 1011, matrix multiply unit (MXU) 1015(A)-1015(N), where N is any integer greater than 1, and transpose permute unit 1017. Core Sequencer 1009 can fetch (e.g., VLIW (Very Long Instruction Word)) instructions from core's Instruction Memory (Imem), execute scalar operations using a scalar data memory (Smem) and scalar registers (Sregs) (not shown), and forward vector instructions to Vector Processing Unit (VPU) 1011. Instructions can, for example, launch eight operations: two scalar, two vector ALU, vector load and store, and a pair of slots that queue data to and from matrix multiply and transpose units. VPU 1011 can perform vector operations using a large on-chip vector memory (Vmem), and vector registers (Vregs). VPU 1011 can stream data to and from MXU through decoupling FIFOs. VPU 1011 can collect and distribute data to Vmem via data-level parallelism (2D matrix and vector functional units) and instruction-level parallelism (8 operations per instruction). A large two-dimensional matrix multiply unit (MXU) 1015(A)-1015(N) can, e.g., use a systolic array to reduce area and energy plus large, software-controlled on-chip memories instead of caches. Transpose Reduction Permute Unit 1017 can do (e.g., 128×128) matrix transposes, reductions, and permutations of VPU 1011 lanes. High Bandwidth Memory 1007 can be used for applications on chip, and it can be coupled to host queue(s) 1003, e.g., over PCIe. One or more chips 1091 can be connected together for computing. For example, one or more chips 1091 can be connected as a torus, e.g., a 2D torus. Chip 1091 can also include any number (e.g., four) Inter-Core Interconnect (ICI) links 1019 that can enable direct connections between chips to form a supercomputer.

With respect to any processors in chip 1091 and any of its components described above or elsewhere herein, one or more of APIs or equivalents described herein can, for example, get compiled into instructions or equivalents, which may be fetched by instruction fetch logic or equivalents, decoded by a processor decoder or equivalents, scheduled (e.g., in order or out of order) for execution by a scheduler or equivalents, executed by execution logic or equivalents, reordered, and then retired by retirement logic or equivalents. API(s) (and/or compiled instructions including API(s)) can be stored in any storage outside or inside of any processors in chip 1091 (e.g., in cache and/or memory). A result of API(s) can then be stored in storage within or outside of any processors in chip 1000, including registers, DRAM, flash, SRAM, cache, or other memory equivalents.

In at least one embodiment, parallel processor 1000 may include one or more vector processors, in accordance with at least one embodiment. Vector processor may support a RISC-V standard. Vector processor can include one more cores (e.g., scalar units) with one or more Vector Processing Units (VPUs) (e.g., vector units) that can, e.g., perform some or all of the operations described above or elsewhere herein. The one or more cores may include Andes Custom Extension (ACE) that can be used for communication of customized instructions for processor, for example, via ACP. The one or more cores may include 1-cycle multiplier and 1-cycle instruction/data local memory (ILM/DLM) for increased parallelism by allowing simultaneous instruction fetches and data accesses. A memory management unit (e.g., MMU 1045) may manage system memory and cache, and provide for branch execution, issuance of instruction pairs, L1 instruction/data caches and local memory storage. The one or more cores can include Physical memory protection and programmable physical memory attribute unit (PMP/PPMA). Core can include a digital signal processor (DSP), and a floating-point unit (FPU) as well as load-store unit (LSU) to interface with memory hierarchy (D$ and I$). The one or more cores can include branch prediction unit and multiplier unit.

In at least one embodiment, chip 1091 can include circuitry (e.g., one or more circuits described above and elsewhere herein) to generate, from an input tensor, contraction operands by directly storing the operands in a reordered feature-leading layout and perform a feature-preserving triangular multiplicative update by contraction over an intermediate indexgenerate, from an input tensor, contraction operands by directly storing the operands in a reordered feature-leading layout and perform a feature-preserving triangular multiplicative update by contraction over an intermediate index or otherwise perform any of the operations described above or elsewhere herein. One or more circuits can be configured by software to generate, from an input tensor, contraction operands by directly storing the operands in a reordered feature-leading layout and perform a feature-preserving triangular multiplicative update by contraction over an intermediate indexgenerate, from an input tensor, contraction operands by directly storing the operands in a reordered feature-leading layout and perform a feature-preserving triangular multiplicative update by contraction over an intermediate index or otherwise perform any of the operations described above or elsewhere herein.

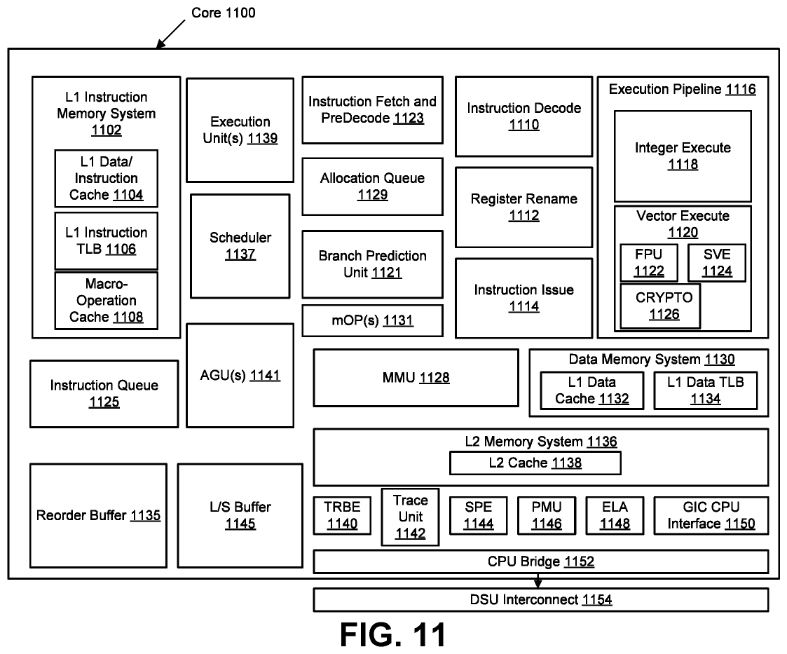

FIG. 11 illustrates an example of a processing core 1100 that may implement Arm architecture (e.g., v9.0-A) or another processor that shares at least some of the components described herein. Neoverse™ V2 core 1100 can be implemented inside a DynamIQ Shared Unit (DSU) cluster via DSU-110 interconnect 1154 for connected one or more cores, e.g., for parallel processing. Neoverse™ V2 core may be implemented as a single core in a DSU cluster that is configured for Direct connect, with or without L3 cache, snoop filter, or Snoop Control Unit (SCU) logic (not shown). Neoverse™ V2 core can include a CPU bridge 1152 that connects core 1100 to DSU-110 interconnect 1154, which can also connect core 1100 to an external memory system and the rest of a system-on-a-chip. L1 instruction memory system 1102 can fetch instructions from an instruction cache 1104 and deliver instructions (e.g., one or more APIs described herein that may be compiled into instructions) to an instruction decode unit 1110, e.g., to perform some or all of operations described above or elsewhere herein. L1 instruction memory system 1102 may include L1 instruction cache 1104, e.g., with 64-byte cache lines, L1 instruction Translation Lookaside Buffer (TLB) 1106, e.g., with native support for 4 KB, 16 KB, 64 KB, and 2 MB page sizes, Macro-Operation Cache (MOP) 1108 (e.g., 1536-entry, 4-way skewed associative L0 MOP cache), which can contain decoded and optimized instructions for higher performance. Instruction decode unit 1110 can decode AArch64 instructions into internal format. Register rename unit 1112 can perform register renaming to facilitate out-of-order execution and dispatches decoded instructions to various issue queues. Instruction issue unit 1114 can control when decoded instructions may be dispatched to execution pipelines, and it can include issue queues for storing instructions pending dispatch to execution pipelines. Integer execution pipeline 1116 can be included in an execution pipeline and include integer execute unit 1118 that can perform arithmetic and logical data processing operations. Vector execute unit 1120 can be included in an execution pipeline and can perform Advanced SIMD and floating-point operations (FPU) 1122, execute Scalable Vector Extension (SVE) and Scalable Vector Extension 2 (SVE2) instructions 1124, and can optionally execute cryptographic instructions (Crypto) 1126. Advanced SIMD can include media and signal processing architecture that adds instructions primarily for audio, video, 3D graphics, image, and speech processing. A floating-point architecture provides support for single-precision and double-precision floating-point operations. L1 data memory system 1130 can execute load and store instructions, as well as service memory coherency requests. L1 data memory system 1130 can include an L1 data cache 1132 and a fully associative L1 data TLB 1134 with native support for 4 KB, 16 KB and 64 KB page sizes and 2 MB and 512 MB block sizes. Memory Management Unit (MMU) 1128 can provide fine-grained memory system control through a set of virtual-to-physical address mappings and memory attributes that can be held in translation tables, which can be saved into TLB 1134 when an address is translated. L2 memory system 1136 can include L2 cache 1138, and it can be connected to DSU-110 1154 through an asynchronous CPU bridge 1152. Neoverse™ V2 core 1100 can support a range of debug, test, and trace options including a trace unit 1142 and a trace buffer 1140, and an Embedded Logic Analyzer (ELA) 1148. Neoverse™ V2 core 1100 can implement Statistical Profiling Extension (SPE) 1144 to provide a statistical view of the performance characteristics of executed instructions that software writers can use to optimize their code for better performance. Performance Monitoring Unit (PMU) 1146 can provide performance monitors that can be configured to gather statistics on operation of each core and memory system. Information can be used for debug and code profiling. Generic Interrupt Controller (GIC) CPU interface 1150, when integrated with an external distributor component, can be a resource for supporting and managing interrupts in a cluster system. In a cluster, there can be one CPU bridge 1152 between each Neoverse™ V2 core 1100 and DSU-110 1154. CPU bridge 1152 can control buffering and synchronization between core 1100 and DSU-110 1154. CPU bridge 1152 can be asynchronous to allow different frequency, power, and area implementation points for each core 1100. CPU bridge 1152 can run synchronously without affecting other interfaces such as, but not limited to, debug and trace which can be asynchronous.

Each core 1100 can include a fetch/decode unit (e.g., 1123), an integer execution engine (e.g., 1118), a floating point execution engine (e.g., 1120), and an L2 cache (e.g., 1138). The fetch/decode unit can fetch instructions to perform some or all of the operations described herein (such as, but not limited to, an API that is compiled into instructions) and decode such instructions, generate micro-operations, and dispatch separate micro-instructions to the integer execution engine and/or the floating point execution engine. The fetch/decode unit can concurrently dispatch one micro-instruction to the integer execution engine and another micro-instruction to the floating point execution engine. The integer execution engine can execute integer and memory operations. The floating point engine can execute floating point and vector operations. The fetch/decode unit can dispatch micro-instructions to one or more execution engines that replace both the integer execution engine and the floating point execution engine.

Each core 1100 may access an i-th L2 cache included in i-th core 1100. Each core 1100 included in a j-th core complex, where j is an integer representing a particular instance of the core complex, can be connected to other cores 1100 included in the j-th core complex via an L3 cache included in the j-th core complex. Cores 1100 included in the j-th core complex, where j is an integer representing a particular instance of the core complex, can access all of the L3 cache included in the j-th core complex. The L3 cache may include any number of slices.

In at least one embodiment, core 1100 can include a front-end, a back-end or execution engine, and a memory subsystem. The front-end can provide the execution engine with operations (e.g., operations described elsewhere herein) by decoding instructions stored in memory. For example, the front-end can include a micro-operations (μOps) cache path and/or a legacy path 1131, along with branch prediction unit 1121 that can determine paths instructions. A legacy path for instructions may include fetching variable-length (e.g., x86) instructions from L1 instruction cache 1104 with instruction fetch and predecode 1123, queuing the instructions in instruction queue 1125, and decoding instructions using a decoder (e.g., 1110) into μOps that can be provided to allocation queue 1129. Alternatively, a μOPs cache path may include a cache containing already decoded μOps (μOps 1131) that can be sent to allocation queue 1129. Allocation queue 1129 can perform as an interface between the front-end and the execution engine, and can provide instructions to the execution engine. One or more of API(s) described herein can, for example, get compiled into instructions that can be stored, processed, and executed by the front-end, the execution engine, and stored in the memory subsystem.

The execution engine can receive micro-operations into reorder buffer 1135, which can register allocation, rename, and retire μOPs. From reorder buffer 1135, μOPs can be sent to scheduler 1137 that can be connected one or more different execution units 1139, which can be connected to address generation unit (AGU) 1141. Execution units 1139 can perform, e.g., basic arithmetic logic unit (ALU) operations, multiplication, division, and/or more complex operations, such as, but not limited to, various vector operations. Scheduler 1137 may manage queuing μOPs for one or more of execution units 1139 depending, e.g., on operations needed to be performed.

The memory subsystem can process load and store requests as well as ordering operations. For example, μOPs may relate to memory access (e.g. load and store), and those can be sent on dedicated scheduler ports that can perform those memory operations. Store and load operations, for example, can be sent to load and store buffer(s) 1145. The memory subsystem can also include shared or separate L1 data and instruction cache 1104, as well as L2 cache 1138 that can be used and shared by L1 data and instruction cache 1104. As described above for FIG. 11, each core 1100 can be connected to a slice of a third level of cache that can be shared by all cores 1100.

In at least one embodiment, processor 1100 can include circuitry (e.g., one or more circuits described above and elsewhere herein) to generate, from an input tensor, contraction operands by directly storing the operands in a reordered feature-leading layout and perform a feature-preserving triangular multiplicative update by contraction over an intermediate index or otherwise perform any of the operations described above or elsewhere herein. One or more circuits can be configured by software to generate, from an input tensor, contraction operands by directly storing the operands in a reordered feature-leading layout and perform a feature-preserving triangular multiplicative update by contraction over an intermediate index or otherwise perform any of the operations described above or elsewhere herein.

FIG. 12A illustrates a diagram of an example many-core tiled processor microarchitecture. Many-core tiled processor in FIG. 12A may be configured as a Language Processing Unit (LPU), Tensor Streaming Processor (TSP), or other such processor. As illustrated in FIG. 12A, each “tile” of a processor architecture can be a processing element tied together using a network-on-chip (NoC) that can be used, e.g., to perform some or all of the operations described above or elsewhere herein. For example, each tile may have an instruction dispatch 1204 and an integer (INT) 1206 and floating-point (FP) unit 1208 as well as load-store unit (LSU) 1212 to interface with memory hierarchy (data cache (D$) 1210 and instruction cache (I$) 1214) and network (NET) 1216 interface for communication with other tiles. Some tiles in processor 1200 may include memory controller 1202 for managing and controlling memory, as described further herein. Processor 1200 can have a functional slice architecture. Processor 1200 may be located on an application specific integrated circuit (ASIC), and FIG. 12A may represent a layout of an ASIC. Processor 1200 can include a co-processor that is designed to execute instructions for a predictive model. A predictive model is any model that is configured to make a prediction from input data. A predictive model can use a classifier to make a classification prediction. A predictive model may be a machine learning model such as, but not limited to, a tensor flow model, and processor 1200 is a tensor streaming processor.

Processor 1200 can employ different microarchitectures, which disaggregates functional units shown in each tile in FIG. 12B. The processor 1200 may be characterized by a functional slice architecture, in which the processor 1200 is physically and logically divided into a plurality of functional slices 1230 (e.g., 1230A, 1230B, 1230C, 1230D, . . . , 1230N), each dedicated to a specific computational or storage role. These slices may be arranged in a grid-like tile structure, wherein a first dimension (e.g., the vertical or y-axis 1222) is used for instruction dispatch (e.g., instruction flow 1232), and a second dimension (e.g., the horizontal or x-axis 1224) is used for the streaming of operand data (e.g., data flow).In another embodiment, functional tiles of processor 1200 may be aggregated into a plurality of functional process units 1220 (e.g., 1220A, 1220B, 1220C, . . . , 1220N), each corresponding to a particular function type (e.g., FP/INT 1220A, NET 1220B, MEM 1220C). For example, as illustrated in FIG. 12B, each slice may correspond to a column of functional tiles extending in a north-south direction. In addition, processor 1200 also may include communication lanes to carry data between tiles of different slices, each running horizontally in an east-west direction. Each communication lane may be connected to each of slices 1230 of processor 1200.

Slices 1230 of processor 1200 may each correspond to a different function, and may include arithmetic logic slices (e.g., FP/INT 1220A), lane switching slices (e.g., NET 1220B), and memory slices (e.g., MEM 1220C). Arithmetic logic units may execute one or more arithmetic and/or logic operations on data received via communication lanes to generate output data. Examples of arithmetic logic units may be matrix multiplication units and vector multiplication units. Memory slices include memory cells that store data. Memory slices can provide data to other slices through communication lanes. Memory slices can also receive data from other slices through communication lanes. Lane switching slices can configurably route data from one communication lane to any other communication lane. For example, data from a first lane can be provided to a second lane through a lane switching slice. In some embodiments, a lane switching slice can be implemented as a crossbar switch. Each slice 1230 also includes its own instruction queue (not shown) that stores instructions, and an instruction control unit (ICU) to control execution of instructions. Instructions in a given instruction queue may be executed only by tiles in its associated functional slice and may not be executed by other slice(s) of processor 1200.

By arranging tiles of processor 1200 into different functional slices 1230, on-chip instruction and control flow of processor 1200 can be decoupled from data flow. For example, one arrow in FIG. 12B illustrates flow of instructions within processor architecture, in accordance with some embodiments. Another arrow in FIG. 12B illustrates data flow within processor architecture, in accordance with at least one embodiment. As illustrated, instructions and control flow can flow in a first direction across tiles of processor 1200 (e.g., north-south, along a length of functional slices, as shown by the first arrow), while data flows flow in a second direction across tiles of processor 1200 (e.g., east-west, across functional slices, as shown by the second arrow) that is perpendicular to the first direction.

Different functional slices of processor 1200 may correspond to MEM 1230C (memory), VXM 1230D (vector execution module), MXM 1230A (matrix execution module), NIM (numerical interpretation module), and SXM 1230B (switching and permutation module). Each slice may include N tiles that may all be controlled by a same instruction control unit (ICU). VXM 1230D may be configured to execute pointwise operations, activation functions (e.g., GeLU, SiLU), and other element-wise computations required by machine learning models. MXM 1230A may be configured to perform high-density matrix multiplication operations, such as outer products and convolutions, using systolic arrays or similar dense compute structures. Data Switching Slices may be configured to route data between the functional slices and to external interfaces. Each slice may operate completely independently and can only be coordinated using barrier-like synchronization primitives or through a compiler by exploiting “tractable determinism.” Each tile of processor 1200 can correspond to an execution unit organized as an ×M SIMD tile. For example, each tile of on-chip memory of processor 1200 may be organized to store an L-element vector atomically. As such, a MEM slice having N tiles may work together to store or process a large vector (e.g., having a total of N×M elements).

MXM 1230A can include dedicated matrix-computation logic within a functionally sliced tensor-processing architecture and can be configured to support deterministic, high-throughput execution of machine-learning or other workloads in accordance with any embodiment described herein. MXM 1230A can be implemented as a functional slice within a functionally sliced processor architecture, wherein the MXM 1230A is spatially arranged to receive operand streams and to emit result streams without reliance on register-based load-store semantics. MXM 1230A can be spatially arranged to operate on streamed tensor data rather than register-resident operands. MXM 1230A can be architected to align with a wide-vector, lane-based programming model in which tensors are represented as vectors of more than 320 elements.

In some embodiments, MXM 1230A can be configured to perform matrix multiplication and convolution operations that form computational kernels for deep neural network inference, training or other workloads described above or elsewhere herein. MXM 1230A can consume streams of activation data and streams of weight data, can compute dot products between activations and weights across a plurality of lanes, and can produce accumulated output feature or other vectors. MXM 1230A can support low-precision input formats including but not limited to int8 and fp16, while accumulating results into higher-precision formats such as int32 or fp32, thereby enabling quantized execution and floating-point execution within the same architecture, as described herein. In at least one embodiment, once an MXM 1230A pipeline is filled, MXM 1230A generates a new output vector on each cycle, thereby sustaining high arithmetic utilization consistent with throughput requirements of various devices and/or processing units.

In some embodiments, MXM 1230A can communicate with other processor components through streams implementing a producer-consumer dataflow model. The result streams can be consumed by VXM 1230D for post-processing operations, forwarded for data rearrangement, written to memory slices, or transmitted to chip-to-chip interfaces. VXM 1230D can consume this without reliance on caches, interrupts, or dynamic arbitration thereby enabling predictable performance and chained execution pipelines characteristic of processing units (e.g., embodiments in FIGS. 9-12B).

SXM 1230B can include dedicated stream-switching, lane-shifting, and permutation logic within a functionally sliced tensor-processing architecture and can be configured to provide data movement for machine-learning or other tensor workloads in accordance with any embodiment described herein. SXM 1230B can be implemented as a functional slice within a functionally sliced processor architecture, wherein the SXM 1230B is spatially arranged to operate on architecturally-visible streams and to move vector elements without reliance on register based load store semantics. In some embodiments, SXM 1230B can be arranged to effect inter-lane movement of streamed tensor data across a wide-vector, lane-based programming model and can cooperate with memory slices to route stream data deterministically in two dimensions of an on-chip network.

In some embodiments, SXM 1230B can be configured to perform lane-shift operations and programmable permutations that implement tensor reshape, alignment, padding, and layout transforms. SXM 1230B can further include a permuter configured to apply a programmed bijection mapping for correspondingly indexed streams, thereby enabling arbitrary lane remapping across the full vector width while preserving predictable timing and avoiding dynamic arbitration.

In some embodiments, SXM 1230B can be coupled between memory slices 1230C as part of an on-chip network that routes streamed operands and results deterministically in two dimensions. As described herein, horizontally propagating streams can traverse the X-dimension via the MEM 1230C slice stream-register interfaces, while SXM 1230B can provide the Y-dimension movement by shifting and permuting elements across lanes, thereby enabling inter-lane communication without packet routing, arbitration, or caches. SXM 1230B can receive one or more incoming streams and can emit correspondingly indexed streams after permutation, transposition, distribution, and/or rotation, such that downstream slices can consume the transformed stream values in a producer-consumer chain. In at least one embodiment, SXM 1230B can be instantiated in each hemisphere of the processor adjacent to corresponding MEM 1230C resources, enabling concurrent transpose/permutation operations while instruction control units (ICUs) 1236 dispatch temporally-scheduled operations so that SXM-produced streams intersect deterministically with consumer operations in VXM 1230D and/or MXM 1230A.

VXM 1230D can include dedicated vector-execution logic within a functionally sliced, tensor-streaming processor architecture and can be configured to perform operations on streamed vector data in accordance with any embodiment described herein. VXM 1230D can be implemented as a functional slice spatially interposed between memory slices and other arithmetic slices, and can be arranged to consume operand streams and emit result streams without reliance on register-resident operands, condition codes, or load/store semantics. In some embodiments, VXM 1230D can operate on vectors represented as parallel lanes, each lane corresponding to an element of a tensor, and can align with a wide-vector programming model supporting scalable vector, as described herein.

In some embodiments, each lane of VXM 1230D can comprise a mesh of vector arithmetic logic units (ALUs) 1238 configured to execute operations on streamed operands, comprising unary operations, binary operations, type conversions, and activation functions. VXM 1230D can support fixed-point and floating-point numerics, comprising int8, int16, int32, fp16, and fp32 formats, and can provide saturating or modular arithmetic semantics to enable predictable handling of overflow and quantization behavior. Instruction execution can be carried out over several stages: (1) instruction fetch (IF), (2) instruction decode (ID), (3) execution on ALUs (EX), (4) memory access (MEM), and (5) writeback (WB) to update the results in the general-purpose registers (GPRs).

The processor 1200 may use a specialized, high-performance instruction pipeline (e.g., integer ALU instruction pipeline 1238) that is designed for deterministic execution, where the software/compiler pre-schedules every operation to avoid bottlenecks. The pipeline 1238 may include an instruction fetch (IF) stage 1252, an instruction decode (ID) stage 1254, an operand dispatch/decode (OD) stage 1256, one or more execution (EX) stages (e.g., a first execution stage 1258 and a second execution stage 1260), and a write back (WB) stage 1262. For example, the pipeline 1238 may include an instruction fetch (IF) stage 1252 where the processor 1200 may fetch the next instruction from the instruction queue/instructions memory, typically the on-chip SRAM, to be processed. The pipeline 1238 may include an instruction decode (ID) stage 1254 where the processor 1200 decodes opcode and operands, selects source/destination streaming registers, and prepares control signals. The pipeline 1238 may include an operand dispatch/decode (OD) stage 1256 where the processor 1200 may access and align the operand streams for this slice, and handle any local muxing/steering from the streaming register file into the VXM slice 1230D. The pipeline 1238 may include one or more execute (EX) stages—e.g., a first execute stage 1258 and a second execute stage 1260. The first execute stage 1258, for example, may include handling parts of the tensor arithmetic or data reshaping, while the second execute stage 1260, for example, may allow for the processor 1200 to handle more complex operations—such as matrix operations (e.g., using the MXMs), vector processing (e.g., using the VXMs), etc. —in a pipelined fashion. As an example, the first execution stage 1258 may perform lower-latency integer operations or a first half of a multi-cycle integer operation while the second execution stage 1260 may complete the integer operation and produce a final result value. The pipeline 1238 may include a write back (WB) stage 1262 where the compiled result (e.g., activation) is written back to the appropriate stream/register (e.g., to on-chip SRAM) so it can continue flowing across slices 1230. As such, the pipeline 1238 may effectively use a six-stage realization of the IF/ID/EX/MEM/WB pattern, with OD as an explicit operand stage, EX split into two back-to-back execution stages, and no separate MEM stage because the VXM slice 1230D (e.g., INT ALU path) doesn't perform memory access itself.

The processor 1200 may use a memory (load/store) instruction pipeline 1240 that includes an instruction fetch (IF) stage 1266, an instruction decode (ID) stage 1268, an operand decode/dispatch (OD) stage 1270, one or more memory stages (e.g., first memory stage 1272 and second memory stage 1274), and a write back (WB) stage 1276. The pipeline 1240 may include an instruction fetch (IF) stage 1266 where an instruction control unit (ICU) 1236 fetches the memory instruction (e.g., READ a,s, WRITE a,s, GATHER, SCATTER, etc., where “a” is the memory or base address and “s” is the destination stream ID) from the appropriate instruction queue. In the instruction decode (ID) stage 1268 the instruction may be decoded to determine an operation type (e.g., load, store, gather, scatter), base address/map stream, destination/source stream IDs, and control bits (e.g., stride, count, delays, etc.). The operand decode/dispatch (OD) stage 1270 may include the LSU/DS logic preparing operands—e.g., by selecting the correct address stream or immediate address, applying configured stride or iteration count, and aligning the target source/destination stream in the streaming register file. The first memory stage 1272 may generate physical RAM addresses from the logical address operands, including any loop/stride logic for multi-element tensors. The first memory stage 1272 may also resolve which memory slice 1220C, bank, and timing group will service each access, given the partitioned on-chip SRAM (e.g., 88 MEM slices across hemispheres). The second memory stage 1274 may perform the actual SRAM read or write in the targeted memory slice(s) 1230C. As an example, for loads, the processor 1200 may pull a 320-byte vector from SRAM and launch it as a physical stream on the appropriate logical stream ID, and for stores, the processor 1200 may consume a stream and writes its contents into SRAM addresses (including indirect/gather-scatter cases). The write back (WB) stage 1276 finalizes the operation at the streaming-register level—e.g., marking the destination stream as having new data (for loads/gathers) or completing the lifetime of a source stream once its data has been stored (for stores/scatters). From the programmer's view, this can be where the tensor “appears” on the target stream or is durably written back to on-chip global SRAM, ready for subsequent VXM/MXM/SXM instructions.

In some embodiments, VXM 1230D can consume operand streams sourced directly from MEM slices or produced by upstream MXM slices, with instructions dispatched from instruction control units (ICUs) 1236 such that vertically flowing instruction parcels intersect horizontally flowing data streams at precise, compiler-scheduled cycles. Results produced by VXM 1230D can be emitted onto eastward or westward streams and forwarded without intermediate storage to downstream functional slices, including SXM 1230B slices for lane permutation, transposition, or redistribution, or MEM 1230C slices for commitment to on-chip SRAM.

Instruction control units (ICUs) 1236 can be configured to provide deterministic instruction fetch, sequencing, and dispatch for a functionally sliced tensor-streaming processor architecture. The ICU 1236 can include a per-slice controller that fetches, decodes, and schedules instructions (VXM, MXM, MEM, SXM, etc.) and handles barriers and synchronization. In embodiments, each functional slice may have its own ICU, which fetches instructions from local SRAM into an instruction queue and issues them down the slice in a staggered fashion. The ICUs 1236 perform instruction fetch, decode, and parceling, while the tiles handle operand read, execute, and write back, which cleanly separates the instruction control from the data flow execution. The ICUs 1236 support control instructions such as IFETCH, NOP, SYNC, and NOTIFY, enabling barrier-style synchronization and waking/sleeping of the independent ICUs 1236 on chip so slices can coordinate without complex dynamic scheduling hardware.

In some embodiments, ICUs 1236 can be spatially separated from execution logic and can be architected such that instruction fetch, decode, and parceling are centralized while operand execution occurs in downstream functional slices. In some embodiments, ICUs 1236 can manage a plurality of independent instruction queues, each corresponding to a functional slice or slice row, thereby enabling single-instruction, multiple-data (SIMD) execution across vertically stacked tiles without reliance on dynamic scheduling, branch prediction, or speculative execution. Instruction streams can flow in a predetermined direction to intersect with horizontally flowing operand streams, enabling precise temporal and spatial coordination of instruction execution.

Tiles in a slice may execute instructions in a “staggered” fashion where instructions may be issued tile-by-tile within a slice over a period of N cycles. Functional slices may be arranged physically on-chip to allow efficient data-flow for pipelined execution across hundreds of cycles for common patterns. Data flows can perform a single “u-turn” (change in direction) corresponding to a single matrix operation before being written back to memory, in some embodiments, a particular data flow may change direction multiple times (due to multiple matrix and vector operations) before resulting data is written back into memory.

When using processor 1200 (e.g., TSP) having a functional slice architecture, TSP compiler (not shown) generates an explicit plan for how processor 1200 can execute a program (e.g., a microprogram). Compiler can specify when each operation will be executed, which functional slices will perform work, and which STREAM registers hold operands. Compiler can maintain a high-fidelity (cycle accurate) model of processor 1200 (e.g., TSP) hardware state so a microprogram can orchestrate data flow.

Processor 1200 (e.g., TSP) can use a Web-hosted compiler that takes as its input a model (e.g., a ML model such as, but not limited to, a TensorFlow model) and emits a proprietary instruction stream targeting processor 1200 (e.g., TSP). Compiler, in at least one embodiment, is responsible for coordinating control and data flow of a program, and specifies any instruction-level parallelism by explicitly bundling instructions that can and should execute concurrently so that they may be dispatched together. Primary hardware structure includes an architecturally-visible streaming register file (STREAMs), described in greater detail below, which serves as a conduit through which operands flow from MEM slices (e.g., SRAM) to functional slices and vice versa.

MEM 1220C or MEM 1230C of processor 1200 can serve as: (1) storage for model parameters, microprograms and data on which they operate, and (2) network-on-chip (NoC) for communicating data operands from MEM to functional slices and computed results back to MEM. In some embodiments, on-chip memory can consumes ≈75% of chip area of processor 1200. In some embodiments, due to bandwidth requirements of processor 1200, on-chip memory of MEM tiles may include SRAM, and not DRAM. On-chip memory capacity of processor 1200 can determine (i) number of ML models that can simultaneously reside on-chip, (ii) size of any given model, and (iii) partitioning of large models to fit into multi-chip systems. In some embodiments, MEM system of processor 1200 can provide a plurality of memory slices organized into two different hemispheres (referred to as “MEM WEST” and “MEM EAST”, respectively).

Memory slices of each hemisphere may be mirrored, such that slices may be physically numbered {0, . . . L} in an East hemisphere, and {L, . . . 0} in a West hemisphere, such that memory slice 0 for each hemisphere corresponds to a slice closest to VXM slices between hemispheres, where each hemisphere comprises L slices. Direction of data transfer towards the center of a chip may be referred to as inwards, while data transfer toward the outer (Eastern or Western most) edge of a chip may be referred to as outwards. Although hemispheres of memory of processor 1200 may be referred to as east and west, it is understood that in other embodiments, other names may be used to refer to different hemispheres of memory.

In various embodiments, the processor 1200 may implement a flat memory hierarchy using on-chip global SRAM (comprised of the memory slices 1230C). To facilitate the continuous flow of data required for model (e.g., large language model (LLM), vision-language-action (VLA) model, multi-modal model, other types of model) inference, the processor 1200 may further comprise a plurality of streaming register files. These registers are configured to buffer and track the state of active tensors as they traverse the data transport lanes. The compiler allocates these registers in both space (specific physical locations) and time (specific clock cycles), allowing for the concurrent execution of memory operations and arithmetic computations without resource contention. Because the latency of the transport lanes and the execution units can be fixed and known at compile time, the processor ensures a predetermined temporal relationship between the arrival of an instruction at a functional unit and the arrival of the corresponding operand data. This configuration eliminates the need for runtime hardware arbitration, flow control signals, or data metadata (headers), thereby maximizing the silicon area and power budget available for arithmetic operations.

The intersection of an instruction stream and a data stream at a specific tile triggers an operation. Because the latency of the transport lanes can be fixed, the compiler can predict exactly where a piece of data will be at any given clock cycle (t). This eliminates the need for hardware “handshaking” or “ready” signals, as the data is guaranteed to be present when the instruction issues.

To accommodate workloads exceeding the capacity of a single processor 1200, such as trillion-parameter language models, the system employs a multi-processor system having a plesiochronous timing architecture where independent clocks are nominally the same frequency but may have slight phase drifts. In this configuration, a plurality of processors 1200 are interconnected via a direct-attached network (e.g., a Dragonfly topology) that does not require external switching hardware.

The system can be configured to synchronize the clock phases of the interconnected processors, establishing a global time base. This global synchronization permits the compiler to schedule data transfers across the inter-chip links with the same deterministic precision as intra-chip transfers. Consequently, a cluster of such processors 1200 can function as a single, logical synchronous compute fabric, where the latency of communication between any two nodes can be fixed and deterministic. This architecture significantly reduces tail latency and enables linear performance scaling for distributed tensor computations.

With respect to any processors in FIG. 12 and any components described above or elsewhere herein, one or more of APIs or equivalents described herein can, for example, get compiled into instructions or equivalents, which may be fetched by instruction fetch logic or equivalents, decoded by a processor decoder or equivalents, scheduled (e.g., in order or out of order) for execution by a scheduler or equivalents, executed by execution logic or equivalents, reordered, and then retired by retirement logic or equivalents. API(s) (and/or compiled instructions including API(s)) can be stored in any storage outside or inside of processor 1200 (e.g., in cache and/or memory). A result of API(s) can then be stored in storage within or outside of processor 1200, including registers, DRAM, flash, SRAM, cache, or other memory equivalents.

In some embodiments, the processor employs a software-defined deterministic execution model. The processor architecture may not contain any reactive hardware control structures—such as dynamic branch predictors, speculative execution logic, reorder buffers, and hardware-managed cache controllers—that introduce non-deterministic latency in conventional processors. Instead, the execution of the processor can be controlled by a compiler-generated schedule that explicitly defines the state of the processor at every clock cycle.

In at least one embodiment, processor 1200 can include circuitry (e.g., one or more circuits described above and elsewhere herein) to generate, from an input tensor, contraction operands by directly storing the operands in a reordered feature-leading layout and perform a feature-preserving triangular multiplicative update by contraction over an intermediate index or otherwise perform any of the operations described above or elsewhere herein. One or more circuits can be configured by software to generate, from an input tensor, contraction operands by directly storing the operands in a reordered feature-leading layout and perform a feature-preserving triangular multiplicative update by contraction over an intermediate index or otherwise perform any of the operations described above or elsewhere herein.

### Software Constructions

The following figures set forth, without limitation, examples of software constructs for implementing at least one embodiment.

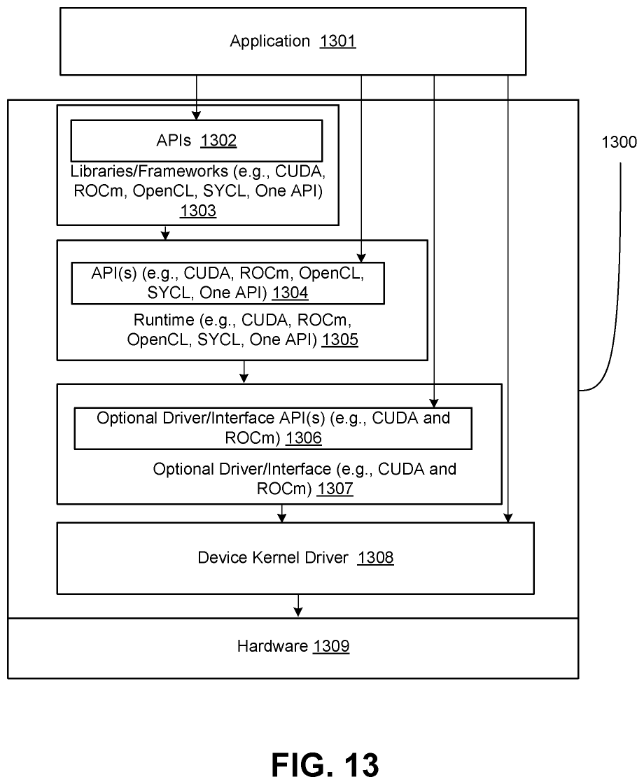

FIG. 13 illustrates a software stack of a programming platform, in accordance with at least one embodiment. A programming platform can include a platform for leveraging hardware on a computing system to accelerate computational tasks. A programming platform may be accessible to software developers through libraries, compiler directives, and/or extensions to programming languages, in at least one embodiment. A programming platform may be CUDA, Radeon Open Compute Platform (“ROCm”), OpenCL (OpenCL™ is developed by Khronos group), SYCL, Intel oneAPI, or another platform.

A software stack 1300 of a programming platform can provide an execution environment for an application 1301. Application 1301 may include any computer software capable of being launched on software stack 1300. Application 1301 may include an artificial intelligence (“AI”)/machine learning (“ML”) application, a high performance computing (“HPC”) application, a virtual desktop infrastructure (“VDI”), or a data center workload.

Application 1301 and software stack 1300 run on hardware 1308. Hardware 1308 may include one or more GPUs, CPUs, LPUs, FPGAs, AI engines, and/or other types of compute devices that support a programming platform. Software stack 1300 may be vendor specific and compatible with only devices from particular vendor(s), such as CUDA, ROCm, OneAPI, OpenCL, or other implementations. Hardware 1308 can include a host connected to one more devices that can be accessed to perform computational tasks via application programming interface (“API”) calls. A device within hardware 1308 may include hardware described in FIGS. 9-12B. API(s) (and/or compiled instructions including API(s)) can be stored in any storage outside or inside of hardware 1308 (e.g., in cache and/or memory). A result of API(s) can then be stored in storage within or outside of hardware 1308, including registers, DRAM, flash, SRAM, cache, or other memory. One or more of APIs described herein can receive a call. One or more of APIs described herein can communicate with a library or a portion of a library to perform a function described by the call. One or more of APIs described herein can receive a call and communicate with a library or portion of a library to perform a function described by the call.

Software stack 1300 of a programming platform can include a number of libraries 1303, a runtime 1305, an optional driver/interface 1307, and a device kernel driver 1308. Each of libraries 1303 may include data and programming code that can be used by computer programs and leveraged during software development. Libraries 1303 may include pre-written code and subroutines, classes, values, type specifications, configuration data, documentation, help data, and/or message templates. Libraries 1303 can include functions that may be optimized for execution on one or more types of devices. Libraries 1303 may include functions for performing mathematical, deep learning, and/or other types of operations on devices. Libraries 1303 can be associated with corresponding APIs 1302, which may include one or more APIs, that expose functions implemented in libraries 1303. A processor (e.g. CPU, GPU) may perform, call, or otherwise use one or more APIs to prioritize kernels. For example, a first kernel (e.g., parent) can launch a second kernel (e.g., child kernel), and said second kernel can be used by a processor to launch additional kernels (e.g., grandchildren kernels) independent of said first kernel. A processor may perform an API or calls an API from memory to be performed to support dynamic stream priority (e.g., updating priority while a stream is being used to perform operations). For example, when a processor performs said API, it allows a programmer to copy stream priority from one stream to one or more other streams.

Software stack 1300 may include one or more APIs to associate one or more instructions with one or more memory ordering operations, such as, but not limited to, a fence or membar operation. Instructions can be associated with one or more domains such that a memory ordering operation is executed in association to one or more particular domains without interfering with instructions of other domains. An API can indicate a thread has arrived (e.g., at a thread synchronization barrier), or finished a stage of work in relation to asynchronous data movement operations on a GPU. Software stack 1300 may include one or more to allow programmers to manually indicate an expected transaction count when a thread has finished a stage of work, which can be used to update an object that tracks whether all data movement operations for a set of threads may be complete.

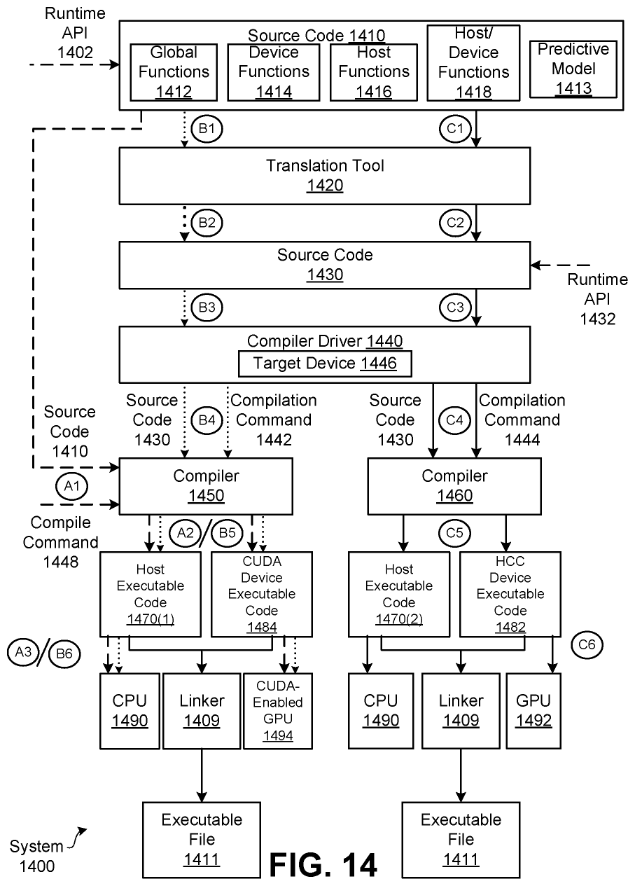

Application 1301 can be written as source code that is compiled into executable code, as discussed in greater detail below in conjunction with FIG. 14. Executable code of application 1301 may run, at least in part, on an execution environment provided by software stack 1300. During execution of application 1301, code may be reached that needs to run on a device, as opposed to a host. In such a case, runtime 1305 may be called to load and launch requisite code on a device. Runtime 1305 may include any technically feasible runtime system that is able to support execution of application 1301.

Runtime 1305 can be implemented as one or more runtime libraries associated with corresponding APIs, which are shown as API(s) 1304. One or more of such runtime libraries may include functions for memory management, execution control, device management, error handling, and/or synchronization, among other things. Memory management functions may include functions to allocate, deallocate, and copy device memory, as well as transfer data between host memory and device memory. Execution control functions may include functions to launch a function (sometimes referred to as a “kernel” when a function can be a global function callable from a host) on a device and set attribute values in a buffer maintained by a runtime library for a given function to be executed on a device.

Runtime libraries and corresponding API(s) 1304 may be implemented in any technically feasible manner. One (or any number of) API may expose a low-level set of functions for fine-grained control of a device, while another (or any number of) API may expose a higher-level set of such functions. A high-level runtime API may be built on top of a low-level API. One or more of runtime APIs may be language-specific APIs that may be layered on top of a language-independent runtime API.

An optional driver or interface 1307 may be implemented, e.g., for CUDA and ROCm implementations, that are described further below. Optional driver/interface 1307 may be associated with optional driver or interface API(s), such as, but not limited to, CUDA and/or ROCm API(s).

One or more processors disclosed in “processing systems” can perform, access, or otherwise use software stack 1300. For example, supercomputer 800, system-on-a-chip 900, parallel processor 1000, graphics multiprocessor 1034, processor 1100, processor 1200, accelerator 1000, neuromorphic processor 901, accelerated processing unit 924, tensor processing unit 1000, and language processing unit 1200 can perform, use, call, or otherwise implement (e.g., through accessing a memory) one or more APIs included in software stack 1300.

Device kernel driver 1308 can be configured to facilitate communication with an underlying device. Device kernel driver 1308 may provide low-level functionalities upon which APIs, such as, but not limited to, API(s) 1304, and/or other software relies. Device kernel driver 1308 may be configured to compile intermediate representation (“IR”) code into binary code at runtime. For CUDA or other implementations such as, but not limited to, ROCm, OneAPI, or OpenCL, device kernel driver 1308 may compile Parallel Thread Execution (“PTX”) IR code that is not hardware specific into binary code for a specific target device at runtime (with caching of compiled binary code), which is also sometimes referred to as “finalizing” code. Doing so may permit finalized code to run on a target device, which may not have existed when source code was originally compiled into PTX code. Alternatively, device source code may be compiled into binary code offline, without requiring device kernel driver 1308 to compile IR code at runtime.

Processors described elsewhere herein, such as, but not limited to, processors in FIGS. 9-12B can include circuitry (e.g., one or more circuits described above and elsewhere herein) to generate, from an input tensor, contraction operands by directly storing the operands in a reordered feature-leading layout and perform a feature-preserving triangular multiplicative update by contraction over an intermediate index or otherwise perform any of the operations described above or elsewhere herein. One or more circuits can be configured by software, e.g., software stack 1300 to generate, from an input tensor, contraction operands by directly storing the operands in a reordered feature-leading layout and perform a feature-preserving triangular multiplicative update by contraction over an intermediate index or otherwise perform any of the operations described above or elsewhere herein.

In accordance with at least one embodiment, software stack 1300 of FIG. 13 can be performed in a CUDA implementation. A CUDA software stack 1300, on which an application 1301 may be launched, may include CUDA libraries 1303, a CUDA runtime 1305, a CUDA driver 1307, and a device kernel driver 1308. CUDA software stack 1300 can execute on hardware (e.g., graphics multiprocessor 1034) that may include a GPU that supports CUDA and is developed by NVIDIA Corporation of Santa Clara, CA.

In accordance with at least one embodiment, software stack 1300 of FIG. 13 can be performed in a ROCm implementation. A ROCm software stack 1300, on which an application 1301 may be launched, includes a language runtime 1303, a system runtime 1305, a thunk 1307, and a ROCm kernel driver 1308. ROCm software stack 1300 executes on hardware 1309, which may include a GPU that supports ROCm and is developed by AMD Corporation of Santa Clara, CA.

Application 1301 may perform similar functionalities as discussed above in conjunction with FIG. 13. In addition, language runtime 1303 and system runtime 1305 may perform similar functionalities as runtime 1305 discussed above in conjunction with FIG. 13. Language runtime 1303 and system runtime 1305 may differ in that system runtime 1305 is a language-independent runtime that implements a ROCr system runtime API 1304 and makes use of a Heterogeneous System Architecture (“HSA”) Runtime API. HSA runtime API can include a thin, user-mode API that exposes interfaces to access and interact with an AMD GPU, including functions for memory management, execution control via architected dispatch of kernels, error handling, system and agent information, and runtime initialization and shutdown, among other things. In contrast to system runtime 1305, language runtime 1303 can be an implementation of a language-specific runtime API 1302 layered on top of ROCr system runtime API 1304. Language runtime API may include a Heterogeneous compute Interface for Portability (“HIP”) language runtime API, a Heterogeneous Compute Compiler (“HCC”) language runtime API, or an OpenCL API, among others. HIP language in particular is an extension of C++ programming language with functionally similar versions of CUDA mechanisms, and a HIP language runtime API may include functions that may be similar to those of CUDA runtime API discussed above in conjunction with FIG. 13, such as, but not limited to, functions for memory management, execution control, device management, error handling, and synchronization, among other things.

Thunk (ROCt) 1307 can be an interface 1306 that can be used to interact with underlying ROCm driver 1308. ROCm driver 1308 can be a ROCk driver, which is a combination of an AMDGPU driver and a HSA kernel driver (amdkfd). AMDGPU driver can be a device kernel driver for GPUs developed by AMD that performs similar functionalities as device kernel driver 1308 discussed above in conjunction with FIG. 13. HSA kernel driver can be a driver permitting different types of processors to share system resources more effectively via hardware features.

Various libraries (not shown) may be included in ROCm software stack 1300 above language runtime 1303 and provide functionality similar to CUDA libraries 1303, discussed above in conjunction with FIG. 13. Various libraries may include mathematical, deep learning, and/or other libraries such as, but not limited to, a hipBLAS library that implements functions similar to those of CUDA cuBLAS, a rocFFT library for computing FFTs that is similar to CUDA cuFFT, among others.

Processors described elsewhere herein, such as, but not limited to, processors in FIGS. 9-12B can include circuitry (e.g., one or more circuits described above and elsewhere herein) to generate, from an input tensor, contraction operands by directly storing the operands in a reordered feature-leading layout and perform a feature-preserving triangular multiplicative update by contraction over an intermediate index or otherwise perform any of the operations described above or elsewhere herein. One or more circuits can be configured by software, e.g., software stack 1300 to generate, from an input tensor, contraction operands by directly storing the operands in a reordered feature-leading layout and perform a feature-preserving triangular multiplicative update by contraction over an intermediate index or otherwise perform any of the operations described above or elsewhere herein.

In accordance with at least one embodiment, software stack 1300 of FIG. 13 can be performed in an OpenCL implementation. An OpenCL software stack 1300, on which an application 1301 may be launched, can include an OpenCL framework 1303, an OpenCL runtime 1305, and a driver 1308. OpenCL software stack 1300 may execute on hardware 1309 that is not vendor-specific. As OpenCL is supported by devices developed by different vendors, specific OpenCL drivers may be required to interoperate with hardware from such vendors.

Application 1301, OpenCL runtime 1305, device kernel driver 1308, and hardware 1309 may perform similar functionalities as other implementations of application 1301, runtime 1305, device kernel driver 1308, and hardware 1309, respectively, that are discussed above in conjunction with FIG. 13. Application 1301 can further include an OpenCL kernel (not shown) with code that is to be executed on a device.

OpenCL may define a “platform” that allows a host to control devices connected to a host. An OpenCL framework can provide a platform layer API and a runtime API, shown as platform API 1302 and runtime API 1304. Runtime API 1304 can use contexts to manage execution of kernels on devices. Each identified device may be associated with a respective context, which runtime API 1304 may use to manage command queues, program objects, and kernel objects, share memory objects, among other things, for that device. Platform API 1302 can expose functions that permit device contexts to be used to select and initialize devices, submit work to devices via command queues, and enable data transfer to and from devices, among other things. In addition, OpenCL framework can provide various built-in functions (not shown), including math functions, relational functions, and image processing functions, among others.

In accordance with at least one embodiment, software can be supported by a programming platform that is configured to support various programming models, middlewares and/or libraries, and frameworks that an application may rely upon. Application may be an AI/ML application implemented using, for example, a deep learning framework such as, but not limited to, MXNet, PyTorch, or TensorFlow, which may rely on libraries such as, but not limited to, cuDNN, NVIDIA Collective Communications Library (“NCCL”), and/or NVIDA Developer Data Loading Library (“DALI”) CUDA libraries to provide accelerated computing on underlying hardware.

Programming platform may be one of a CUDA, ROCm, or OpenCL platform described above in conjunction with FIG. 13. Programming platform can support multiple programming models, which may be abstractions of an underlying computing system permitting expressions of algorithms and data structures. Programming models may expose features of underlying hardware in order to improve performance. Programming models may include CUDA, HIP, OpenCL, C++ Accelerated Massive Parallelism (“C++ AMP”), Open Multi-Processing (“OpenMP”), Open Accelerators (“OpenACC”), and/or Vulkan Compute.

Libraries and/or middlewares may provide implementations of abstractions of programming models. Such libraries can include data and programming code that may be used by computer programs and leveraged during software development. Such middlewares can include software that provides services to applications beyond those available from programming platform. Libraries and/or middlewares may include cuBLAS, cuFFT, cuRAND, and other CUDA libraries, or rocBLAS, rocFFT, rocRAND, and other ROCm libraries. In addition, libraries and/or middlewares may include NCCL and ROCm Communication Collectives Library (“RCCL”) libraries providing communication routines for GPUs, a MIOpen library for deep learning acceleration, and/or an Eigen library for linear algebra, matrix and vector operations, geometrical transformations, numerical solvers, and related algorithms.

Application frameworks may depend on libraries and/or middlewares. Each of application frameworks can be a software framework used to implement a standard structure of application software. Returning to the AI/ML example discussed above, an AI/ML application may be implemented using a framework such as, but not limited to, Caffe, Caffe2, TensorFlow, Keras, PyTorch, or MxNet deep learning frameworks, for example.

In at least one embodiment, processors described elsewhere herein, such as, but not limited to, processors in FIGS. 9-12B can include circuitry (e.g., one or more circuits described above and elsewhere herein) to generate, from an input tensor, contraction operands by directly storing the operands in a reordered feature-leading layout and perform a feature-preserving triangular multiplicative update by contraction over an intermediate index or otherwise perform any of the operations described above or elsewhere herein. One or more circuits can be configured by software, e.g., programming platforms described herein, to generate, from an input tensor, contraction operands by directly storing the operands in a reordered feature-leading layout and perform a feature-preserving triangular multiplicative update by contraction over an intermediate index or otherwise perform any of the operations described above or elsewhere herein.

FIG. 14 illustrates a system 1400 configured to compile and execute source code 1410 using different types of processing units, in accordance with at least one embodiment. System 1400 includes first source code 1410 (e.g., CUDA source code), a first compiler 1450 (e.g., a CUDA compiler), first host executable code 1470(1), first device executable code 1484 (e.g., CUDA device executable code), a CPU 1490, a CUDA-enabled GPU 1494, a GPU 1492, a translation tool 1420 (e.g., a CUDA to HIP translation tool), second source code 1430 (e.g., HIP source code), a compiler driver 1440 (e.g., a HIP compiler driver), a second compiler 1460 (e.g., an HCC), second host executable code 1470(2), and second device executable code 1482 (e.g., HCC device executable code).

First source code 1410 may be a collection of human-readable code in a CUDA programming language. A CUDA programming language can be an extension of the C++ programming language that includes mechanisms to define device code and distinguish between device code and host code. Device code can include source code that, after compilation, is executable in parallel on a device. A device may be a processor that is optimized for parallel instruction processing, such as, but not limited to, CUDA-enabled GPU 1494, GPU 1492, or another GPGPU, etc. Host code can be source code that, after compilation, is executable on a host. A host can be a processor that is optimized for sequential instruction processing, such as, but not limited to, CPU 1490.

First source code 1410 can include any number (including zero) of global functions 1412, any number (including zero) of device functions 1414, any number (including zero) of host functions 1416, and any number (including zero) of host/device functions 1418. Global functions 1412, device functions 1414, host functions 1416, and host/device functions 1418 may be mixed in first source code 1410. Each of global functions 1412 may be executable on a device and callable from a host. One or more of global functions 1412 may therefore act as entry points to a device. Each of global functions 1412 can be a kernel. In a technique known as dynamic parallelism, one or more of global functions 1412 can define a kernel that is executable on a device and callable from such a device. A kernel can be executed N (where N is any positive integer) times in parallel by N different threads on a device during execution. First source code 1410 can include instructions for a predictive model, such as a predictive model described elsewhere herein.

Each of device functions 1414 can be executed on a device and callable from such a device only. Each of host functions 1416 can be executed on a host and callable from such a host only. Each of host/device functions 1418 may define both a host version of a function that is executable on a host and callable from such a host only and a device version of the function that is executable on a device and callable from such a device only.

First source code 1410 may also include any number of calls to any number of functions that may be defined via a first runtime API 1402 (e.g., a CUDA runtime API). First runtime API 1402 may include any number of functions that execute on a host to allocate and deallocate device memory, transfer data between host memory and device memory, manage systems with multiple devices, etc. First source code 1410 may also include any number of calls to any number of functions that may be specified in any number of CUDA APIs. A CUDA API may be any API that is designed for use by CUDA code. CUDA APIs can include first runtime API 1402, a CUDA driver API, APIs for any number of CUDA libraries, etc., including any API(s) described elsewhere herein. Relative to first runtime API 1402, a CUDA driver API can be a lower-level API but can provide finer-grained control of a device. Examples of CUDA libraries include cuBLAS, cuFFT, cuRAND, cuDNN, etc.

First compiler 1450 may compile input CUDA code (e.g., first source code 1410) to generate first host executable code 1470(1) and first device executable code 1484. First compiler 1450 may be, but is not limited to, NVCC. First host executable code 1470(1) can be a compiled version of host code included in input source code that is executable on CPU 1490. CPU 1490 may be any processor that is optimized for sequential instruction processing.

First device executable code 1484 may be a compiled version of device code included in input source code that is executable on CUDA-enabled GPU 1494. First device executable code 1484 may include binary code. First device executable code 1484 can include IR code, such as, but not limited to, PTX code, that is further compiled at runtime into binary code for a specific target device (e.g., CUDA-enabled GPU 1494) by a device driver. CUDA-enabled GPU 1494 may include any processor that is optimized for parallel instruction processing and that supports CUDA. CUDA-enabled GPU 1494 may be developed by NVIDIA Corporation of Santa Clara, CA.

Translation tool 1420 can be configured to translate First source code 1410 to functionally similar second source code 1430. Second source code 1430 may include a collection of human-readable code in a HIP programming language. A HIP programming language can include an extension of the C++ programming language that includes functionally similar versions of CUDA mechanisms to define device code and distinguish between device code and host code. A HIP programming language may include a subset of functionality of a CUDA programming language. For example, a HIP programming language includes mechanism(s) to define global functions 1412, but such a HIP programming language may lack support for dynamic parallelism and therefore global functions 1412 defined in HIP code may be callable from a host only.

Second source code 1430 may include any number (including zero) of global functions 1412, any number (including zero) of device functions 1414, any number (including zero) of host functions 1416, and any number (including zero) of host/device functions 1418. Second source code 1430 may include at least a portion of predictive model 1413. Second source code 1430 may also include any number of calls to any number of functions that may be specified in a second runtime API 1432 (e.g., a HIP runtime API). Second runtime API 1432 may include functionally similar versions of a subset of functions included in first runtime API 1402. Second source code 1430 may also include any number of calls to any number of functions that may be specified in any number of HIP APIs. A HIP API may be any API that is designed for use by HIP code and/or ROCm. HIP APIs may include second runtime API 1432, a HIP driver API, APIs for any number of HIP libraries, APIs for any number of ROCm libraries, etc.

A translation tool 1420 can convert each kernel call in CUDA code from a CUDA syntax to a HIP syntax and can convert any number of other CUDA calls in CUDA code to any number of other functionally similar HIP calls. A CUDA call can include a call to a function specified in a CUDA API, and a HIP call can include a call to a function specified in a HIP API. Translation tool 1420 may convert any number of calls to functions specified in runtime API 1402 to any number of calls to functions specified in second runtime API 1432.

Translation tool 1420 can include a tool known as hipify-perl that executes a text-based translation process. Translation tool 1420 can include a tool known as hipify-clang that, relative to hipify-perl, executes a more complex and more robust translation process that involves parsing CUDA code using clang (a compiler front-end) and then translating resulting symbols. Converting CUDA code to HIP code may include modifications (e.g., manual edits) in addition to those performed by translation tool 1420.

Compiler driver 1440 can include a front end that determines a target device 1446 and then configures a compiler that is compatible with target device 1446 to compile second source code 1430 (e.g., generated via translation of first source code 1410 by translation tool 1420). Target device 1446 can include a processor that is optimized for parallel instruction processing. Compiler driver 1440 may determine target device 1446 in any technically feasible fashion.

If target device 1446 is compatible with CUDA (e.g., CUDA-enabled GPU 1494), then compiler driver 1440 can generate a first compilation command 1442 (e.g., a HIP/NVCC compilation command). First compilation command 1442 can configure first compiler 1450 to compile second source code 1430 using a HIP to CUDA translation header and a CUDA runtime library. In response to first compilation command 1442, first compiler 1450 may generate first host executable code 1470(1) and first device executable code 1484.

If target device 1446 is not compatible with CUDA, then compiler driver 1440 may generate a second compilation command 1444 (e.g., a HIP/HCC compilation command). Second compilation command 1444 can configure second compiler 1460 to compile second source code 1430 using an HCC header and a HIP/HCC runtime library. In response to second compilation command 1444, second compiler 1460 may generate second host executable code 1470(2) and second device executable code 1482. Second device executable code 1482 may be a compiled version of device code included in second source code 1430 that is executable on GPU 1492. GPU 1492 may be any processor that is optimized for parallel instruction processing, is not compatible with CUDA, and is compatible with HCC. GPU 1492 can be developed by AMD Corporation of Santa Clara, CA. GPU 1492 can include a non-CUDA-enabled GPU 1492.

For explanatory purposes only, three different flows that may be implemented in at least one embodiment to compile first source code 1410 for execution on CPU 1490 and different devices are depicted in FIG. 14. A direct CUDA flow can compile first source code 1410 for execution on CPU 1490 and CUDA-enabled GPU 1494 without translating first source code 1410 to second source code 1430. An indirect CUDA flow can translate first source code 1410 to second source code 1430 and then compiles second source code 1430 for execution on CPU 1490 and CUDA-enabled GPU 1494. A CUDA/HCC flow can translate first source code 1410 to second source code 1430 and then can compile second source code 1430 for execution on CPU 1490 and GPU 1492.

A direct CUDA flow that may be implemented is depicted via dashed lines and a series of bubbles annotated A1-A3. As depicted with bubble annotated A1, first compiler 1450 can receive first source code 1410 and a compile command 1448 that can configure first compiler 1450 to compile first source code 1410. First source code 1410 that can be used in a direct CUDA flow can be written in a CUDA programming language that is based on a programming language other than C++ (e.g., C, Fortran, Python, Java, etc.). In response to compile command 1448, first compiler 1450 can generate first host executable code 1470(1) and first device executable code 1484 (depicted with bubble annotated A2). As depicted with bubble annotated A3, first host executable code 1470(1) and first device executable code 1484 may be executed on, respectively, CPU 1490 and CUDA-enabled GPU 1494. First device executable code 1484 can include binary code. First device executable code 1484 can include PTX code and can be further compiled into binary code for a specific target device at runtime.

An indirect CUDA flow that may be implemented is depicted via dotted lines and a series of bubbles annotated B1-B6. As depicted with bubble annotated B1, translation tool 1420 can receive first source code 1410. As depicted with bubble annotated B2, translation tool 1420 can translate first source code 1410 to second source code 1430. As depicted with bubble annotated B3, compiler driver 1440 can receive second source code 1430 and can determine that target device 1446 is CUDA-enabled.

As depicted with bubble annotated B4, compiler driver 1440 can generate first compilation command 1442 and can transmit both first compilation command 1442 and second source code 1430 to first compiler 1450. First compilation command 1442 can configure first compiler 1450 to compile second source code 1430 using a HIP to CUDA translation header and a CUDA runtime library. The HIP to CUDA translation header can translate any number of mechanisms (e.g., functions) specified in any number of HIP APIs to any number of mechanisms specified in any number of CUDA APIs. First compiler 1450 may use HIP to CUDA translation header in conjunction with a CUDA runtime library corresponding to first runtime API 1402 to generate first host executable code 1470(1) and first device executable code 1484. In response to first compilation command 1442, first compiler 1450 can generate first host executable code 1470(1) and first device executable code 1484 (depicted with bubble annotated B5). As depicted with bubble annotated B6, first host executable code 1470(1) and first device executable code 1484 may be executed on, respectively, CPU 1490 and CUDA-enabled GPU 1494. First device executable code 1484 can include binary code. First device executable code 1484 can include PTX code and can be further compiled into binary code for a specific target device at runtime.

A CUDA/HCC flow that may be implemented is depicted via solid lines and a series of bubbles annotated C1-C6. As depicted with bubble annotated C1, translation tool 1420 can receive first source code 1410. As depicted with bubble annotated C2, translation tool 1420 can translate first source code 1410 to second source code 1430. As depicted with bubble annotated C3, compiler driver 1440 can receive second source code 1430 and can determine that target device 1446 is not CUDA-enabled.

Compiler driver 1440 may generate second compilation command 1444 and may transmit both second compilation command 1444 and second source code 1430 to second compiler 1460 (depicted with bubble annotated C4). Second compilation command 1444 can configure second compiler 1460 to compile second source code 1430 using an HCC header and a HIP/HCC runtime library. HIP/HCC runtime library can correspond to second runtime API 1432. HCC header may include any number and type of interoperability mechanisms for HIP and HCC. In response to second compilation command 1444, second compiler 1460 can generate second host executable code 1470(2) and second device executable code 1482 (depicted with bubble annotated C5). As depicted with bubble annotated C6, second host executable code 1470(2) and second device executable code 1482 may be executed on, respectively, CPU 1490 and GPU 1492.

After first source code 1410 is translated to second source code 1430, compiler driver 1440 may subsequently be used to generate executable code for either CUDA-enabled GPU 1494 or GPU 1492 without re-executing translation tool 1420. Translation tool 1420 can translate first source code 1410 to second source code 1430 that is then stored in memory. Compiler driver 1440 can then configure second compiler 1460 to generate second host executable code 1470(2) and second device executable code 1482 based on second source code 1430. In at least one embodiment, compiler driver 1440 subsequently configures first compiler 1450 to generate first host executable code 1470(1) and first device executable code 1484 based on stored second source code 1430.

An example kernel may be translated by translation tool 1420 of FIG. 14, in accordance with at least one embodiment. First source code 1410 can partition an overall problem that a given kernel is designed to solve into relatively coarse sub-problems that can independently be solved using thread blocks. Each thread block includes any number of threads. Each sub-problem can be partitioned into relatively fine pieces that can be solved cooperatively in parallel by threads within a thread block. Threads within a thread block can cooperate by sharing data through shared memory and by synchronizing execution to coordinate memory accesses.

First source code 1410 can organize thread blocks associated with a given kernel into a one-dimensional, a two-dimensional, or a three-dimensional grid of thread blocks. Each thread block includes any number of threads, and a grid includes any number of thread blocks.

A kernel can be a function in device code that is defined using a “__global__” declaration specifier. The dimension of a grid that executes a kernel for a given kernel call and associated streams may be specified using a CUDA kernel launch syntax. CUDA kernel launch syntax can be specified as “KernelName<<<GridSize, BlockSize, SharedMemorySize, Stream>>>(KernelArguments);”. An execution configuration syntax can include a “<<< . . . >>>” construct that is inserted between a kernel name (“KernelName”) and a parenthesized list of kernel arguments (“KernelArguments”). CUDA kernel launch syntax can include a CUDA launch function syntax instead of an execution configuration syntax.

“GridSize” can be of a type dim3 and specify the dimension and size of a grid. Type dim3 may be a CUDA-defined structure that includes unsigned integers x, y, and z. If z is not specified, then z may default to one. If y is not specified, then y may default to one. The number of thread blocks in a grid can be equal to the product of GridSize.x, GridSize.y, and GridSize.z. “BlockSize” can be of type dim3 and specify the dimension and size of each thread block. The number of threads per thread block may be equal to the product of BlockSize.x, BlockSize.y, and BlockSize.z. Each thread that executes a kernel may be given a unique thread ID that is accessible within the kernel through a built-in variable (e.g., “threadIdx”).

With respect to CUDA kernel launch syntax, “SharedMemorySize” may be an optional argument that may specify a number of bytes in a shared memory that is dynamically allocated per thread block for a given kernel call in addition to statically allocated memory. With respect to CUDA kernel launch syntax, SharedMemorySize may default to zero. With respect to CUDA kernel launch syntax, “Stream” may be an optional argument that specifies an associated stream and defaults to zero to specify a default stream. A stream may be a sequence of commands (possibly issued by different host threads) that execute in order. Different streams may execute commands out of order with respect to one another or concurrently.

First source code 1410 may include a kernel definition for an example kernel “MatAdd” and a main function. Main function may be host code that executes on a host and includes a kernel call that causes kernel MatAdd to execute on a device. Kernel MatAdd can add two matrices A and B of size N×N, where N is a positive integer, and store the result in a matrix C. Main function can define a threadsPerBlock variable as 16 by 16 and a numBlocks variable as N/16 by N/16. Main function can then specify kernel call “MatAdd<<<numBlocks, threadsPerBlock>>>(A, B, C);”. As per CUDA kernel launch syntax, kernel MatAdd can be executed using a grid of thread blocks having a dimension N/16 by N/16, where each thread block has a dimension of 16 by 16. Each thread block can include 256 threads, a grid can be created with enough blocks to have one thread per matrix element, and each thread in such a grid may execute kernel MatAdd to perform one pair-wise addition.

While translating first source code 1410 to second source code 1430, translation tool 1420 may translate each kernel call in first source code 1410 from CUDA kernel launch syntax to a HIP kernel launch syntax and may convert any number of other CUDA calls in first source code 1410 to any number of other functionally similar HIP calls. HIP kernel launch syntax can be specified as “hipLaunchKernelGGL(KernelName, GridSize, BlockSize, SharedMemorySize, Stream, KernelArguments);”. Each of KernelName, GridSize, BlockSize, ShareMemorySize, Stream, and KernelArguments can have the same meaning in HIP kernel launch syntax as in CUDA kernel launch syntax (described previously herein). Arguments SharedMemorySize and Stream can be required in HIP kernel launch syntax and can be optional in CUDA kernel launch syntax.

A portion of second source code 1430 can be identical to a portion of first source code 1410 depicted except for a kernel call that causes kernel MatAdd to execute on a device. Kernel MatAdd may be defined in second source code 1430 with the same “__global__” declaration specifier with which kernel MatAdd is defined in first source code 1410. A kernel call in second source code 1430 may be “hipLaunchKernelGGL(MatAdd, numBlocks, threadsPerBlock, 0, 0, A, B, C);”, while a corresponding kernel call in first source code 1410 is “MatAdd<<<numBlocks, threadsPerBlock>>>(A, B, C);”.

Code may be compiled to execute on one of programming platforms of FIG. 14 described above, in accordance with at least one embodiment. The compiler for the processor can have access to information that indicates the hardware configuration of the processor, and configures the timing of data and instruction flows such that corresponding data and instructions are received at each tile with a predetermined temporal relationship. The compiler may work with any processors disclosed within FIG. 9-12B. As such, operand data can be transmitted between the slices of the processor without any accompanying metadata. Instead, each slice can be able to determine what operations to perform on received data based upon the timing at which the data is received.

In some embodiments, a compiler for the processor has information indicating the hardware configuration of the processor, and synchronizes the timing of data and instruction flows such that corresponding data and instructions are received at each tile with a predetermined temporal relationship (e.g., during the same cycle, separated by a predetermined delay, etc.). In some embodiments, the predetermined temporal relationship may be based upon the hardware of the processor, a type of instruction, and/or the like. Because the temporal relationship between when data and instructions are received is known, the operand data received by a tile may not need to include any metadata indicating what the data is to be used for. Instead, each tile may receive instructions, and based upon the predetermined timing, perform the instruction on the corresponding data. This may allow for the data and instructions to flow through the processor more efficiently.

A compiler (e.g., first compiler 1450 or second compiler 1460) can be configured to receive source code (e.g., first source code 1410 or second source code 1430), compile the source code, and output an executable file 1411. The compiler can be configured to convert the source code into host executable code (e.g., first host executable code 1470(1) or second host executable code 1470(2)) for execution on a host and device executable code (e.g., first device executable code 1484 or second device executable code 1482) for execution on a device (e.g., CUDA-enabled GPU 1494 or GPU 1492). The source code may either be compiled offline prior to execution of an application, or online during execution of an application. The source code may include code in any programming language supported by the compiler, such as, but not limited to, C++, C, Fortran, etc. The source code may be included in a single-source file having a mixture of host code and device code, with locations of device code being indicated therein. A single-source file may be a .cu file that includes CUDA code or a .hip.cpp file that includes HIP code or a file in another format that includes both host code and device code. Alternatively, the source code may include multiple source code files, rather than a single-source file, into which host code and device code may be separated. The compiler includes or has access to one or more libraries to recognize a sequence of API calls to perform a single fused API, where a single fused API is a combined API for two or more APIs. In at least one embodiment, the compiler may be an NVIDIA CUDA compiler (“NVCC”) for compiling CUDA code in .cu files, or a HCC compiler for compiling HIP code in .hip.cpp files, or other compilers.

The compiler can include a compiler front end, a host compiler, and a device compiler. The compiler front end can be configured to separate device code from host code in the source code. The device code may be compiled by the device compiler into the device executable code, which as described may include binary code or IR code, in at least one embodiment. Separately, the host code may be compiled by the host compiler into the host executable code. For NVCC other compilers, such as, but not limited to, those for oneAPI, ROCm, and OpenCL, the host compiler may be a general purpose C/C++ compiler that outputs native object code, while the device compiler may be a Low Level Virtual Machine (“LLVM”)-based compiler that forks a LLVM compiler infrastructure and outputs PTX code or binary code. For HCC, both the host compiler and the device compiler may be LLVM-based compilers that output target binary code.

Subsequent to compiling the source code into the host executable code and the device executable code, a linker 1409 (e.g., included in the compiler or receiving an output from the compiler) can link the host executable code and the device executable code together in executable file 1411. Native object code for a host and PTX or binary code for a device may be linked together in an Executable and Linkable Format (“ELF”) file, which is a container format used to store object code. The host executable code and the device executable code may be in any suitable format, such as, but not limited to, binary code and/or IR code. In the case of CUDA, the host executable code may include native object code and the device executable code may include code in PTX intermediate representation, in at least one embodiment. In the case of ROCm, both the host executable code and the device executable code may include target binary code, in at least one embodiment. Other implementations, such as, but not limited to, oneAPI and OpenCL are contemplated and can be performed similarly to the CUDA and ROCm implementations above.

The source code may be translated prior to compiling source code. Source code can be passed through a translation tool (e.g., translation tool 1420), which translates the source code into translated source code. The compiler can be used to compile translated source code into the host executable code and the device executable code in a process that is similar to compilation of the source code by the compiler into the host executable code and the device executable code, as discussed above in conjunction with FIG. 14.

One or more techniques described herein can utilize a oneAPI programming model. A oneAPI programming model can refer to a programming model for interacting with various compute accelerator architectures. OneAPI may refer to an application programming interface (API) designed to interact with various compute accelerator architectures. A oneAPI programming model may utilize a DPC++ programming language. A DPC++ programming language may refer to a high-level language for data parallel programming productivity. A DPC++ programming language can be based at least in part on C and/or C++ programming languages. A oneAPI programming model can be a programming model such as, but not limited to, those developed by Intel Corporation of Santa Clara, CA.

OneAPI and/or oneAPI programming model can be utilized to interact with various accelerator, GPU, processor, and/or variations thereof, architectures. OneAPI may include a set of libraries that implement various functionalities. OneAPI may include at least a oneAPI DPC++ library, a oneAPI math kernel library, a oneAPI data analytics library, a oneAPI deep neural network library, a oneAPI collective communications library, a oneAPI threading building blocks library, a oneAPI video processing library, and/or variations thereof.

A oneAPI DPC++ library, also referred to as oneDPL, can be a library that implements algorithms and functions to accelerate DPC++ kernel programming. OneDPL may implement one or more standard template library (STL) functions. OneDPL can implement one or more parallel STL functions. OneDPL can provide a set of library classes and functions such as, but not limited to, parallel algorithms, iterators, function object classes, range-based API, and/or variations thereof. OneDPL can implement one or more classes and/or functions of a C++ standard library. OneDPL can implement one or more random number generator functions.

A oneAPI math kernel library, also referred to as oneMKL, can be a library that implements various optimized and parallelized routines for various mathematical functions and/or operations. OneMKL can implement one or more basic linear algebra subprograms (BLAS) and/or linear algebra package (LAPACK) dense linear algebra routines. OneMKL may implement one or more sparse BLAS linear algebra routines. OneMKL can implement one or more random number generators (RNGs). OneMKL may implement one or more vector mathematics (VM) routines for mathematical operations on vectors. OneMKL may implement one or more Fast Fourier Transform (FFT) functions.

A oneAPI data analytics library, also referred to as oneDAL, can include a library that implements various data analysis applications and distributed computations. OneDAL can implement various algorithms for preprocessing, transformation, analysis, modeling, validation, and decision making for data analytics, in batch, online, and distributed processing modes of computation. OneDAL can implement various C++ and/or Java APIs and various connectors to one or more data sources. OneDAL may implement DPC++ API extensions to a traditional C++ interface and enables GPU usage for various algorithms.

A oneAPI deep neural network library, also referred to as oneDNN, can include a library that implements various deep learning functions. OneDNN may implement various neural network, machine learning, and deep learning functions, algorithms, and/or variations thereof.

A oneAPI collective communications library, also referred to as oneCCL, can include a library that implements various applications for deep learning and machine learning workloads. OneCCL can be built upon lower-level communication middleware, such as, but not limited to, message passing interface (MPI) and libfabrics. OneCCL can enable a set of deep learning specific optimizations, such as, but not limited to, prioritization, persistent operations, out of order executions, and/or variations thereof. OneCCL can implement various CPU and GPU functions.

A oneAPI threading building blocks library, also referred to as oneTBB, can include a library that implements various parallelized processes for various applications. OneTBB can be utilized for task-based, shared parallel programming on a host. OneTBB may implement generic parallel algorithms. OneTBB may implement concurrent containers. OneTBB may implement a scalable memory allocator. OneTBB may implement a work-stealing task scheduler. OneTBB may implement low-level synchronization primitives. OneTBB may be compiler-independent and usable on various processors, such as, but not limited to, GPUs, PPUs, CPUs, and/or variations thereof.

A oneAPI video processing library, also referred to as oneVPL, can include a library that is utilized for accelerating video processing in one or more applications. OneVPL can implement various video decoding, encoding, and processing functions. OneVPL can implement various functions for media pipelines on CPUs, GPUs, and other accelerators. OneVPL can implement device discovery and selection in media centric and video analytics workloads. OneVPL can implement API primitives for zero-copy buffer sharing.

A oneAPI programming model may utilize a DPC++ programming language. A DPC++ programming language can include a programming language that can include functionally similar versions of CUDA mechanisms to define device code and distinguish between device code and host code. A DPC++ programming language may include a subset of functionality of a CUDA programming language. One or more CUDA programming model operations may be performed using a oneAPI programming model using a DPC++ programming language.

Any application programming interface (API) described herein can be compiled into one or more instructions, operations, or any other signal by a compiler, interpreter, or other software tool. Compilation can include generating one or more machine-executable instructions, operations, or other signals from source code. An API compiled into one or more instructions, operations, or other signals, when performed, can cause one or more processors such as, but not limited to, processors described, e.g., in FIGS. 9-12B, or any other logic circuit further described herein to perform one or more computing operations.

In at least one embodiment, translation tools described elsewhere herein, such as, but not limited to, can include circuitry (e.g., one or more circuits described above and elsewhere herein) to translate CUDA code to generate, from an input tensor, contraction operands by directly storing the operands in a reordered feature-leading layout and perform a feature-preserving triangular multiplicative update by contraction over an intermediate index to HIP, oneAPI, OpenCL, or any other language used to perform any of the operations described above or elsewhere herein. One or more circuits can be configured by software to translate CUDA code to generate, from an input tensor, contraction operands by directly storing the operands in a reordered feature-leading layout and perform a feature-preserving triangular multiplicative update by contraction over an intermediate index to HIP, oneAPI, OpenCL, or any other language used to perform any of the operations described above or elsewhere herein.

### Logic and Neural Network Training and Deployment

The following figures set forth, without limitation, examples of logic and artificial intelligence-based systems that can be used to implement functionality and/or operations described herein.

FIGS. 15A and 15B illustrate logic 1515 which, as described elsewhere herein, can be used in one or more devices or systems (e.g., such as any of the processors in FIGS. 9-12B), data centers, cloud or web-based services described herein) to perform operations such as, but not limited to, those discussed herein, in accordance with at least one embodiment. Logic can refer to any combination of software logic, hardware logic, and/or firmware logic to provide functionality and/or operations described herein, wherein logic may be, collectively or individually, embodied as circuitry that forms part of a larger system, for example, an integrated circuit (IC), an application-specific integrated circuit (ASIC), a field programmable array (FPGA), system-on-chip (SoC), or one or processors (e.g., CPU, GPU). Logic 1515 illustrated in FIGS. 15A and 15B may be used in conjunction with an application-specific integrated circuit (“ASIC”), such as, but not limited to, those in FIGS. 9-12B.

Logic 1515 can be used to perform inferencing and/or training operations associated with one or more embodiments. Logic 1515 may be inference and/or training logic. In at least one embodiment, FIG. 15A illustrates inference and/or training logic 1515 used to perform inferencing and/or training operations associated with one or more embodiments. Inference and/or training logic 1515 may include code and/or data storage 1501 to store forward and/or output weight and/or input/output data, and/or other parameters to configure neurons or layers of a neural network trained and/or used for inferencing in aspects of one or more embodiments. Training logic 1515 may include, or be coupled to code and/or data storage 1501 to store graph code or other software to control timing and/or order, in which weight and/or other parameter information is to be loaded to configure, logic, including integer and/or floating point units (collectively, arithmetic logic units (ALUs). Code, such as, but not limited to, graph code, can load weight or other parameter information into processor ALUs based on an architecture of a neural network to which such code corresponds. Code and/or data storage 1501 can store weight parameters and/or input/output data of each layer of a neural network trained or used in conjunction with one or more embodiments during forward propagation of input/output data and/or weight parameters during training and/or inferencing using aspects of one or more embodiments. Any portion of code and/or data storage 1501 may be included with other on-chip or off-chip data storage, including a processor's L1, L2, or L3 cache or system memory.

Any portion of code and/or data storage 1501 may be internal or external to one or more processors or other hardware logic devices or circuits. Code and/or code and/or data storage 1501 may be cache memory, dynamic randomly addressable memory (“DRAM”), static randomly addressable memory (“SRAM”), non-volatile memory (e.g., flash memory), or other storage. A choice of whether code and/or code and/or data storage 1501 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

Inference and/or training logic 1515 may include a code and/or data storage 1505 to store backward and/or output weight and/or input/output data corresponding to neurons or layers of a neural network trained and/or used for inferencing in aspects of one or more embodiments. Code and/or data storage 1505 can store weight parameters and/or input/output data of each layer of a neural network trained or used in conjunction with one or more embodiments during backward propagation of input/output data and/or weight parameters during training and/or inferencing using aspects of one or more embodiments. Training logic 1515 may include, or be coupled to code and/or data storage 1505 to store graph code or other software to control timing and/or order, in which weight and/or other parameter information is to be loaded to configure, logic, including integer and/or floating point units (collectively, arithmetic logic units (ALUs).

Code, such as, but not limited to, graph code, may cause loading of weight or other parameter information into processor ALUs based on an architecture of a neural network to which such code corresponds. Any portion of code and/or data storage 1505 may be included with other on-chip or off-chip data storage, including a processor's L1, L2, or L3 cache or system memory. Any portion of code and/or data storage 1505 may be internal or external to one or more processors or other hardware logic devices or circuits. Code and/or data storage 1505 may be cache memory, DRAM, SRAM, non-volatile memory (e.g., flash memory), or other storage. A choice of whether code and/or data storage 1505 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

Code and/or data storage 1501 and code and/or data storage 1505 may be separate storage structures. Code and/or data storage 1501 and code and/or data storage 1505 may be a combined storage structure. Code and/or data storage 1501 and code and/or data storage 1505 may be partially combined and partially separate. Any portion of code and/or data storage 1501 and code and/or data storage 1505 may be included with other on-chip or off-chip data storage, including a processor's L1, L2, or L3 cache or system memory.

Inference and/or training logic 1515 may include one or more arithmetic logic unit(s) (“ALU(s)”) 1510, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 1520 that may be functions of input/output and/or weight parameter data stored in code and/or data storage 1501 and/or code and/or data storage 1505. Activations stored in activation storage 1520 may be generated according to linear algebraic and or matrix-based mathematics performed by ALU(s) 1510 in response to performing instructions or other code, wherein weight values stored in code and/or data storage 1505 and/or data storage 1501 may be used as operands along with other values, such as, but not limited to, bias values, gradient information, momentum values, or other parameters or hyperparameters, any or all of which may be stored in code and/or data storage 1505 or code and/or data storage 1501 or another storage on or off-chip.

ALU(s) 1510 can be included within one or more processors or other hardware logic devices or circuits, whereas in another embodiment, ALU(s) 1510 may be external to a processor or other hardware logic device or circuit that uses them (e.g., a co-processor). ALUs 1510 may be included within a processor's execution units or otherwise within a bank of ALUs accessible by a processor's execution units either within same processor or distributed between different processors of different types (e.g., central processing units, graphics processing units, fixed function units, etc.). Code and/or data storage 1501, code and/or data storage 1505, and activation storage 1520 may share a processor or other hardware logic device or circuit, whereas in another embodiment, they may be in different processors or other hardware logic devices or circuits, or some combination of same and different processors or other hardware logic devices or circuits. Any portion of activation storage 1520 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

Activation storage 1520 may be cache memory, DRAM, SRAM, non-volatile memory (e.g., flash memory), or other storage. Activation storage 1520 may be completely or partially within or external to one or more processors or other logical circuits. A choice of whether activation storage 1520 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 1515 illustrated in FIG. 15A may be used in conjunction with an application-specific integrated circuit (“ASIC”), such as, but not limited to, a TensorFlow® Processing Unit from Google, an inference processing unit (IPU) from Graphcore™, or a Nervana® (e.g., “Lake Crest”) processor from Intel Corp. In at least one embodiment, inference and/or training logic 1515 illustrated in FIG. 15A may be used in conjunction with hardware similar to FIGS. 9-12B.

In FIG. 15B, for example, each of code and/or data storage 1501 and code and/or data storage 1505 is associated with a dedicated computational resource, such as, but not limited to, computational hardware 1502 and computational hardware 1506, respectively. Each of computational hardware 1502 and computational hardware 1506 can include one or more ALUs that perform mathematical functions, such as, but not limited to, linear algebraic functions, only on information stored in code and/or data storage 1501 and code and/or data storage 1505, respectively, result of which is stored in activation storage 1520.

Each of code and/or data storage 1501 and 1505 and corresponding computational hardware 1502 and 1506, respectively, correspond to different layers of a neural network, such that resulting activation from one storage/computational pair 1501/1502 of code and/or data storage 1501 and computational hardware 1502 is provided as an input to a next storage/computational pair 1505/1506 of code and/or data storage 1505 and computational hardware 1506, in order to mirror a conceptual organization of a neural network. Each of storage/computational pairs 1501/1502 and 1505/1506 may correspond to more than one neural network layer. Additional storage/computation pairs (not shown) subsequent to or in parallel with storage/computation pairs 1501/1502 and 1505/1506 may be included in inference and/or training logic 1515.

In at least one embodiment, logic 1515 described elsewhere herein, can include circuitry (e.g., one or more circuits described above and elsewhere herein) to generate, from an input tensor, contraction operands by directly storing the operands in a reordered feature-leading layout and perform a feature-preserving triangular multiplicative update by contraction over an intermediate index or otherwise perform any of the operations described above or elsewhere herein. One or more circuits in logic 1515 can be configured by software described herein, to generate, from an input tensor, contraction operands by directly storing the operands in a reordered feature-leading layout and perform a feature-preserving triangular multiplicative update by contraction over an intermediate index or otherwise perform any of the operations described above or elsewhere herein.

FIG. 15C illustrates training and deployment of a deep neural network, in accordance with at least one embodiment. An untrained neural network 1526 can be trained using a training dataset 1522. A training framework 1524 can be a PyTorch framework, and/or training framework 1524 can include a TensorFlow, Boost, Caffe, Microsoft Cognitive Toolkit/CNTK, MXNet, Chainer, Keras, Deeplearning4j, or other training framework. Training framework 1524 can train an untrained neural network 1526 and enables it to be trained using processing resources described herein to generate a trained neural network 1528. Weights may be chosen randomly or by pre-training using a deep belief network. Training may be performed in either a supervised, partially supervised, or unsupervised manner.

Untrained neural network 1526 can be trained using supervised learning, wherein training dataset 1522 includes an input paired with a desired output for an input, or where training dataset 1522 includes input having a known output and an output of neural network 1526 is manually graded. Untrained neural network 1526 can be trained in a supervised manner and processes inputs from training dataset 1522 and compares resulting outputs against a set of expected or desired outputs. Errors can then be propagated back through untrained neural network 1526. Training framework 1524 can adjust weights that control untrained neural network 1526. Training framework 1524 can include tools to monitor how well untrained neural network 1526 is converging towards a model, such as, but not limited to, trained neural network 1528, suitable to generating correct answers, such as, but not limited to, in result 1532, based on input data such as, but not limited to, a new dataset 1530. Training framework 1524 can train untrained neural network 1526 repeatedly while adjust weights to refine an output of untrained neural network 1526 using a loss function and adjustment algorithm, such as, but not limited to, stochastic gradient descent. Training framework 1524 can train untrained neural network 1526 until untrained neural network 1526 achieves a desired accuracy. Trained neural network 1528 can then be deployed to implement any number of machine learning operations.

Untrained neural network 1526 can be trained using unsupervised learning, wherein untrained neural network 1526 attempts to train itself using unlabeled data. Unsupervised learning training dataset 1522 can include input data without any associated output data or “ground truth” data. Untrained neural network 1526 can learn groupings within training dataset 1522 and can determine how individual inputs may be related to untrained dataset 1522. Unsupervised training can be used to generate a self-organizing map in trained neural network 1528 capable of performing operations useful in reducing dimensionality of new dataset 1530. Unsupervised training can also be used to perform anomaly detection, which allows identification of data points in new dataset 1530 that deviate from normal patterns of new dataset 1530.

Semi-supervised learning may be used, which is a technique in which in training dataset 1522 includes a mix of labeled and unlabeled data. Training framework 1524 may be used to perform incremental learning, such as, but not limited to, through transferred learning techniques. Incremental learning can enable trained neural network 1528 to adapt to new dataset 1530 without forgetting knowledge instilled within trained neural network 1528 during initial training.

Training framework 1524 can include a framework processed in connection with a software development toolkit such as, but not limited to, an OpenVINO (Open Visual Inference and Neural network Optimization) toolkit. An OpenVINO toolkit can include a toolkit such as, but not limited to, those developed by Intel Corporation of Santa Clara, CA.

OpenVINO can include a toolkit for facilitating development of applications, specifically neural network applications, for various tasks and operations, such as, but not limited to, human vision emulation, speech recognition, natural language processing, recommendation systems, and/or variations thereof. OpenVINO can support neural networks such as, but not limited to, convolutional neural networks (CNNs), recurrent and/or attention-based neural networks, and/or various other neural network models. OpenVINO can support various software libraries such as, but not limited to, OpenCV, OpenCL, and/or variations thereof.

OpenVINO can support neural network models for various tasks and operations, such as, but not limited to, classification, segmentation, object detection, face recognition, speech recognition, pose estimation (e.g., humans and/or objects), monocular depth estimation, image inpainting, style transfer, action recognition, colorization, and/or variations thereof.

OpenVINO can include one or more software tools and/or modules for model optimization, also referred to as a model optimizer. A model optimizer can include a command line tool that facilitates transitions between training and deployment of neural network models. A model optimizer may optimize neural network models for execution on various devices and/or processing units, such as, but not limited to, a GPU, CPU, PPU, GPGPU, and/or variations thereof. A model optimizer can generate an internal representation of a model, and can optimize said model to generate an intermediate representation. A model optimizer may reduce a number of layers of a model. A model optimizer can remove layers of a model that may be utilized for training. A model optimizer may perform various neural network operations, such as, but not limited to, modifying inputs to a model (e.g., resizing inputs to a model), modifying a size of inputs of a model (e.g., modifying a batch size of a model), modifying a model structure (e.g., modifying layers of a model), normalization, standardization, quantization (e.g., converting weights of a model from a first representation, such as, but not limited to, floating point, to a second representation, such as, but not limited to, integer), and/or variations thereof.

OpenVINO can include one or more software libraries for inferencing, also referred to as an inference engine. An inference engine can include a C++ library, or any suitable programming language library. An inference engine can be utilized to infer input data. An inference engine may implement various classes to infer input data and generate one or more results. An inference engine can implement one or more API functions to process an intermediate representation, set input and/or output formats, and/or execute a model on one or more devices.

OpenVINO may provide various abilities for heterogeneous execution of one or more neural network models. Heterogeneous execution, or heterogeneous computing, can refer to one or more computing processes and/or systems that utilize one or more types of processors and/or cores. OpenVINO can provide various software functions to execute a program on one or more devices. OpenVINO may provide various software functions to execute a program and/or portions of a program on different devices. OpenVINO may provide various software functions to, for example, run a first portion of code on a CPU and a second portion of code on a GPU and/or FPGA. OpenVINO may provide various software functions to execute one or more layers of a neural network on one or more devices (e.g., a first set of layers on a first device, such as, but not limited to, a GPU, and a second set of layers on a second device, such as, but not limited to, a CPU).

OpenVINO can include various functionality similar to functionalities associated with a CUDA programming model, such as, but not limited to, various neural network model operations associated with frameworks such as, but not limited to, TensorFlow, PyTorch, and/or variations thereof. One or more CUDA programming model operations may be performed using OpenVINO. Various systems, methods, and/or techniques described herein may be implemented using OpenVINO.

In at least one embodiment, circuitry (e.g., one or more circuits described above and elsewhere herein) can be used to cause one or more neural networks and training frameworks described elsewhere herein to generate, from an input tensor, contraction operands by directly storing the operands in a reordered feature-leading layout and perform a feature-preserving triangular multiplicative update by contraction over an intermediate index or otherwise perform any of the operations described above or elsewhere herein. One or more neural networks and training frameworks can be configured by software to generate, from an input tensor, contraction operands by directly storing the operands in a reordered feature-leading layout and perform a feature-preserving triangular multiplicative update by contraction over an intermediate index or otherwise perform any of the operations described above or elsewhere herein.

In at least one embodiment, computing system 800, processors described in FIGS. 2-5B, software stack 1300, and logic 1515 may be deployed in a variety of operational environments including cloud computing platforms, autonomous vehicles, robotic systems, edge computing systems, and combinations thereof. These deployment environments may leverage the same or similar computing architectures, processors, interconnects, and software constructs described above to perform distributed computation, machine learning training, machine learning inference, sensor processing, or control operations.

In at least one embodiment, computing system 800 may be implemented as part of a cloud computing infrastructure that provides scalable compute resources to remote clients over one or more networks. For example, computing system 800 may correspond to a node or group of nodes within a cloud service provider infrastructure including, but not limited to, public clouds, private clouds, hybrid clouds, or distributed edge clouds.

In such embodiments, CPUs, GPUs, DPUs, LPUs, and other processors described herein may execute software workloads associated with artificial intelligence services, data analytics services, distributed databases, web services, media processing services, or high-performance computing tasks. Resource orchestrator 835, job scheduler 823, configuration manager 825, and resource manager 827 may allocate processing resources across nodes in response to service requests received from clients (e.g., processing devices 802, 804) over network 830. For example, application(s) 843 may include cloud-based machine learning inference services, speech recognition services, image analysis services, recommendation engines, or generative artificial intelligence services that operate on data submitted by remote clients.

In at least one embodiment, trained neural network models produced using training framework 1524 and deployed as trained neural network 1528 may be executed within such cloud infrastructures using processors described in FIGS. 2-5B. GPUs, LPUs, tensor processors, or other accelerators may perform parallel inference operations on batches of incoming requests, while DPUs or NICs may offload networking, storage virtualization, and security functions to improve overall data center efficiency.

In at least one embodiment, processors described herein may be incorporated into autonomous or semi-autonomous vehicle platforms. For example, system-on-chip 900, parallel processor 1000, or processor 1200 may be integrated into an onboard compute module of a vehicle, such as an automobile, a truck, a drone, an aircraft, a marine vessel, or other autonomous or semi-autonomous platforms.

Such systems may receive input from one or more sensors including cameras, LiDAR sensors, radar sensors, ultrasonic sensors, inertial measurement units (IMUs), global navigation satellite systems (GNSS), or other environmental sensing devices. Sensor data may be processed using machine learning models executed by GPUs, LPUs, NPUs, tensor processors, or other accelerators described herein to perform perception, localization, mapping, object detection, semantic segmentation, trajectory prediction, or path planning operations.

In at least one embodiment, inference and/or training logic 1515 may execute neural network models that interpret sensor data to identify objects, determine drivable space, or estimate motion of surrounding entities. Outputs of these models may be provided to vehicle control logic that determines steering, braking, acceleration, or navigation actions. In some implementations, high-bandwidth memory architectures, high-speed interconnects, or specialized matrix processing units described herein may accelerate inference workloads associated with real-time perception systems.

In at least one embodiment, vehicle systems may communicate with remote computing systems, such as cloud-based implementations of computing system 800, to upload training data, receive updated models, or participate in distributed training processes. For example, vehicle-collected sensor datasets may be transmitted to a data center where training framework 1524 may retrain or otherwise update neural networks using aggregated fleet data, and updated model parameters may subsequently be deployed back to vehicles for improved performance.

In at least one embodiment, processors and computing architectures described herein may be implemented in robotic systems including industrial robots, service robots, collaborative robots (cobots), warehouse robots, medical robots, agricultural robots, or mobile robots.

Robotic platforms may utilize processors such as SOC 900, parallel processor 300, or processor 1200 to perform perception, control, and decision-making tasks. For example, robotic systems may execute machine learning models that perform object detection, grasp planning, scene understanding, human interaction recognition, or navigation in dynamic environments. In at least one embodiment, machine learning models executed by the robotic system for inference may be trained using GPU-accelerated software (e.g., CUDA-based or other training platforms) executed on processors described herein.

In at least one embodiment, sensor data from cameras, depth sensors, force sensors, or tactile sensors may be processed using inference logic implemented on GPUs, LPUs, NPUs, or other accelerators described herein. Neural network inference may generate control signals for robotic actuators including motors, grippers, articulated arms, or locomotion systems.

In some implementations, robotic systems may operate within distributed computing environments in which some computation occurs locally on embedded processors while other computation occurs remotely (e.g., in computing system 800). For example, latency-sensitive inference tasks may execute locally on an onboard GPU, LPU, or NPU, while large-scale model training or global environment mapping may be performed in a remote data center.

In at least one embodiment, computing architectures described herein may be deployed in edge computing systems positioned between cloud data centers and end devices. Edge nodes may include processors such as SOC 900 or GPU- or LPU-based systems (e.g., incorporating parallel processor 1000 or processor 1200) that provide localized computation for applications requiring reduced latency, reduced bandwidth usage, or improved reliability.

Examples of such edge deployments include intelligent transportation infrastructure, smart city monitoring systems, automated warehouses, retail analytics platforms, healthcare monitoring systems, and telecommunications edge infrastructure. Edge systems may process sensor data locally using machine learning models and communicate summarized or processed data to centralized cloud systems.

In these deployments, the combination of CPUs, GPUs, LPUs, NPUs, DPUs, and other accelerators described herein may enable efficient execution of distributed machine learning workloads, real-time analytics, and inference services across heterogeneous computing environments.

Accordingly, processors, computing systems, and software stacks described herein may be implemented in cloud computing platforms, autonomous vehicle systems, robotic systems, and edge computing environments, among other applications. These environments may leverage the parallel processing capabilities, high-bandwidth interconnects, and machine learning acceleration features described herein to perform complex computational tasks including training and deployment of neural networks, real-time sensor processing, and distributed data analysis. In at least one embodiment, cloud-based and/or web-based services and/or systems that can be used to generate, from an input tensor, contraction operands by directly storing the operands in a reordered feature-leading layout and perform a feature-preserving triangular multiplicative update by contraction over an intermediate index or otherwise perform some or all of processes, operations and/or and techniques described above or elsewhere herein. Additionally, cloud-based and/or web-based services and/or systems can be configured by software to generate, from an input tensor, contraction operands by directly storing the operands in a reordered feature-leading layout and perform a feature-preserving triangular multiplicative update by contraction over an intermediate index or otherwise perform any of the operations described above or elsewhere herein. In at least one embodiment, autonomous vehicle systems and/or robotic systems can include circuitry (e.g., one or more circuits described above and elsewhere herein) to generate, from an input tensor, contraction operands by directly storing the operands in a reordered feature-leading layout and perform a feature-preserving triangular multiplicative update by contraction over an intermediate index or otherwise perform any of the operations described above or elsewhere herein. Additionally, one or more circuits in autonomous vehicle systems and/or robotic systems can be configured by software, e.g., programming platforms described herein, to generate, from an input tensor, contraction operands by directly storing the operands in a reordered feature-leading layout and perform a feature-preserving triangular multiplicative update by contraction over an intermediate index or otherwise perform any of the operations described above or elsewhere herein.

At least one embodiment of the disclosure can be described in view of the following clauses:

1. One or more processors, comprising:
circuitry to:
   receive an input tensor representing features and stored in memory according to a first ordered memory layout, the input tensor including a first pair-index axis, a second pair-index axis, and a feature-channel axis;
   execute a fused accelerator kernel configured to perform a plurality of neural network operations including computing, from the input tensor, a first tensor and a second tensor, and storing the first tensor and the second tensor in memory according to a second ordered memory layout, wherein the storing performs a transpose operation that reorders axes from the first ordered memory layout to the second ordered memory layout, and wherein, in the second ordered memory layout, the feature-channel axis precedes the first pair-index axis and the second pair-index axis; and
   compute a triangular multiplicative update tensor by performing a tensor contraction between the first tensor and the second tensor that sums over an intermediate index, wherein the feature-channel axis is preserved by the tensor contraction and is not summed over the intermediate index.

2. The one or more processors of claim 1, wherein the transpose operation is to be performed by storing computed tensor values directly at memory addresses corresponding to the second ordered memory layout during execution of the fused accelerator kernel.

3. The one or more processors of claim 1, wherein the transpose operation is to be performed as part of the fused accelerator kernel, without executing a separate transpose kernel between execution of the fused accelerator kernel and performance of the tensor contraction.

4. The one or more processors of claim 1, wherein the transpose operation is to reorder tensor values generated from the input tensor from a first ordered memory layout in which the first pair-index axis and the second pair-index axis precede the feature-channel axis to the second ordered memory layout in which the feature-channel axis precedes the first pair-index axis and the second pair-index axis.

5. The one or more processors of claim 1, wherein the fused accelerator kernel is to:
perform a first matrix multiplication and a second matrix multiplication using a tensor derived from the input tensor;
generate a result tensor based on respective results of the first matrix multiplication and the second matrix multiplication; and
store the resulting tensor in the second ordered memory layout.

6. The one or more processors of claim 1, wherein the fused accelerator kernel is to generate a projected tensor in the second ordered memory layout, and wherein the circuitry is to generate the first tensor and the second tensor by partitioning the projected tensor along the feature-channel axis.

7. The one or more processors of claim 1, wherein the circuitry is further to perform backward propagation for the triangular multiplicative update, and wherein the backward propagation includes recomputing one or more projection accumulations or gating accumulations during gradient computation.

8. A method comprising:
receiving an input tensor representing features and stored in memory according to a first ordered memory layout, the input tensor including a first pair-index axis, a second pair-index axis, and a feature-channel axis;
executing a fused accelerator kernel to generate, from the input tensor, a first tensor and a second tensor and store the first tensor and the second tensor in memory according to a second ordered memory layout by writing computed tensor values directly to memory addresses corresponding to the second ordered memory layout, wherein, in the second ordered memory layout, the feature-channel axis precedes the first pair-index axis and the second pair-index axis; and
computing a triangular multiplicative update tensor by performing a tensor contraction between the first tensor and the second tensor that sums over an intermediate index.

9. The method of claim 8, wherein executing the fused accelerator kernel includes storing the first tensor and the second tensor in the second ordered memory layout such that, for fixed values of the feature-channel axis, the tensor contraction is performed as a matrix multiplication over the intermediate index, and different fixed values of the feature-channel axis correspond to different matrix multiplications of a batched matrix multiplication.

10. The method of claim 8, wherein the tensor contraction is performed while the first tensor and the second tensor remain stored in the second ordered memory layout, without restoring a layout in which the feature-channel axis follows the first pair-index axis and the second pair-index axis before performing the tensor contraction.

11. The method of claim 8, further comprising:
executing a fused layer-normalization-and-transpose kernel after computing the triangular multiplicative update tensor to normalize the triangular multiplicative update tensor; and
storing a post-contraction tensor in a layout in which the feature-channel axis is preceded by the first pair-index axis and the second pair-index axis.

12. The method of claim 8, further comprising performing backward propagation for the triangular multiplicative update by executing a fused backward kernel configured to compute a gradient with respect to an input tensor for a fused layer-normalization-and-transpose operation.

13. The method of claim 8, wherein the input tensor further includes a batch axis, and wherein the storing reorders tensor values generated from the input tensor from a first ordered memory layout in which the batch axis is followed by the first pair-index axis, the second pair-index axis, and the feature-channel axis, to a second ordered memory layout in which the batch axis and the feature-channel axis precede the first pair-index axis and the second pair-index axis.

14. A system, comprising:
one or more processors to:
   receive an input tensor representing features and stored in memory according to a first ordered memory layout, the input tensor including a first pair-index axis, a second pair-index axis, and a feature-channel axis;
   execute a fused accelerator kernel to generate, from the input tensor, a first tensor and a second tensor and store the first tensor and the second tensor in memory according to a second ordered memory layout, wherein the storing performs a transpose operation by writing computed tensor values to memory addresses corresponding to the second ordered memory layout, and wherein, in the second ordered memory layout, the feature-channel axis precedes the first pair-index axis and the second pair-index axis; and
   compute a triangular multiplicative update tensor by performing a tensor contraction between the first tensor and the second tensor that sums over an intermediate index, wherein the feature-channel axis is preserved by the tensor contraction.

15. The system of claim 14, wherein the one or more processors are further to execute one or more backward kernels to perform backward propagation for the triangular multiplicative update by computing one or more gradients associated with at least one of layer normalization, projection, gating, or masking.

16. The system of claim 14, the tensor contraction forms the updated feature associated with the first pair-index axis and the second pair-index axis by combining features associated with a pair identified by the first pair-index axis and a shared intermediate index and features associated with a pair identified by the second pair-index axis and the shared intermediate index.

17. The system of claim 14, wherein the one or more processors are further to execute a backward kernel configured to compute gradients for a fused sigmoid-gated dual matrix multiplication operation used in the triangular multiplicative update.

18. The system of claim 14, wherein the fused accelerator kernel is further configured to perform a first matrix multiplication and a second matrix multiplication using a tensor derived from the input tensor, wherein a shared operand derived from the input tensor is loaded once from memory and reused as an input to both the first matrix multiplication and the second matrix multiplication to generate respective projection results.

19. The system of claim 14, wherein the fused accelerator kernel is compiled using a layout parameter that specifies an input tensor layout and an output tensor layout, and wherein pointer arithmetic used by the fused accelerator kernel to access tensor elements of the input tensor and to store tensor elements of the output tensor is determined based on the layout parameter.

20. The system of claim 14, wherein the input tensor further includes a batch axis, and
wherein the storing reorders tensor values generated from the input tensor from a first ordered memory layout in which the batch axis is followed by the first pair-index axis, the second pair-index axis, and the feature-channel axis, to a second ordered memory layout in which the batch axis and the feature-channel axis precede the first pair-index axis and the second pair-index axis.

21. One or more processors, comprising:
circuitry to:
receive an input tensor representing features and stored in memory according to a first ordered memory layout, the input tensor including a feature-channel axis, a first pair-index axis, and a second pair-index axis;
execute, on a Language Processing Unit (LPU), a triangular multiplicative update graph to generate a first tensor and a second tensor and store the first tensor and the second tensor in memory according to a second ordered memory layout in which the feature-channel axis is a leading axis, wherein the storing performs a transpose that reorders the feature-channel axis relative to the first pair-index axis and the second pair-index axis; and
compute, on the LPU, a triangular multiplicative update tensor by performing a tensor contraction between the first tensor and the second tensor that sums over an intermediate index.

22. The one or more processors of clause 21, wherein the transpose is to be performed during storing of the first tensor and the second tensor in the second ordered memory layout.

23. The one or more processors of any of clauses 21-22, wherein the transpose is performed by writing tensor elements of the first tensor and the second tensor to memory according to a layout mapping corresponding to the second ordered memory layout.

24. The one or more processors of any of clauses 21-23, wherein the circuitry is further to write tensor elements of the first tensor and the second tensor to output buffers assigned according to the second ordered memory layout.

25. The one or more processors of any of clauses 21-24, wherein the triangular multiplicative update graph is executed on the LPU according to a compiler-scheduled dataflow plan that assigns one or more output buffers storing the first tensor and the second tensor according to the second ordered memory layout.

26. The one or more processors of any of clauses 21-25, wherein the triangular multiplicative update graph is executed according to a compiler-scheduled dataflow plan that schedules the tensor contraction for execution on the LPU as a batched matrix multiplication such that the feature-channel axis is preserved rather than reduced and different values of the feature-channel axis correspond to different matrix multiplications over the intermediate index.

27. The one or more processors of any of clauses 21-26, wherein one or more producer operations of the triangular multiplicative update graph include one or more of: normalization, linear projection, gating, masking, or elementwise combination, and wherein the one or more producer operations write outputs directly according to the second ordered memory layout.

28. A method comprising:
receiving an input tensor representing features and stored in memory according to a first ordered memory layout, the input tensor including a feature-channel axis, a first pair-index axis, and a second pair-index axis;
executing, on a Language Processing Unit (LPU) and according to a compiler-scheduled dataflow plan, one or more producer operations of a triangular multiplicative update graph to generate a first tensor and a second tensor and store the first tensor and the second tensor in one or more output buffers assigned to a second ordered memory layout in which the feature-channel axis is a leading axis,
wherein the storing performs a transpose that reorders the feature-channel axis relative to the first pair-index axis and the second pair-index axis by generating store addresses corresponding to the second ordered memory layout, without generating a separate intermediate tensor in the second ordered memory layout; and
computing a triangular multiplicative update tensor by performing a tensor contraction between the first tensor and the second tensor that sums over an intermediate index.

29. The method of clause 28, wherein the storing performs the transpose without executing a separate transpose stage between generating the first tensor and the second tensor and performing the tensor contraction.

30. The method of any of clauses 28-29, wherein the tensor contraction consumes the first tensor and the second tensor from the one or more output buffers without copying the first tensor and the second tensor to separate contraction-input buffers.

31. The method of any of clauses 28-30, wherein the compiler-scheduled dataflow plan schedules the tensor contraction for execution on the LPU as a batched matrix multiplication such that the feature-channel axis is preserved rather than reduced and different values of the feature-channel axis correspond to different matrix multiplications over the intermediate index.

32. The method of any of clauses 28-31, wherein the compiler-scheduled dataflow plan propagates the second ordered memory layout across multiple stages of the triangular multiplicative update graph before restoration to a layout in which the feature-channel axis trails the first pair-index axis and the second pair-index axis.

33. The method of any of clauses 28-32, further comprising storing the triangular multiplicative update tensor according to the second ordered memory layout and performing layer normalization on the triangular multiplicative update tensor while the triangular multiplicative update tensor remains stored according to the second ordered memory layout.

34. The method of any of clauses 28-33, wherein the tensor contraction is performed while the first tensor and the second tensor remain stored in the second ordered memory layout, without restoring a layout in which the feature-channel axis trails the first pair-index axis and the second pair-index axis before performing the tensor contraction.

35. A system, comprising:
one or more processors to:
receive an input tensor representing features and stored in memory according to a first ordered memory layout, the input tensor including a feature-channel axis, a first pair-index axis, and a second pair-index axis;
execute, on a Language Processing Unit (LPU), a triangular multiplicative update graph to generate a first tensor and a second tensor and store the first tensor and the second tensor in memory according to a second ordered memory layout in which the feature-channel axis is a leading axis, wherein the storing performs a transpose that reorders the feature-channel axis relative to the first pair-index axis and the second pair-index axis; and
compute, on the LPU, a triangular multiplicative update tensor by performing a tensor contraction between the first tensor and the second tensor that sums over an intermediate index.

36. The system of clause 35, wherein the one or more processors are to execute the triangular multiplicative update graph according to a compiler-scheduled dataflow plan that assigns output buffers that store the first tensor and the second tensor according to the second ordered memory layout.

37. The system of any of clauses 35-36, wherein the transpose is to reorder tensor values generated from the input tensor from the first ordered memory layout in which the first pair-index axis and the second pair-index axis precede the feature-channel axis to the second ordered memory layout in which the feature-channel axis precedes the first pair-index axis and the second pair-index axis.

38. The system of any of clauses 35-37, wherein, to generate the first tensor and the second tensor, the one or more processors are to generate a feature-expanded tensor from the input tensor, the feature-expanded tensor having more feature channels than the input tensor, and partition the feature-expanded tensor along the feature-channel axis while the feature-expanded tensor is stored in the second ordered memory layout.

39. The system of any of clauses 35-38, wherein one or more producer operations of the triangular multiplicative update graph are to perform a first matrix multiplication and a second matrix multiplication using a shared operand derived from the input tensor, the shared operand being loaded once from memory and reused as an input to both the first matrix multiplication and the second matrix multiplication.

40. The system of any of clauses 35-39, wherein the triangular multiplicative update tensor is stored according to the second ordered memory layout, and wherein one or more downstream operations of the triangular multiplicative update graph are to consume the triangular multiplicative update tensor while the triangular multiplicative update tensor is stored according to the second ordered memory layout.

As will be apparent to one of ordinary skill in the art, other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

As described further herein, processors, such as those disclosed in FIGS. 9-12B can use instructions to perform any of the operations described herein. Instructions, for example, can be performed using one or more threads. A thread block can include any number of threads of execution. A workgroup can be a thread block. A processor can execute a group of threads (e.g., 16 threads). A group of threads can also be referred to as a warp, or subgroup, or wavefront (e.g., as used by AMD and Intel). Each thread in a warp, wave, subgroup, or wavefront can belong to a single thread block and can be configured to process a different set of data based on a single set of instructions. A lane can be a thread. A work item can be a thread, such as, but not limited to, e.g., with OpenCL.

A processor, such as, processors described further herein (e.g., FIGS. 9-12B) can include one or more threads that can perform instructions synchronously. A thread can perform instructions synchronously. For example, a thread can perform a sequence of two instructions. An output of the first instruction can be input to the second instruction.

In at least one embodiment, a thread performs an instruction asynchronously if the thread performs one or more subsequent instructions before a processor's completion of all operations corresponding to the instruction have been completely been performed. For example, the thread can perform the instruction to cause a processor to queue or otherwise begin performing an operation and the thread can perform subsequent instructions before the processor has completed performing the operation. A processor, such as, processors described further herein (e.g., FIGS. 9-12B) can perform instructions asynchronously. For example, a thread may submit or issue an instruction to be performed by processor, and processor can perform the instruction independently of a thread that can be performing other instruction(s). A thread may submit or issue an instruction that can be performed by processor, and, for example, can inform one or more threads (the same thread or other threads) when the processor has performed a previously submitted or issued instruction. A thread may perform a first instruction to wait to be informed that processor has performed previously submitted or issued instructions, and, for example, output from the processor can be available to the thread. Output from processor can be input to a thread performing a second instruction. Instructions can be performed asynchronously in a variety of sequences. For example, one or more threads may submit one or more instructions to a processor, and processor may perform instructions in a sequence that is the same or different than an order submitted by the threads. Processor may specify a sequencing for the instructions that the processor performs.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Use of “may” and/or “can” is intended to indicate by way of example without limiting any particular embodiment or component or other function described above, below, or elsewhere herein. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as, but not limited to, phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). Number of items in a plurality can be at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. A process such as, but not limited to, those processes described herein (or variations and/or combinations thereof) can be performed under control of one or more computer systems configured with executable instructions and is implemented as code (e.g., executable instructions, one or more computer programs or one or more applications) executing collectively on one or more processors, by hardware or combinations thereof. Code can be stored on a computer-readable storage medium, for example, in form of a computer program comprising a plurality of instructions executable by one or more processors. A computer-readable storage medium can be a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. Code (e.g., executable code or source code) can be stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media can include multiple non-transitory computer-readable storage media and one or more of individual non-transitory storage media of multiple non-transitory computer-readable storage media lack all of code while multiple non-transitory computer-readable storage media collectively store all of code. Executable instructions can be executed such that different instructions are executed by different processors for example, a non-transitory computer-readable storage medium store instructions and a main central processing unit (“CPU”) executes some of instructions while a graphics processing unit (“GPU”) executes other instructions. Different components of a computer system can have separate processors and different processors execute different subsets of instructions.

An arithmetic logic unit can include a set of combinational logic circuitry that takes one or more inputs to produce a result. An arithmetic logic unit can be used by a processor to implement mathematical operation such as, but not limited to, addition, subtraction, or multiplication. An arithmetic logic unit is used to implement logical operations such as, but not limited to, logical AND/OR or XOR. An arithmetic logic unit can be stateless, and made from physical switching components such as, but not limited to, semiconductor transistors arranged to form logical gates. An arithmetic logic unit may operate internally as a stateful logic circuit with an associated clock. An arithmetic logic unit may be constructed as an asynchronous logic circuit with an internal state not maintained in an associated register set. An arithmetic logic unit can be used by a processor to combine operands stored in one or more registers of the processor and produce an output that can be stored by the processor in another register or a memory location.

As a result of processing an instruction retrieved by the processor, the processor may present one or more inputs or operands to an arithmetic logic unit, causing the arithmetic logic unit to produce a result based at least in part on an instruction code provided to inputs of the arithmetic logic unit. The instruction codes provided by the processor to the ALU may be based at least in part on the instruction executed by the processor. Combinational logic in the ALU may process the inputs and produces an output which is placed on a bus within the processor. A processor can select a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating point unit, a DSP, a tensor core, a shader core, a coprocessor, or a CPU.

One or more components of systems and/or processors disclosed above can communicate with one or more CPUs, ASICs, GPUs, FPGAs, or other hardware, circuitry, or integrated circuit components that include, e.g., an upscaler or upsampler to upscale an image, an image blender or image blender component to blend, mix, or add images together, a sampler to sample an image (e.g., as part of a DSP), a neural network circuit that is configured to perform an upscaler to upscale an image (e.g., from a low resolution image to a high resolution image), or other hardware to modify or generate an image, frame, or video to adjust its resolution, size, or pixels; one or more components of systems and/or processors disclosed above can use components described in this disclosure to perform methods, operations, or instructions that generate or modify an image.

Computer systems can be configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or example language (e.g., “such as, but not limited to,”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as, but not limited to, “processing,” “computing,” “calculating,” “determining,” or like, refer to action and/or processes of a computer or computing system, or similar electronic computing device, that manipulate and/or transform data represented as physical, such as, but not limited to, electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU or other accelerator. A “computing platform” may comprise one or more processors. As used herein, “software” processes may include, for example, software and/or hardware entities that perform work over time, such as, but not limited to, tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

References may be made to obtaining, acquiring, receiving, or inputting analog or digital data into a subsystem, computer system, or computer-implemented machine. Processes of obtaining, acquiring, receiving, or inputting analog and digital data can be accomplished in a variety of ways such as, but not limited to, by receiving data as a parameter of a function call or a call to an application programming interface. Processes of obtaining, acquiring, receiving, or inputting analog or digital data can be accomplished by transferring data via a serial or parallel interface. Processes of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as example forms of implementing the claims.

What is claimed is:

1. One or more processors, comprising:
circuitry to:
receive an input tensor representing features and stored in memory according to a first ordered memory layout, the input tensor including a first pair-index axis, a second pair-index axis, and a feature-channel axis;
execute a fused accelerator kernel configured to perform a plurality of neural network operations including computing, from the input tensor, a first tensor and a second tensor, and storing the first tensor and the second tensor in memory according to a second ordered memory layout, wherein the storing performs a transpose operation that reorders axes from the first ordered memory layout to the second ordered memory layout, and wherein, in the second ordered memory layout, the feature-channel axis precedes the first pair-index axis and the second pair-index axis; and
compute a triangular multiplicative update tensor by performing a tensor contraction between the first tensor and the second tensor that sums over an intermediate index, wherein the feature-channel axis is preserved by the tensor contraction and is not summed over the intermediate index.

2. The one or more processors of claim 1, wherein the transpose operation is to be performed by storing computed tensor values directly at memory addresses corresponding to the second ordered memory layout during execution of the fused accelerator kernel.

3. The one or more processors of claim 1, wherein the transpose operation is to be performed as part of the fused accelerator kernel, without executing a separate transpose kernel between execution of the fused accelerator kernel and performance of the tensor contraction.

4. The one or more processors of claim 1, wherein the transpose operation is to reorder tensor values generated from the input tensor from a first ordered memory layout in which the first pair-index axis and the second pair-index axis precede the feature-channel axis to the second ordered memory layout in which the feature-channel axis precedes the first pair-index axis and the second pair-index axis.

5. The one or more processors of claim 1, wherein the fused accelerator kernel is to:
perform a first matrix multiplication and a second matrix multiplication using a tensor derived from the input tensor;
generate a result tensor based on respective results of the first matrix multiplication and the second matrix multiplication; and
store the result tensor in the second ordered memory layout.

6. The one or more processors of claim 1, wherein the fused accelerator kernel is to generate a projected tensor in the second ordered memory layout, and
wherein the circuitry is to generate the first tensor and the second tensor by partitioning the projected tensor along the feature-channel axis.

7. The one or more processors of claim 1, wherein the circuitry is further to perform backward propagation for the triangular multiplicative update, and wherein the backward propagation includes recomputing one or more projection accumulations or gating accumulations during gradient computation.

8. A method comprising:
receiving an input tensor representing features and stored in memory according to a first ordered memory layout, the input tensor including a first pair-index axis, a second pair-index axis, and a feature-channel axis;
executing a fused accelerator kernel to generate, from the input tensor, a first tensor and a second tensor and store the first tensor and the second tensor in memory according to a second ordered memory layout by writing computed tensor values directly to memory addresses corresponding to the second ordered memory layout, wherein, in the second ordered memory layout, the feature-channel axis precedes the first pair-index axis and the second pair-index axis; and
computing a triangular multiplicative update tensor by performing a tensor contraction between the first tensor and the second tensor that sums over an intermediate index.

9. The method of claim 8, wherein executing the fused accelerator kernel includes storing the first tensor and the second tensor in the second ordered memory layout such that, for fixed values of the feature-channel axis, the tensor contraction is performed as a matrix multiplication over the intermediate index, and different fixed values of the feature-channel axis correspond to different matrix multiplications of a batched matrix multiplication.

10. The method of claim 8, wherein the tensor contraction is performed while the first tensor and the second tensor remain stored in the second ordered memory layout, without restoring a layout in which the feature-channel axis follows the first pair-index axis and the second pair-index axis before performing the tensor contraction.

11. The method of claim 8, further comprising:
executing a fused layer-normalization-and-transpose kernel after computing the triangular multiplicative update tensor to normalize the triangular multiplicative update tensor; and
storing a post-contraction tensor in a layout in which the feature-channel axis is preceded by the first pair-index axis and the second pair-index axis.

12. The method of claim 8, further comprising performing backward propagation for the triangular multiplicative update by executing a fused backward kernel configured to compute a gradient with respect to an input tensor for a fused layer-normalization-and-transpose operation.

13. The method of claim 8, wherein the input tensor further includes a batch axis, and wherein the storing reorders tensor values generated from the input tensor from a first ordered memory layout in which the batch axis is followed by the first pair-index axis, the second pair-index axis, and the feature-channel axis, to a second ordered memory layout in which the batch axis and the feature-channel axis precede the first pair-index axis and the second pair-index axis.

14. A system, comprising:
one or more processors to:
receive an input tensor representing features and stored in memory according to a first ordered memory layout, the input tensor including a first pair-index axis, a second pair-index axis, and a feature-channel axis;
execute a fused accelerator kernel to generate, from the input tensor, a first tensor and a second tensor and store the first tensor and the second tensor in memory according to a second ordered memory layout, wherein the storing performs a transpose operation by writing computed tensor values to memory addresses corresponding to the second ordered memory layout, and wherein, in the second ordered memory layout, the feature-channel axis precedes the first pair-index axis and the second pair-index axis; and
compute a triangular multiplicative update tensor by performing a tensor contraction between the first tensor and the second tensor that sums over an intermediate index, wherein the feature-channel axis is preserved by the tensor contraction.

15. The system of claim 14, wherein the one or more processors are further to execute one or more backward kernels to perform backward propagation for the triangular multiplicative update by computing one or more gradients associated with at least one of layer normalization, projection, gating, or masking.

16. The system of claim 14, wherein the tensor contraction forms an updated feature associated with the first pair-index axis and the second pair-index axis by combining features associated with a pair identified by the first pair-index axis and a shared intermediate index and features associated with a pair identified by the second pair-index axis and the shared intermediate index.

17. The system of claim 14, wherein the one or more processors are further to execute a backward kernel configured to compute gradients for a fused sigmoid-gated dual matrix multiplication operation used in the triangular multiplicative update.

18. The system of claim 14, wherein the fused accelerator kernel is further configured to perform a first matrix multiplication and a second matrix multiplication using a tensor derived from the input tensor, wherein a shared operand derived from the input tensor is loaded once from memory and reused as an input to both the first matrix multiplication and the second matrix multiplication to generate respective projection results.

19. The system of claim 14, wherein the fused accelerator kernel is compiled using a layout parameter that specifies an input tensor layout and an output tensor layout, and wherein pointer arithmetic used by the fused accelerator kernel to access tensor elements of the input tensor and to store tensor elements of the first tensor and the second tensor is determined based on the layout parameter.

20. The system of claim 14, wherein the input tensor further includes a batch axis, and
wherein the storing reorders tensor values generated from the input tensor from a first ordered memory layout in which the batch axis is followed by the first pair-index axis, the second pair-index axis, and the feature-channel axis, to a second ordered memory layout in which the batch axis and the feature-channel axis precede the first pair-index axis and the second pair-index axis.
